(19) United States
(12) Patent Application Publication
(10) Pub. No.: US 2007/0282724 A1
(43) Pub. Date: Dec. 6, 2007

(54) ASSET BASED LENDING (ABL) SYSTEMS AND METHODS

(75) Inventors: Robert L. Barnes, London (GB); Daniel L. Duncan, Atlanta, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: PrimeRevenue, Inc., Atlanta, GA (US)

(21) Appl. No.: 11/754,215

(22) Filed: May 25, 2007

Related U.S. Application Data
(63) Continuation-in-part of application No. 11/677,488, filed on Feb. 21, 2007.
(60) Provisional application No. 60/746,663, filed on May 8, 2006.
(60) Provisional application No. 60/780,317, filed on Mar. 8, 2006.
(60) Provisional application No. 60/775,045, filed on Feb. 21, 2006.
(60) Provisional application No. 60/803,168, filed on May 25, 2006.
(60) Provisional application No. 60/803,166, filed on May 25, 2006.
(60) Provisional application No. 60/803,162, filed on May 25, 2006.
(60) Provisional application No. 60/803,170, filed on May 25, 2006.

(51) Int. Cl. G06Q 40/00

(52) U.S. Cl. 705/35

(57) ABSTRACT

In an automated asset based lending (ABL) system, a method of enabling the client and the financial institution to automate reconciliation of deposit data against a borrowing base, the method comprising receiving cash application data from the client, receiving deposit data from the client and matching the deposit data to a client ledger, the deposit data including a deposit amount, identifying the client and identifying a client bank account, the client ledger including draws, cash applications and invoices, denoting the deposit amount as unapplied cash, determining a minimum immediate refund amount, the refund amount corresponding to non-funded cash, matching the deposit amount to cash applications and creating cash applications against the invoices, the cash application corresponding to the deposit amount, and applying a balance remaining from the deposit amount to at least one draw and/or recovery account, wherein the balance is applied to the oldest draw and/or recovery account available.

### CROSS REFERENCE TO RELATED APPLICATIONS

This application is a Continuation-in-Part of U.S. application Ser. No. 11/677,488, filed Feb. 21, 2007, which claims the benefit under 35 U.S.C. § 119(e) of U.S. Provisional Patent Application Ser. No. 60/746,663, entitled “Improved System and Methods for ABL Valuation and Pricing,” filed May 8, 2006, U.S. Provisional Patent Application Ser. No. 60/780,317, entitled “System and Methods for ABL Valuation and Pricing,” filed Mar. 8, 2006, and U.S. Provisional Patent Application Ser. No. 60/775,045, entitled “Structure for Asset Based Lending System,” filed Feb. 21, 2006, each of which is incorporated herein by reference as if set forth herein in its entirety. This application also claims the benefit under 35 U.S.C. § 119(e) of U.S. Provisional Patent Application Ser. No. 60/803,168, entitled “Deposit Reconciliation,” filed May 25, 2006, U.S. Provisional Patent Application Ser. No. 60/803,166, entitled “ABL Portfolios,” filed May 25, 2006, U.S. Provisional Patent Application Ser. No. 60/803,162, entitled “ABL Electronic Document Definitions and Relationships,” filed May 25, 2006, and U.S. Provisional Patent Application Ser. No. 60/803,170, entitled “ABL-Client Program,” filed May 25, 2006, each of which is incorporated herein by reference as if set forth herein in its entirety.

### FIELD OF THE PRESENT INVENTION

The present invention relates generally to electronic commerce financing, and more particularly, to automated asset based lending (ABL) systems that integrate supplier receivables data, allowing financial institutions optimally to value and price lending against those receivables, thus enabling financial institutions to offer suppliers a maximum borrowing base with minimum risk and highest return to the financial institution, further enabling the financial institution to conduct business in multiple currencies, time zones and countries using a computer based ABL process.

### BACKGROUND OF THE PRESENT INVENTION

Many financial institutions (FIs) have lending programs whereby they purchase all or part of a client's receivables; some of these lending programs fit into an asset based lending (ABL) category. In a typical ABL program, invoices are created when a financial institution's client provides goods and services to its customers. For the purposes of this disclosure, the client's “customers” are synonymous with “debtors.”

To obtain working capital, the financial institution's client sells its receivables at a discount to the financial institution. This process can be lengthy and primarily consists of paper-based transactional processing. Typically, a client must provide the financial institution with detailed invoice level receivables paperwork and follow up with substantial documentation and proof of invoice validity prior to obtaining cash for those receivables. This approach is often problematic as the client's entire receivable base is usually devalued due to inaccurate debtor credit ratings and invoice details. A lack of visibility to debtor concentrations across the client base is also indistinguishable. As a result, the client often receives higher rates, a reduced borrowing base, and less money for its receivables. In addition, the global marketplace provides unique challenges for financial institutions that conduct ABL programs in multiple countries, time zones, and currencies.

In today's global economy, financial institutions need automated solutions that integrate supplier receivables data, allowing the financial institution optimally to value and price lending against those receivables. Ideally, such solutions should provide the accuracy and accountability to enable financial institutions to offer suppliers a maximum borrowing base with minimum risk and highest return to the financial institution. For these and many other reasons, there is a need for automated ABL systems that enable the financial institution to conduct business in multiple currencies, time zones and countries using a computer based ABL lending process.

### SUMMARY OF THE INVENTION

The present invention relates generally to electronic commerce financing and, more particularly, to automated asset based lending (ABL) systems that integrate supplier receivables data, allowing financial institutions optimally to value and price lending against those receivables, thus enabling financial institutions to offer suppliers a maximum borrowing base with minimum risk and highest return to the financial institution, further enabling the financial institution to conduct business in multiple currencies, time zones and countries using a computer based ABL process.

One aspect of the present invention provides in an asset based lending system having a client and at least one financial institution, a method for valuing and pricing client's receivables, the method comprising, downloading accounts receivable information from the client, the accounts receivable information having a specified currency, calculating a borrowing base for the client via utilizing debtor risk ratings, pricing profiles, valuation profiles and pricing tiers, and applying fees and interest as specified in the pricing profile associated with the valuation profile.

Another aspect of the present invention provides an asset based lending system having a client and at least one financial institution, a method for valuing and pricing client's receivables, the method comprising, receiving accounts receivable information from the client, managing valuations, pricing and risk for the accounts receivable information, applying fees and utilizing the valuations to calculate a borrowing base, receiving a draw request from the client, transferring funds to the client's operating account, receiving a deposit from the client, and upon notification of the deposit, re-calculating the borrowing base utilizing draw request information, deposit information and valuations.

Another aspect of the present invention provides an asset based lending system having a client and at least one financial institution, each of which accesses the system through a computer network interface, a method of enabling the client and the financial institution to automate reconciliation of deposit data against a borrowing base, the method comprising receiving cash application data from the client, the cash application data representing payments as received and recorded by the client, receiving deposit data from the client and matching the deposit data to a client ledger corresponding to the client, the deposit data including a deposit amount, identifying the client and identifying a client bank account, and wherein the client ledger includes draws, cash applications and invoices, denoting the deposit amount as unapplied cash, determining a minimum immediate refund amount, the refund amount corresponding to non-funded cash, the non-funded cash being excluded from the borrowing base, matching the deposit amount to cash applications and creating cash applications against the invoices, the cash application corresponding to the deposit amount, and applying a balance remaining from the deposit amount to at least one draw and/or recovery account, wherein the balance is applied to the oldest draw and/or recovery account available.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a high level overview of an asset based lending (ABL) system.

FIG. 2 is a high level architecture view of the ABL system of FIG. 1.

FIG. 3 is a diagram illustrating the interrelationship of the elements in an ABL application.

FIG. 4 is a diagram illustrating client element relationships in an ABL application.

FIG. 5 is a diagram illustrating debtor element relationships in an ABL application.

FIG. 6 is a diagram illustrating client ledger element relationships in an ABL application.

FIG. 7 is a diagram illustrating debtor ledger element relationships in an ABL application.

FIG. 8 is a diagram illustrating client program element relationships in an ABL application.

FIG. 9 is a diagram illustrating valuation profile element relationships in an ABL application.

FIG. 10 is a screen image illustrating an example valuation profile in an ABL application.

FIG. 11 is a diagram illustrating a method for valuation profile creation in an ABL application.

FIG. 12 is a diagram illustrating a method for fine-tuning a valuation profile in an ABL application.

FIG. 13 is a diagram illustrating a method for borrowing base calculation in an ABL application.

FIG. 14 is an example illustrating a client's accounts receivable book in an ABL application.

FIG. 15 is an example illustrating a method for using pricing profile to determine borrowing base in an ABL application.

FIG. 16 is an example illustrating results from applying a valuation profile against reorganized accounts receivable debtors in an ABL application.

FIG. 17 is a screen image illustrating an example pricing profile in an ABL application.

FIG. 18 is a screen image illustrating an example interest rates list in an ABL application.

FIG. 19 is a screen image illustrating an example interest rate detail in an ABL application.

FIG. 20 is a screen image illustrating an example related pricing profile in an ABL application.

FIG. 21 is a screen image illustrating an example interest rate detail—past rates tab in an ABL application.

FIG. 22 is a screen image illustrating an example interest rate detail—history tab in an ABL application.

FIG. 23 is a diagram illustrating verification profile element relationships in an ABL application.

FIG. 24 is a diagram illustrating an example group hierarchy of a financial institution in an ABL application.

FIG. 25 is a screen image illustrating an example group list of the financial institution in the ABL application.

FIG. 26 is a screen image illustrating an example group details in an ABL application.

FIG. 27 is a screen image illustrating an example workflow in an ABL application.

FIG. 28 is a diagram illustrating client/debtor portfolio element relationships in an ABL application.

FIG. 29 is a diagram illustrating ABL application electronic documents.

FIG. 30 is a diagram illustrating ABL application electronic documents.

FIG. 31 is a screen image illustrating an example draw page in an ABL application.

FIG. 32 is a screen image illustrating an example recovery refund page in an ABL application.

FIG. 33 is a screen image illustrating an example invoice page in an ABL application.

FIG. 34 is a screen image illustrating an example cash application page in an ABL application.

FIG. 35 is a screen image illustrating an example credit memo page in an ABL application.

FIG. 36 is a screen image illustrating an example journal entry page in an ABL application.

FIG. 37 is a screen image illustrating an example deposit page in an ABL application.

FIG. 38 is a screen image illustrating an example electronic funds transfer page in an ABL application.

FIG. 39 is a screen image illustrating an example batch list page in an ABL application.

FIG. 40 is a screen image illustrating an example debtor batch list page in an ABL application.

FIG. 41 is a screen image illustrating an example invoice batch list page in an ABL application.

FIG. 42 is a diagram illustrating the client element web page design in an ABL application.

FIG. 43 is a screen image illustrating an example client list page in an ABL application.

FIG. 44 is a screen image illustrating an example client details page in an ABL application.

FIG. 45 is a screen image illustrating an example client ledgers list page in an ABL application.

FIG. 46 is a screen image illustrating an example client ledger details page in an ABL application.

FIG. 47 is a diagram illustrating the debtor element web page design in an ABL application.

FIG. 48 is a screen image illustrating an example debtor list page in an ABL application.

FIG. 49 is a screen image illustrating an example debtor details page in an ABL application.

FIG. 50 is a diagram illustrating the manage elements web page design in an ABL application.

FIG. 51 is a screen image illustrating an example interest rates list page in an ABL application.

FIG. 52 is a screen image illustrating an example interest rates detail page in an ABL application.

FIG. 53 is a screen image illustrating an example pricing profile list page in an ABL application.

FIG. 54 is a screen image illustrating an example pricing profile details page in an ABL application.

FIG. 55 is a screen image illustrating an example valuation profile list page in an ABL application.

FIG. 56 is a screen image illustrating an example valuation profile details page in an ABL application.

FIG. 57 is a screen image illustrating an example client program list page in an ABL application.

FIG. 58 is a screen image illustrating an example client program details page in an ABL application.

FIG. 59 is a screen image illustrating an example verification profile list page in an ABL application.

FIG. 60 is a screen image illustrating an example verification profile details page in an ABL application.

FIG. 61 is a table illustrating exemplary steps for configuring manual rating criteria in an ABL application.

FIG. 62 is a screen image illustrating an exemplary rating criteria configuration page in an ABL application.

FIG. 63 is a table illustrating exemplary steps required for defining a rating profile in an ABL application.

FIG. 64 is a screen image illustrating an exemplary rating profile configuration page in an ABL application.

FIG. 65 is a table illustrating exemplary specific company manually defined client rating criteria.

FIG. 66 is a table illustrating exemplary client system generated rating criteria.

FIG. 67 is a table illustrating exemplary specific company manually defined debtor rating criteria.

FIG. 68 is a table illustrating exemplary debtor system generated rating criteria.

FIG. 69 is a screen image illustrating an exemplary navigation menu.

FIG. 70 is an exemplary screen image illustrating a ledgers list tab.

FIG. 71 is an exemplary screen image of an outstanding funding request tab.

FIG. 72 is an exemplary screen image of a tasks and alerts tab.

FIG. 73 is screen image of an exemplary funding request tab.

FIG. 74 is a screen image illustrating an exemplary funding request page with an associated refund request.

FIG. 75 is a screen image illustrating an exemplary funding request list page.

FIG. 76 is a screen image illustrating an exemplary data tab.

FIG. 77 is a screen image illustrating an exemplary import batch list page.

FIG. 78 is a screen image illustrating an exemplary debtor select list page.

FIG. 79 is a screen image illustrating an exemplary invoice direct entry page.

FIG. 80 is a screen image illustrating an exemplary aging summary batch record.

FIG. 81 is a screen image illustrating an exemplary certificate of debtors page.

FIG. 82 is a screen image illustrating an exemplary features available on the manage function tab.

FIG. 83 is a screen image illustrating an exemplary details provided by the borrowing base visibility page.

FIG. 84 is a screen image illustrating an exemplary reserve account tab functionality.

FIG. 85 is a screen image illustrating an exemplary recovery account summary page.

FIG. 86 is a screen image illustrating an exemplary recovery account details page.

FIG. 87 is a screen image illustrating an exemplary reserve account pending refund requests.

FIG. 88 is a screen image illustrating an exemplary reserve account refund history page.

FIG. 89 is a screen image illustrating an exemplary deposit page.

FIG. 90 is a process map illustrating an exemplary matching process for a detailed integrated client.

FIG. 91 is a screen image illustrating exemplary profile matching criteria available from a client debtor profile.

FIG. 92 is a screen image illustrating an exemplary cash application add page.

FIG. 93 is a process map illustrating an exemplary matching process for a summary client.

FIG. 94 is a screen image illustrating an exemplary manual reconciliation tab 638 of the summary client deposit document.

FIG. 95 is a screen image illustrating an exemplary deposit reconciliation section.

FIG. 96 is a screen image illustrating an exemplary borrowing base downgrade table tab.

FIG. 97 is a screen image illustrating an exemplary “Configured” parameter in the client debtor profile.

FIG. 98 is an exemplary illustration of the effect of the tiered parameter on the client's borrowing base.

FIG. 99 is a screen image illustrating an exemplary “Auto Accept” parameters on the client debtor profile.

FIG. 100 is an exemplary illustration of identified invoice misallocations.

FIG. 101 is a screen image illustrating an exemplary cash application tab with the reverse reconciliation button.

FIG. 102 is a screen image including an exemplary navigation menu and a portfolio list page.

FIG. 103 is a diagram illustrating exemplary components of a portfolio.

FIG. 104 is a screen image illustrating an exemplary configured portfolio add page.

FIG. 105 is a screen image illustrating an exemplary client portfolio details page.

FIG. 106 is a screen image illustrating an exemplary debtor portfolio details page.

FIG. 107 is a screen image illustrating an exemplary client portfolio query page with associated query tabs.

FIG. 108 is a screen image illustrating an exemplary client summary portfolio query.

FIG. 109 is an exemplary depiction of summary query calculations.

FIG. 110 is a screen image illustrating an exemplary client performance query.

FIG. 111 is an exemplary depiction of client performance calculations.

FIG. 112 is a screen image illustrating an exemplary BUID performance query.

FIG. 113 is an exemplary depiction of the BUID performance query performance calculations.

FIG. 114 is a screen image illustrating an exemplary aging analysis query.

FIG. 115 is an exemplary depiction of the aging analysis query calculations.

FIG. 116 is a screen image illustrating a risk score trend query.

FIG. 117 is an exemplary depiction of the risk score trend query calculations.

FIG. 118 is a screen image illustrating an exemplary detailed client risk analysis query.

FIG. 119 is an exemplary depiction of the client concentration by risk group query.

FIG. 120 is a screen image illustrating an exemplary client concentration vs. debtor exposure.

FIG. 121 is an exemplary depiction of the client concentration vs. debtor exposure calculations.

FIG. 122 is a screen image illustrating an exemplary days sales outstanding query.

FIG. 123 is an exemplary depiction of the days sales outstanding query calculations.

FIG. 124 is a screen image illustrating an exemplary collection trend query.

FIG. 125 is an exemplary depiction of the collection trend query calculations.

FIG. 126 is a screen image illustrating an exemplary payment trend query.

FIG. 127 is an exemplary depiction of the payment trend query calculations.

FIG. 128 is a screen image illustrating an exemplary utilized facility trend #1 (draw funds vs. borrowing base) query.

FIG. 129 is an exemplary depiction of the utilized facility trend #1 (draw funds vs. borrowing base) query calculations.

FIG. 130 is a screen image illustrating an exemplary utilized facility trend #2 (draw funds vs. actual commitment) query.

FIG. 131 is an exemplary depiction of the utilized facility trend #2 (draw funds vs. actual commitment) query calculations.

FIG. 132 is a screen image illustrating an exemplary utilized facility trend #3 (draw funds vs. total assets) query.

FIG. 133 is an exemplary depiction of the utilized facility trend #3 (draw funds vs. total assets) query calculations.

FIG. 134 is a screen image illustrating an exemplary sales trend (estimated vs. actual sales) query.

FIG. 135 is an exemplary depiction of the sales trend (estimated vs. actual sales) query calculations.

FIG. 136 is a screen image illustrating an exemplary sales trend (historical sales trend) query.

FIG. 137 is an exemplary depiction of the sales trend (historical sales trend) query calculations.

FIG. 138 is a screen image illustrating an exemplary dilution trend query.

FIG. 139 is an exemplary depiction of the dilution trend query calculations.

FIG. 140 is a screen image illustrating an exemplary credit note trend query.

FIG. 141 is an exemplary depiction of the credit note trend query calculations.

FIG. 142 is a screen image illustrating an exemplary journal entry trend query.

FIG. 143 is an exemplary depiction of the journal entry trend query calculations.

FIG. 144 is a screen image illustrating an exemplary maximum tenor trend query.

FIG. 145 is an exemplary depiction of the maximum tenor trend query calculations.

FIG. 146 is a screen image illustrating an exemplary borrowing base trend query.

FIG. 147 is an exemplary depiction of the borrowing base trend query calculations.

FIG. 148 is a screen image illustrating an exemplary ineligibles query.

FIG. 149 is an exemplary depiction of the ineligibles query calculations.

FIG. 150 is a screen image illustrating an exemplary client yield history query.

FIG. 151 is an exemplary depiction of the client yield history query calculations.

FIG. 152 is a screen image illustrating an exemplary client yield detail query.

FIG. 153 is an exemplary depiction of the client yield detail query calculations.

FIG. 154 is a screen image illustrating an exemplary client revenue detail query.

FIG. 155 is an exemplary depiction of the client revenue detail query calculations.

FIG. 156 is a screen image illustrating an exemplary collections-DSO query.

FIG. 157 is an exemplary depiction of the collections-DSO query calculations.

FIG. 158 is a screen image illustrating an exemplary debtor concentration query.

FIG. 159 is an exemplary depiction of the debtor concentration query calculations.

FIG. 160 is a screen image illustrating an exemplary dilution query.

FIG. 161 is an exemplary depiction of the dilution query calculations.

FIG. 162 is a screen image illustrating an exemplary debtor aging analysis query.

FIG. 163 is an exemplary depiction of the debtor aging analysis query calculations.

FIG. 164 is a screen image illustrating an exemplary invoice history tab.

FIG. 165 is a screen image illustrating an exemplary related documents tab.

FIG. 166 is a screen image illustrating an exemplary invoice notes tab.

FIG. 167 is a screen image illustrating an exemplary attachments tab.

### DETAILED DESCRIPTION OF PREFERRED EMBODIMENTS

Reference is now made in detail to the description of the embodiments as illustrated in the drawings. The invention may, however, be embodied in many different forms and should not be construed as limited to the embodiments set forth herein; rather, these embodiments are intended to convey the scope of the invention to those skilled in the art. Furthermore, all “examples” given herein are intended to be non-limiting.

The present invention relates generally to electronic commerce financing and, more particularly, to improved asset based lending (ABL) systems and methods for enabling financial institutions (FI) and their clients to collaborate across multiple accounts receivables in multiple currencies and languages.

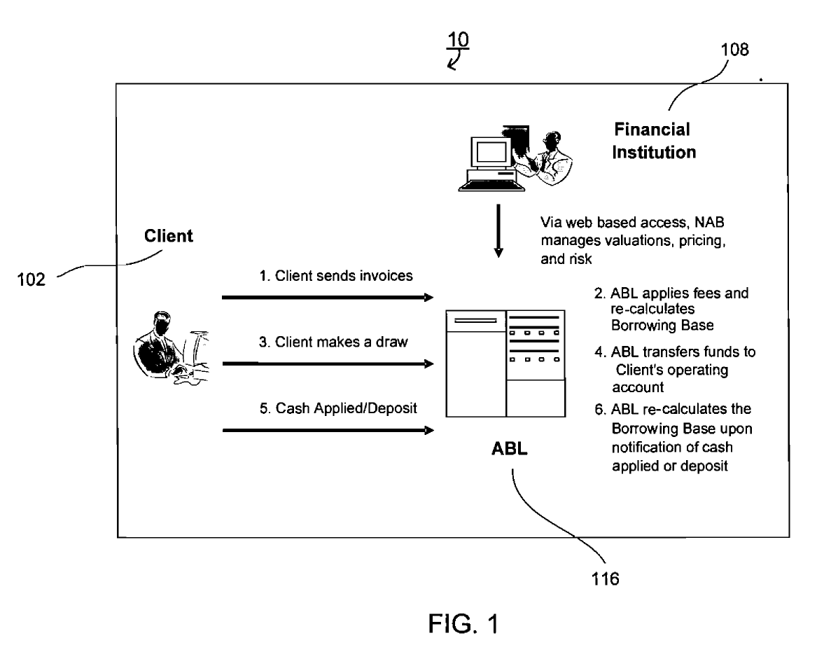

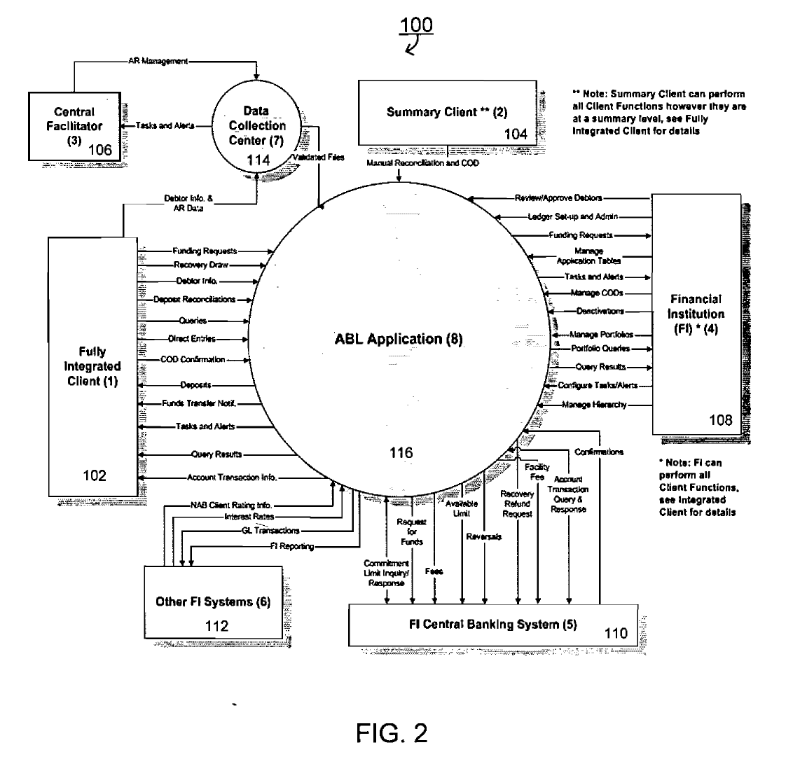

FIG. 1 illustrates a high level functional overview 10 of an asset based lending system. An ABL application 116 integrates the client's accounts receivables with the financial institution's 108 internal banking systems on an ABL platform. The ABL application 116 values the client's borrowing base, thus enabling the client 102 to conduct real-time funding against the newly-calculated borrowing base. The ABL application 116 typically is fully integrated with the financial institution's banking system and, as such, the application software is preferably hosted behind the financial institution's firewall. The ABL system 100 (see FIG. 2) also includes automated risk scoring, portfolio management, ledger and deposit reconciliation, as well as tasks and alerts. Financial institutions 108 and their clients 102 are effectively enabled to perform financial transactions globally, across multiple time zones, in any currency, on a single platform, and in real time.

The system provides an internal application structure based upon a set of functional building blocks. This building block concept provides financial institutions 108 with a flexible and configurable ABL application 116 solution that minimizes system management and maximizes lending capability.

Further, the ABL system 100 provides an innovative solution for valuing and pricing the client's receivables, via the building blocks inherent in the ABL application 116 in conjunction with debtor risk ratings, pricing profiles, valuation profiles and pricing tiers dynamically to determine and value the client's borrowing base.

System generated risk ratings are calculated for each debtor using financial institution 108 configured risk score criteria along with system generated risk scoring. Valuation profiles are associated to pricing profiles and contain configurable valuation tiers. The pricing profiles include various fees and interest rates. The valuation tiers configured in the valuation profile determine (1) the number of debtors to apply against the pricing tier based on the debtor's risk score, (2) the percentage of any one debtor's receivables to be included in the borrowing base, (3) the age of any one debtor's receivables to be included in the borrowing base and (4) the percentage of any specific tier's debtors to be included in the borrowing base.

A borrowing base is calculated for each client. Fees and interest are applied in various ways, as specified in the pricing profile associated with the valuation profile. Although this is a separate process from the valuation process, it applies to the invoice selected as a result of the valuation process.

As shown in FIG. 1, the ABL system enables the financial institution 108 to value clients' account receivables and provide funding in a real-time environment. The ABL system includes distinct user types or entities. (1) clients 102 are customers of the financial institution 108 that interactively utilize the ABL system 100 for obtaining receivables based funding. (2) A single financial institution requires an automated process for managing and monitoring the ABL lending process. (3) A third party provider, or central facilitator, of data collection center services supports and sustains downloading and data harmonization of client receivable data.

The ABL application 116 provides the financial institution 108 with a host of processes, including (1) fully integrated client processes, (2) summary client processes, (3) general ABL application processes, (4) financial institution processes, (5) financial institution banking system integration processes, (6) other financial institution back office system integration processes and (7) data collection center processes.

Referring again to FIG. 1, the bank or financial institution 108 manages valuations, pricing and risk. A client sends invoices to the ABL application 116. The ABL application 116 applies fees and re-calculates the borrowing base. Once the client makes a draw, the ABL application 116 transfers funds to the client's operating account. When cash is applied or when a deposit is made, the ABL application 116 re-calculates the borrowing base upon notification of the cash applied or the deposit respectively.

FIG. 2 illustrates the high level architecture of the ABL system 100, including the processes and entities, as well as the data flow between these processes and entities. The ABL application 116 interacts with a fully integrated client 102 (client 102), a summary client 104, a central facilitator 106 (third party provider), a financial institution 108, FI central banking system 110, other FI systems 112, and a data collection center 114.

The data flow between the ABL application 116 and a fully integrated client 102 includes functionality such as (1) funding requests, (2) recovery draw, (3) debtor information, (4) deposit reconciliations, (5) queries, (6) direct entries, (7) certificate of debtor (COD) confirmation, (8) deposits, funds transfer notification, (9) tasks and alerts, (10) query results and (11) account transaction information.

The fully integrated client 102 provides debtor information and accounts receivable data to the data collection center 114. Accounts receivable upload options include (1) an integrated interface for client with certain accounts receivable packages, e.g. MYOB, (2) an open interface model for clients that desire to upload their data using a central facilitator defined file format, and (3) a non-standard option for clients that either have an accounts receivable package where no integration agent has been developed or that choose not to use an integration agent, even if one is available. Home page functions are used to manage debtors, funding requests, tasks and alerts, and accounts receivables. In addition, the fully integrated client may submit funding requests, access bank account information, view and manage the reserve/recovery account, manage debtors, view ledger details, certificate of debtors/reconciliation, and view electronic documents.

The summary client 104 provides for manual reconciliation and COD to the ABL application 116. The summary client 104 uses system functionality to directly enter summary level accounts receivable information. Further, the summary client 104 is designed for clients 102 that cannot upload detailed accounts receivables data. Finally, it should be noted that summary clients 104 can perform any functions available to the fully integrated client 102, with the exception of detailed data uploads and associated detailed reconciliations. The client 102 functions are performed at a summary level.

Accounts receivable management is provided from the central facilitator 106 to the data collection center 114. The central facilitator 106 performs data mapping for new clients 102 using the non-standard translation method. Further, the central facilitator 106 responds to tasks and alerts from the data collection center 114. Finally, the central facilitator 106 works with financial institutions 108 for enabling and managing client accounts.

The data flow between the ABL application 116 and the financial institution 108 includes functionality such as (1) review and approval of debtors, (2) ledger set-up and administration, (3) funding requests, (4) management of application tables, (5) viewing tasks and alerts, (6) management of CODs, (7) deactivations, (8) management of portfolios, (9) portfolio queries, (10) query results, (11) configuration of tasks and alerts and (12) management of hierarchy. It should be noted that the financial institution 108 is capable of performing any client functions.

The financial institution 108 interactively uses the capabilities available in the ABL application 116 to set-up and manage all ABL application 116 functionality. Home page functions are used to manage financial institution 108 clients 102, funding requests, tasks and alerts, and accounts receivables review funding request.

The data flow between the FI central banking system 110 and the ABL application 116 includes functionality such as (1) confirmations, (2) account transaction query and response, (3) facility fee, (4) recovery refund request, (5) reversals, (6) available limit, (7) fees, (8) request for funds and (9) commitment limit inquiry and response. The ABL application 116 integrates directly to the financial institution's banking system and provides for real-time funding requests, real-time client refunds of unapplied cash, real-time bank account transaction information and performs transaction validation and confirmation.

Other FI systems 112 may also interact with the ABL application 116 and the data flow includes functionality such as (1) financial institution reporting, (2) GL transactions, (3) interest rates and (4) bank client rating information. Financial institution client information, interest rates, bank accounts, and account status are capable of being uploaded to the ABL application. The financial institution central banking system may download GL transactions and other financial institution reporting information to financial institutions 108 and other back office systems.

The data collection center 114 provides validated files to the ABL application 116. Data is transported between the client 102 and the data collection center 114 and also between the ABL application 116 and the data collections center 114. Non-standard translation management provides requirements and implementation structure for those clients 102 that do not use the central facilitator's 106 standard extract and transport agents. The data collection center 114 also provide data validation to correct for structure errors, duplicate records and data reasonableness (not business rules). Disaster recovery is also provide to supported and expedited. Activity monitoring allows for the monitoring of users, client information and transactions. Tasks and alerts specific to the management of the data collection center are also provided. Reports such as, for example, a financial institution transmission report may be provided. The data collection center 114 also provides for integrated client version management.

The ABL application 116 provides functionality including (1) allowing for client and ledger configuration, (2) establishment of financial institution hierarchical organization structure, (3) management of debtor/client risk ratings, (4) portfolio organization, management and query analysis, (5) real-time integration to financial institution banking applications, (6) task management of debtors and electronic documents, (7) configuration of alert processing and financial institution/client user notification, (8) funding approvals, (9) debtor management, (10) permission management within the system, (11) data capture and online query for all key system audit events, (12) processing of deposits and deposit reconciliations, (13) client borrowing base calculation, (14) detailed account reconciliation, (15) batch management processing, (16) client refunds and (17) client bank account inquiries.

ABL Application Elements

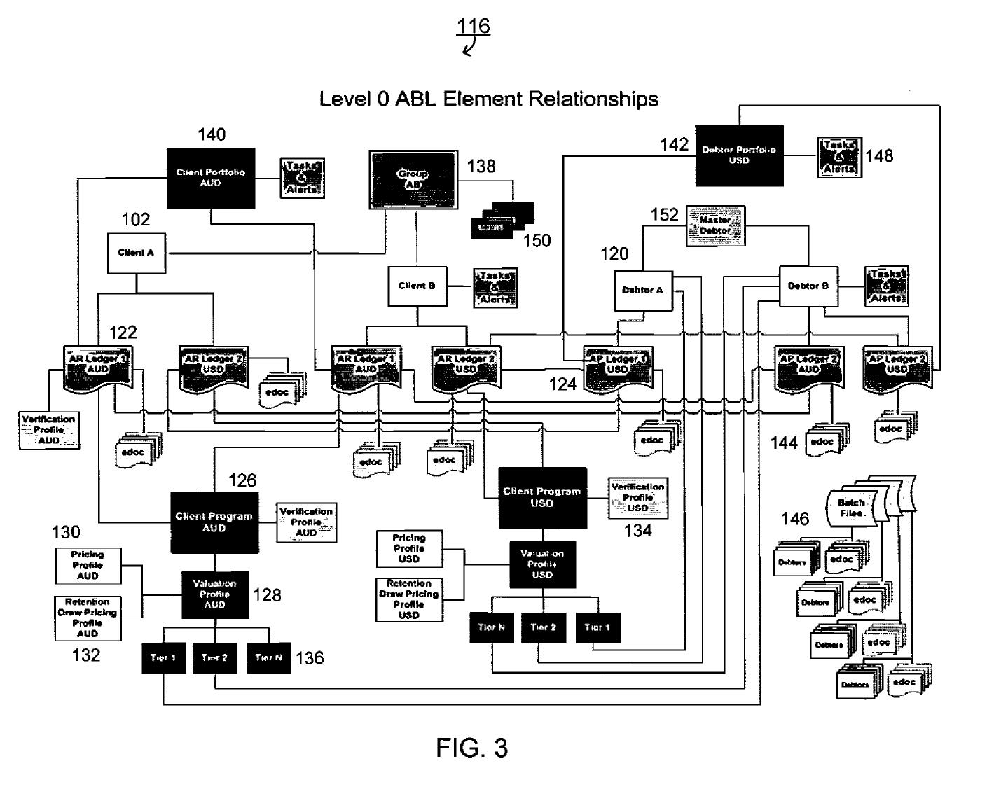

The architecture as shown in FIG. 2 includes a flexible set of application elements that are building blocks in the configuration and processing performed within the ABL application 116. FIG. 3 is a diagram illustrating the interrelationship of the ABL elements, or building blocks in an ABL application 116.

The client element allows the customers of the financial institutions 108 to submit account receivables. The accounts receivables are valued and a specific facility is made available to the client 102 from which they may perform draws.

The debtor 120 pays the clients 102 for the goods and services provided by the client 102. The debtor 120 element is a cornerstone building block in the ABL application 116. Debtors 120 are important to the system 100 as the rating of the debtors affect (for better or for worse) the lending conditions that the clients 102 ultimately receive.

The accounts receivable ledger 122 (AR ledger 122) is provided by the client 102. Client ledgers allow for multi-currency capability enabling the financial institution 108 to manage the ABL lending process in any currency. The AR ledger 122 can be provided in summary or detail form. A more detailed and accurate AR ledger 122 allows the financial institution 108 to better determine the value of the ledger. Clients 102 having ledgers that are consistently paid to terms with minimal dilution can be valued higher and can therefore receive better rates and fees. AR ledgers 122 are specific to a currency, and a client 102 can have any number of ledgers.

Debtor accounts payable ledgers 124 (AP ledger 124) provide visibility to debtor payment trends across multiple clients and currencies. A debtor 120 may have only one ledger per currency.

Client programs 126 reduce the maintenance effort for managing clients 102 with like attributes. Client programs 126 allow the financial institution 108 to group client ledgers having similar characteristics. The financial institution 108 can then associate a single verification profile with many client ledgers, thus simplifying system maintenance. The client program 126 also identifies instances where the client programs' 126 associated valuation profile and verification profile would be affected by modifications.

The valuation profile 128 is the method used to value debtors invoices and calculate the borrowing base for the client. The valuation profile 128 includes pricing profiles 130 and tiers 134. The pricing profile 130 determines the rates and fees applied to the client's facility when creating a draw. The tiers 134 are used to segregate debtors 120 into groups based on their financial rating. The tiers 134 determine how much of any one debtor's invoices can make up the client's 102 borrowing base. A valuation profile 128 can be associated to a client program 126 or directly to a client's accounts receivable. Valuation profile 128 are currency specific and may not be associated with a client program 126 or client accounts receivable having a different currency. Valuation profile 128 can be used in any number of client programs 126. They also allow for identification of all instances where client programs 126 are affected by modifications to a specific valuation profile 128.

Pricing profiles 130 and valuation profiles 128 can be configured once and referenced any number of times by any number of valuation profiles 128. Pricing profiles 130 contain interest and fee information. This information is used to calculate the fees and interest associated with a draw. Pricing profiles 130 are currency specific and may not be associated with a valuation profile 128 of a different currency. They also allow for identification of all instances where client programs 126 would be affected by modifications to these profiles.

If used, the retention draw pricing profile 132 gives the financial institution 108 the option to allow the client 102 to borrow additional funds held in the client's retention account with rates and fees based on the settings contained in the retention draw pricing profile 132.

Tiers 134 are part of the valuation profile 128. A valuation profile 128 can have any number of tiers 134. Valuation tiers are established to value debtor's receivables in the accounts receivable ledger. The valuation profile 128 can have as many tiers 134 as the user desires. Tiers 134 are cross referenced to a specific group of debtors 120 (by their Tax ID number) or to a group of all debtors 120 by rating.

Verification profiles 136 provide a central location for managing most electronic document (e-document) exceptions and allow for reuse or separate configuration for client ledgers within a client program 126. Verification profiles 136 contain specific information that is used to validate against the client's invoice and debtor file. This information may consist of invoice minimum and maximum amounts or dates that apply to invoices contained in the accounts receivable. When invoice exceptions occur, any number of actions may be automatically initiated by the system. They also identify and initiate monetary approval and review functions.

Groups 138 enable the financial institution 108 to organize clients 102 and financial institution users. Groups 138 can be organized to represent the organizational or functional structure of the financial institution 108. This capability allows the financial institution 108 to effectively manage and action tasks and alerts for clients 102, debtors 120 and portfolios. Groups 138 are hierarchical building blocks. Financial institution users are assigned permissions and then associated to groups 138. Clients 102 are assigned to groups 138. In this way client tasks and alerts are assigned to users having the appropriate roles for the group 138 to which they and the client 102 belong.

Client portfolios 140 are used by the financial institution 108 to organize and manage their clients 102. Financial institutions 108 can use client portfolios 140 to help them track the performance of the portfolios they have been assigned. Portfolios allow the financial institution 108 to set alerts, view trends and capture dilution and other important information about their clients 102.

Debtor portfolios 142 are similar to client portfolios 140 except that the debtors 120 are organized into portfolios to allow the financial institution 108 to set alerts, view trends and capture dilution and other important information about their debtors 120.

Electronic documents 144 (e-documents 144) work interactively to provide the user with the capability to view document details, document history, attachments and link to other related documents seamlessly. Electronic documents 144 include credit memos, journal entries, electronic funds transfers, cash applications and invoices.

Batch 146 processing provides the capability to manage data records before they have been processed into the system. Batch files are created as part of the upload or direct entry process. Batch files contain electronic documents 144 records and/or debtor records. Records remain in the batch file until they have been appropriately processed into the system. Batches 146 can themselves can be reviewed and modified by the financial institution to suit the financial institution's 108 requirements.

Tasks and alerts 148 are configured by the financial institution 108 and can be associated to clients 102, debtors 120 and portfolios. Tasks and alerts 148 are the method by which workflow and notifications are managed within the ABL application 116. The ABL application 116 offers a full suite of tasks and alerts to help the financial institution 108 identify when important events occur or to perform various process related tasks.

Users 150, at the financial institution 108, are assigned permissions and then assigned to groups 138 within the hierarchy. Users 150 can then perform permission related tasks for the group 138 to which they are assigned.

The master debtor 152 provides the facility to identify all instances where a single debtor 120 is related to multiple client ledgers. When a client debtor is added to the system, if the debtor 120 already exists then a relationship is made between the new debtor 120 and the master debtor 152. This continues for as many times as the debtor 120 is added for a different client 102. This important feature enables the financial institution 108 to view the debtor 120 across all of its related clients 102. The master debtor 152 provides a powerful tool when assessing the debtors risk and changes to the debtor's risk score.

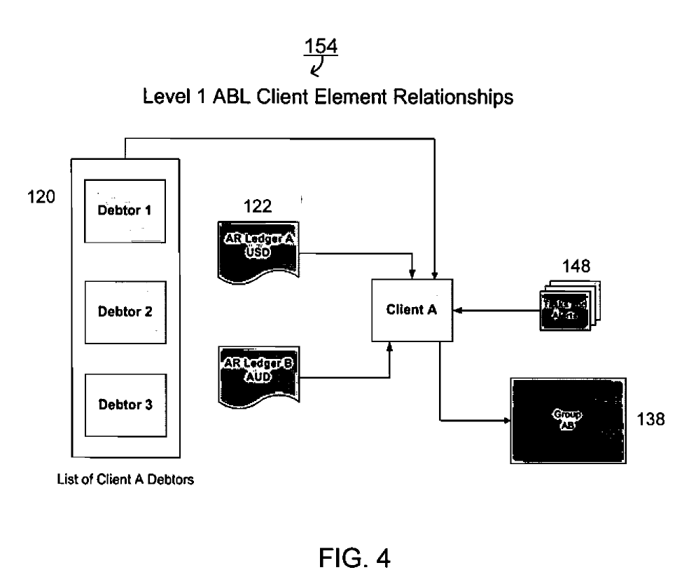

FIG. 4 is a diagram illustrating the client element ABL relationships 154. Clients have elements for (1) accounts receivable ledgers, (2) debtors, (3) tasks and alerts and (4) and groups.

The client 102 can have any number of AR ledger 122. Each AR ledger 122 specifies a currency. One of the primary reasons that AR ledgers 122 are currency specific is to allow for borrowing base calculations and funding of the accounts receivables in the currency specified in the AR ledger 122. If an AR ledger 122 contained accounts receivables data for multiple currencies, it would be difficult to value the AR ledger 122 due to constant changes in the base currency exchange rate. The present system enables the financial institution 108 to value the client's 102 account receivables in the currency of the AR ledger 122. This provides the financial institution 108 with an accurate picture of the borrowing base calculated for each AR ledger 122, and the client 102 knows exactly what the borrowing base is worth. AR ledgers 122 also facilitate the ability for the financial institution 108 to have multiple AR ledger 122 with different valuations based upon the debtor 120 concentration.

A client's 102 debtors 120 are associated to one or more client AR ledgers 122. The financial institution 108 can view all debtors 120 associated with a client 102 or choose to view an individual client AR ledger 122 and see all debtors 120 associated with that AR ledger 122. This capability enables (1) the debtor 120 to do business with the client 102 in multiple currencies and (2) the financial institution 108 to manage the debtor 120 separately for each AR ledger 122.

A limitless number of tasks and alerts 148 can be configured for a client 102. The tasks and alerts 148 apply to all of a client's AR ledger 122. This provides the financial institution 108 detailed visibility to monitor and manage the client and associated AR ledgers 122.

A client 102 can belong to only one group 138. Groups 138 are part of the hierarchy structure and enable the management of tasks and alerts 148. Groups 138 make it possible for the financial institution 108 to configure any organization or functional structure needed to manage their clients 102. Groups 138 control work flow. When tasks and alerts 148 are issued for a client 102, the users 150 that belong to that same group 138 will typically be the first to receive the task or alert 138. Groups 138 also contain business hours and holiday as well as time out parameters for tasks and alerts 148.

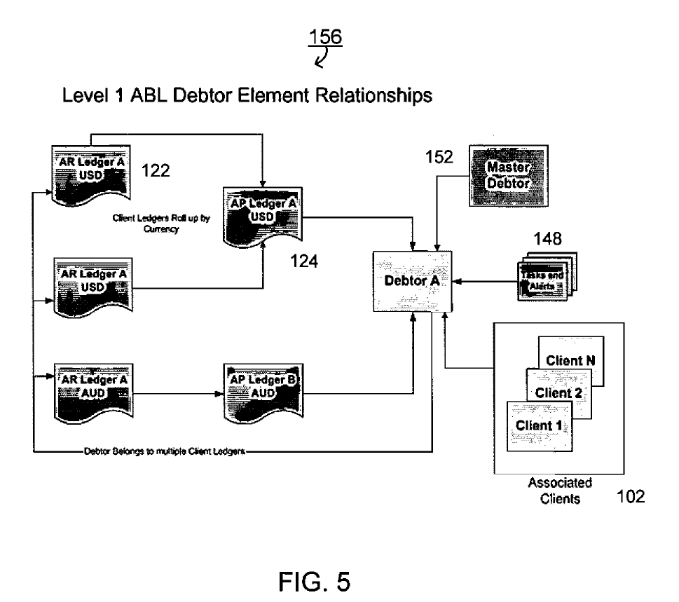

FIG. 5 is a diagram illustrating the ABL debtor element relationships 156. Debtors 120 have elements for (1) client ledgers, (2) clients, (3) currency ledgers, (4) tasks and alerts and (5) and master debtor.

Debtors 120 are included in client AR ledgers 122. A debtor 120 may belong to any number of AR ledgers 122. The AR ledgers 122 are currency specific, as illustrated in FIG. 5 with AP ledger 124 (A) denoted in USD and AP ledger 124 (B) denoted in AUD. Debtor portfolios and AP ledgers 124 are both possible because of these relationships. Additionally, the accounts receivables associated with a debtor 120 are visible in detail and summary from the client AR ledger 122.

Debtors 120 are the client's customers. The client 102 typically has every debtor 120 approved by the financial institution 108 prior to uploading any related accounts receivables information. Once the debtors 120 are approved, the associated accounts receivable can be processed as part of the borrowing base.

Because a debtor 120 may belong to any number of client AR ledgers 122, and since client AR ledgers 122 are currency specific, this unique relationship enables the system to provide a consolidated view of the debtors' accounts payable across the clients 102 having ledgers in the same currency. The consolidated view give the financial institution 108 a unique perspective of the debtors' 120 payment trends, credit rating, dilution, etc., across the debtors' clients in the ABL application 116. Additionally, the accounts payables associated with a debtor 120 are visible in detail and summary from the debtor's currency ledger.

A limitless number of tasks and alerts 148 may be configured for a debtor 120. The tasks and alerts 148 apply to all of the client AR ledgers 122 to which the debtor 120 belongs. This provides the financial institution 108 detailed visibility to monitor and manage the debtor 120 and its associated AP ledgers 124. An example alert might be to notify the responsible financial institution 108 when the debtor's credit rating reaches a predetermined level.

When a debtor 120 is added for a client 102, the system checks to see if the debtor 120 already exists within the system for the client 102. If the debtor 120 does not exist, then the system creates a master debtor 152 record to which the new debtor 120 is associated. If the debtor 120 already exists, then the system associates the new debtor 120 with the existing master debtor 152. Thus, the financial institution 108 may know all of the clients 102 to which a debtor 120 is associated. This is a powerful took when assessing changes to the debtor's risk score or understanding the percentage of the total borrowing base associated to that debtor 120 across all client AR ledgers 122.

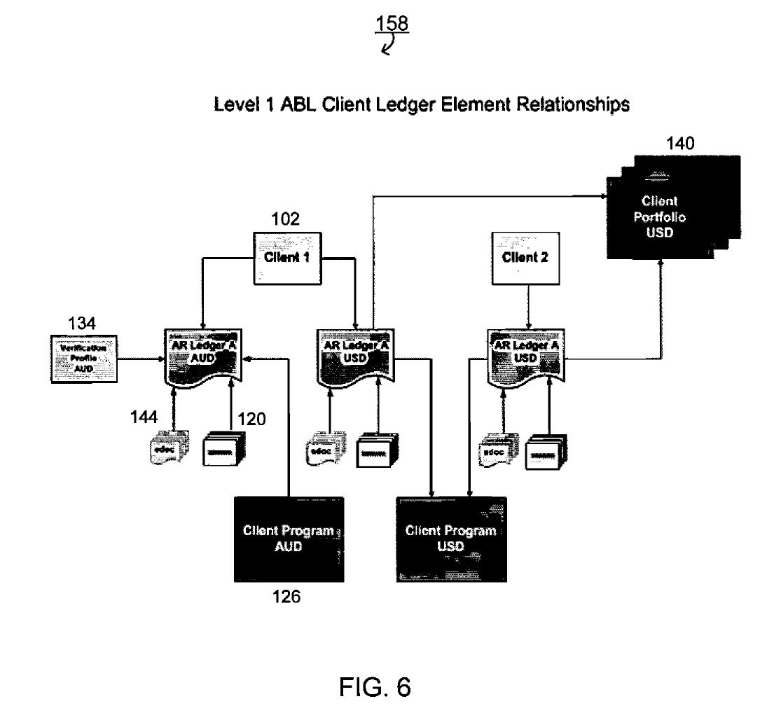

FIG. 6 is a diagram illustrating the ABL client ledger element relationships 158. Client AR ledgers 122 have elements for (1) verification profiles, (2) client programs, (3) electronic documents, (4) debtors, (5) client portfolios, and (6) clients.

The ABL application 116 enables the financial institution user to associate a verification profile 136 to a specific AR ledger 122. This provides the capability for the financial institution 108 to configure specific verification rules for that client's AR ledger 122. Verification rules assigned at the ledger level override verification rules assigned to the client program 126 to which the client's AR ledger 122 is associated.

The electronic documents 144 associated to a client's AR ledger 122 are either detail or summary documents. The ledger type selected by the financial institution 108 at the time of set-up determines the level of detail required.

Clients 102 having detailed AR ledger 122 provide all accounts receivables details and can be reconciled either at a summary level or detailed level. Financial institutions 108 have a greater level of confidence when lending to clients 102 that provide detailed accounts receivables information. Detail ledgers offer a granular view of the clients 102 accounts receivable and, therefore, provide a more accurate picture of dilutions, payment trends and other key factors used when calculating the client's facility. Further details regarding the use of electronic documents 144 are provided below.

Summary clients 104 enter summary ledger data for each debtor 120. While not as accurate as a detailed clients ledger data, summary functionality provides a lending solution for clients 102 that are unable to provide detailed data.

A client 102 can belong to more than one portfolio via its ledger. This allows the financial institution 108 to associate the client's AR ledger 122 to any number of portfolios. In this manner the client 102 can be associated with any number other clients 102 (providing their ledgers are in the same currency) for the purpose of providing portfolio queries and management.

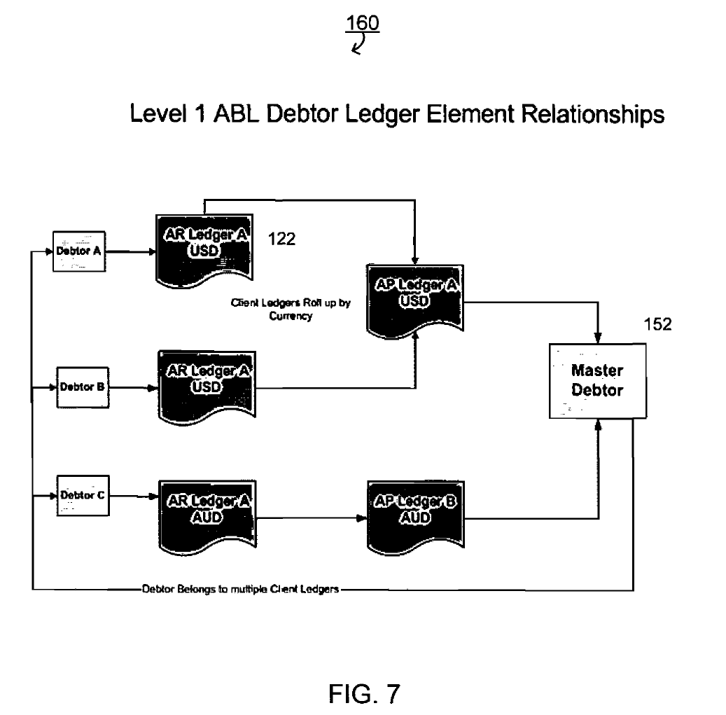

FIG. 7 is a diagram illustrating the ABL debtor ledger element relationships 160. Debtor AP ledgers 124 have elements for (1) client ledgers and (2) master debtor.

The client AR ledgers 122 include the ledgers to which that debtor 120 is associated. This association occurs via the master debtor 152 element. The debtor's AP ledger 124 is a summary ledger consisting of all account receivable data across all client AR ledger 122 having the same currency. Therefore, if a debtor 120 is associated to client AR ledger 122 having multiple currencies, the debtor 120 typically has a summary accounts payable ledger for each currency.

The master debtor 152 indirectly associates all of a debtor's instances to their client's AR ledgers 122 for the purpose of viewing a consolidated list of currency specific ledgers across all clients 102.

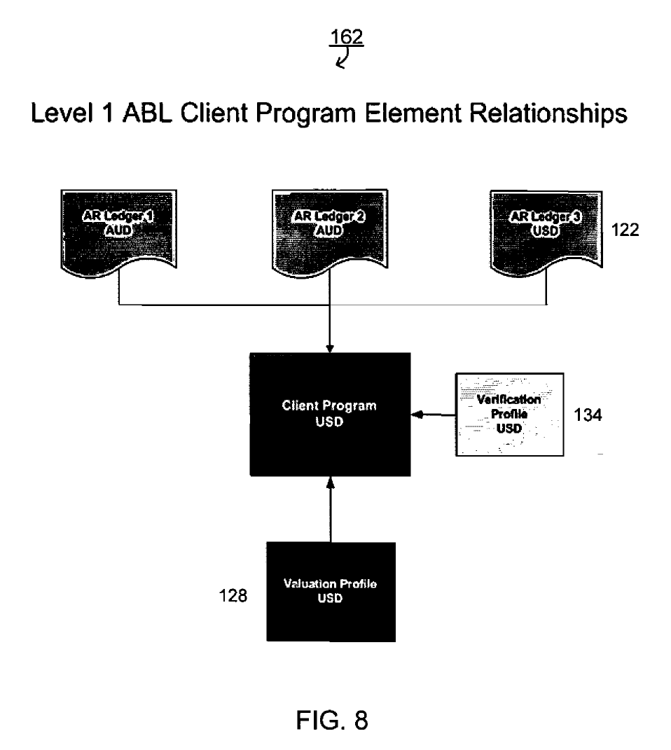

FIG. 8 is a diagram illustrating the ABL client program element relationships 162. Client programs 126 have elements for (1) verification profiles, (2) valuation profiles and (3) client ledgers.

A client program 126 has an associated verification profile 136. The verification profile 136 defines the specific verification rules for all clients 102 associated with the client program 126. Verification profiles 136 directly assigned to a client 102 belonging to a client program 126 take precedence over the verification profile 136 assigned to the client program 126.

Valuation profiles 128 assigned to the client program 126 apply to all client ledgers assigned to the client program 126. If the financial institution 108 desires a separate valuation profile 128 for any given client Ar ledger 122, then the financial institution 108 establishes a separate client program 126 and moves the client AR ledger 122 to that client program 126.

The assignment of a client AR ledger 122 to a client program 126 is performed by editing the client AR ledger 122 and selecting the desired client program 126. A client AR ledger 122 can have a verification profile 136 assigned. For all cases where a specific verification profile 136 is assigned to a client AR ledger 122, the specific assignment typically overrides the verification profile 136 assigned to the client program 126.

The valuation profile 128 tool assists the financial institution 108 in accurately determining the borrowing base for all clients 108. The valuation profile 128 consists of pricing profiles 130 and tier 134 parameters. Tier 134 parameters are configured by the financial institution 108 to calculate the borrowing base in such a way that if reflects the financial institution's appetite for risk and revenue. Once configured and activated, the valuation profile 128 parameters are used in the borrowing base calculation to value all of the client's debtors invoices. The tiers 134 are used to segregate debtors 120 into groups 138 based on their risk score. The tiers 134 determine how much of any one debtor's invoices can make up the client's 102 borrowing base.

The pricing profile 130 determines the rates and fees applied to the client's facility when creating a draw.

A valuation profile 128 is associated with a client program 126. Valuation profiles 128 are currency specific and preferably are not associated with a client programs 126 having a different currency. Valuation profiles 128 can be used in any number of client programs 126. They also allow for identification of all instances where client programs 126 are affected by modifications to a specific valuation profile 128.

Valuation profiles 128 having a status of “development” have the capability to run “what if?” scenarios. These scenarios enable the financial institution 108 to modify the development valuation profile 128 and, from the related client program tab, initiate a borrowing base calculation against any client program 126 associated with that valuation profile 128. The results are displayed back to the financial institution 108 on a results page that show the change in current available borrowing base and recalculated borrowing base for all clients AR ledgers 122 associated with the selected client program 126. Financial institutions 108 can then see the potential effects of their valuation profile 128 changes before they are implemented.

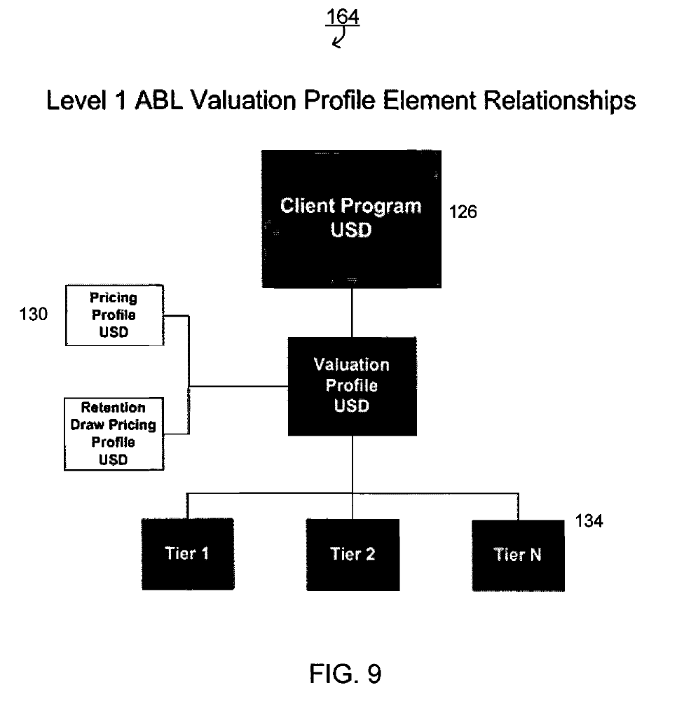

FIG. 9 is a diagram illustrating the ABL valuation profile element relationships 164. Valuation profiles 128 have elements for (1) client programs, (2) pricing profiles and (3) tiers.

A valuation profile 128 can be associated to any number of client programs 126. Preferably, the valuation profile 128 cannot be deactivated if it is associated to an active client program 126.

The pricing profile 130 provides the rates and fees that are associated with the valuation profile 128. A valuation profile 128 can have a new pricing profile 130 assigned. Preferably, the pricing profile 130 can not be deactivated if it is assigned to an active valuation profile 128.

The tiers established for the valuation profile 128 provide the criteria used in calculating the borrowing base. Preferably, pricing tiers are modifiable. Pricing tiers are established to value debtor's receivables in the AR ledger 122. The valuation profile 128 can have as many tiers 134 as the user 150 desires. Tiers 134 are cross-referenced to a debtor 120 or multiple debtors. There can be any number of pricing tiers associated with a valuation profile 128. Tiers 134 provide the financial institution 108 with a flexible and granular method for valuing the borrowing base.

Accessed from the manage menu options, a user 150 with the appropriate role is able to create, fine tune (perform what-if scenarios before posting—make them available) and manage valuation profiles. The user 150 is typically a credit manager or someone with credit responsibilities. Once the user 150 has posted a new valuation profile, it typically appears in a table of available valuation profiles 128 and be seen as active.

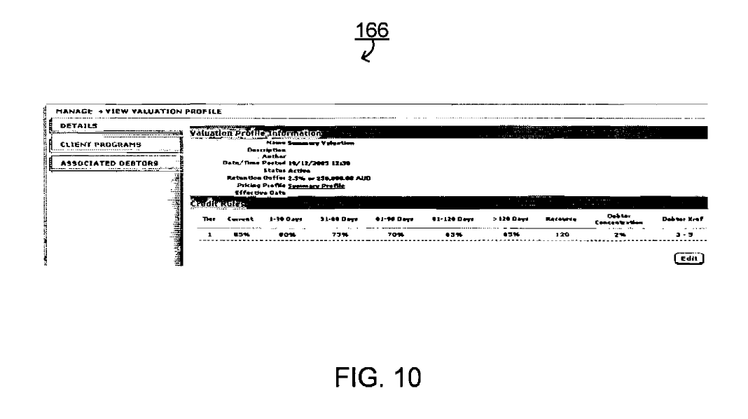

FIG. 10 is a screen image illustrating an example valuation profile 166 page. The valuation profile 128 contains three tabs for details, client programs 126 and associated debtors 120. Under the details tab, fields for (1) name, (2) description, (3) author, (4) date/time posted, (5) status, (6) retention buffer, (7) pricing profile and (8) effective date. The fields are shown in the section labeled ‘valuation profile information.’ The name of the profile is supplied by the financial institution 108. The description field provides detailed information regarding the valuation profile 128. The author is the user 150 that created and made the valuation profile 128 active. The date/time posted field provides the date and time the valuation profile 128 was made active. The status may be (a) development, (b) active or (c) inactive.

The development status corresponds to a user 150 fine tuning the profile, where the profile is not made available for association with a client program. While in development status, the profile cannot be associated with a client program 126.

An active valuation profile 128 is available from the list of available profiles and is ready for association with the client program 126.

An inactive valuation profile 128 cannot be associated with a client program 126. When a valuation profile 128 is set to inactive, the user is required to select another active profile to replace the inactive profile. A replacement active profile is selected for any client program 126 that has the inactive valuation profile 128 associated with it. It should be noted that a client program 126 cannot have an inactive valuation profile associated with it. However, any changes made to a profile once it is assigned typically result in generation of another profile; the old client program 126 remains active and applies to any other client AR ledgers 122 associated with it. (The old client program therefore remains unchanged against any other client AR ledger 122 associated with it, unless the user chooses to “replace all associated ledgers”. Preferably, the new client program 126 created does not take effect until the next business day.

The retention buffer is stored as both a percentage and an amount. These figures are used to determine the minimum retention amount. If the retention percentage is greater than the minimum retention amount after the borrowing base has been calculated, the borrowing base is adjusted down to leave the required retention amount. To determine the minimum retention amount, the system compares the two values and use the greater value.

The pricing profile 130 is the pricing profile 130 that applies to all draws, regardless of tier. The pricing profile 130 also applies to any retention draws.

The effective date controls when the active profile takes effect, e.g., next business day.

Also shown in FIG. 10 are valuation tiers under the section labeled ‘credit rules.’ Valuation tiers are established to value debtor's receivables in the AR ledger 122. The valuation profile 128 can have as many tiers 134 as the user desires. Tiers 134 are cross-referenced to a debtor 120 or to multiple debtors.

Aging columns are established to age the accounts receivable for valuation purposes. The user may set up any number of aging columns. The aging columns are presented showing from-to dates. For example, 0-30 (0 being today), 31-45, 46-60, 61-75, 76-90 and >90. The numbers represent the days. The system takes the AR ledger 122 and ages it into these columns. (It should be noted that the system ensures that the next tier added begin with next sequential number from the previous tier, thus preventing any gap between the numerical sequencing of tiers.)

The aging values are the percentage of the summary value (ABL summary draw) or transaction (invoice) value within that aged column that the ABL system calculates as the borrowing base, for ABL, or as the amount paid—balance being retention in the case of ABL.

The maximum tenor (also “recourse days”) is the maximum number of days old that the summary amount or transaction (invoice) can be accepted into the valuation calculation. For example, if the tier 134 has a maximum tenor of 90 days and the accounts receivable debtor has summary value and/or transactions older than 90 days, these are excluded from the valuation of the borrowing base.

Preferably, there is a default maximum tenor value stored at the AR ledger 122 level in the verification profile 136. The AR ledger 122 value is used as a default, with value in the valuation profile 128 overriding the AR ledger 122 default setting as necessary.

Additionally, there is a flag also set at the AR ledger 122 level to determine how the tenor is calculated. The tenor may be calculated either by invoice date or by month received date. For calculating by invoice date, the age of the invoice is calculated from the actual invoice, and then determination is made as to whether or not it falls within the maximum tenor. For calculating by month received date, for the purposes of the maximum tenor, the effective invoice date becomes the end of the month date of the invoice. For example, an invoice date of Jan. 1, 2005 becomes an effective date of Jan. 31, 2005).

The debtor 120 concentration is the maximum concentration by any one debtor 120 as a percentage of the total borrowing base or the trade being calculated. Once a debtor 120 reaches the concentration limit, the balance of the receivables value associated with that debtor 120 are excluded from the calculation.

The client programs 126 is a list of client programs 126 that the valuation profile 128 is associated with. The table is shown as a tab (or menu item hyperlink).

The debtor cross reference is a group of debtors associated with that tier 134. They can be grouped by the user 150, or the user 150 can associate a debtor rating number. All debtors 120 with that rating are typically included unless already in a specific tier 134. The user 150 assigns the risk score to each tier—or a range of risk scores as in the example profile below—or the user 150 selects specific debtors 120 to a tier 134. Specific debtors 120 are assigned to a tier 134 by direct association. The ABL system allows the financial institution user to search for and select a debtor 120 to specifically attach that debtor 120 to a tier 134.

Creating and Fine-Tuning A Valuation Profile

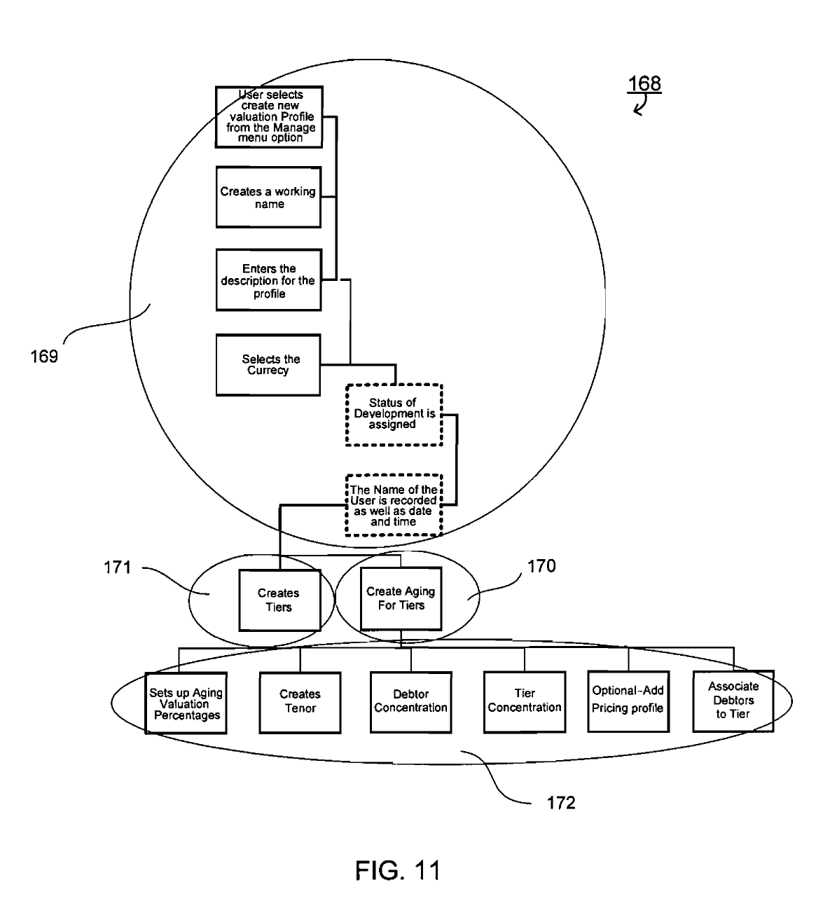

FIG. 11 is a diagram illustrating the steps for valuation profile creation 168. A user 150 may create a valuation profile 128, fine tune the valuation profile 128, and change the valuation profile 128 status to active. Fine-tuning of the valuation profile 128 is necessary to ensure that the right results are achieved when applied. The user 150 is able to select client's AR ledgers 122 or groups of client's ledgers to run the scenarios against. ABL scenarios are compared to the existing valuation of the selected client's AR ledgers 122.

The initial step 169 adds the valuation profile 128 and associated descriptive information. System captured data includes setting the profile to a development status and inserting the user name and date/time entered.

An optional step 170 allows the user 150 to configure any number of aging categories. This is optional since there are preset aging categories already configured.

Any number of tiers 134 may be configured by the user as shown with step 171.

Finally, once the tiers have been added, at step 172 the user 150 then enters the data into the tier parameters such as aging valuation percentages, creating tenor, debtor concentration, tier concentration, optional add pricing profile, associate debtors to tier, among others.

Once the user 150 has completed the steps required to create the valuation profile 128, the user 150 can then fine tune the values in the set-up under the development status.

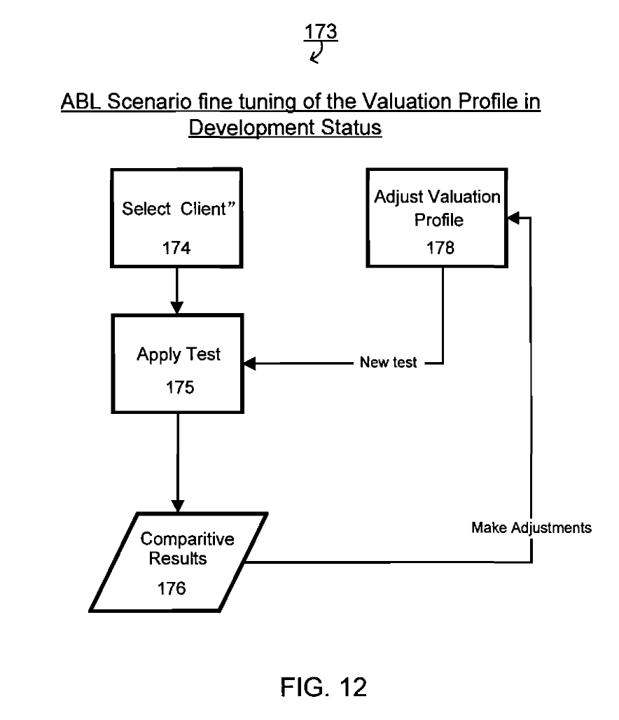

FIG. 12 is a diagram illustrating the steps for fine-tuning a valuation profile 173. The user 150 selects clients 174 to test the new valuation profile 128 against. The system checks the clients AR ledgers 122 and matches the ledgers based on currency. Next, the system applies the test 175 by testing the valuation profile against the currently selected ledgers and provides comparative results. Comparative results 176 compare the current borrowing base to the new valuation profile 128 being tested. Adjustments 178 are then made to the valuation profile and a new test begins. As each new test is completed, the results are recorded against the current borrowing base of the selected client's AR ledgers 122, as well as the results from prior tests. The results are recorded so long as the valuation profile 128 is in development status.

Users 150 with the role to create the valuation profile 128 are able to work with a valuation profile 128 once it is set up in development status. The user 150 selects clients 102 or groups 138 of clients AR ledgers 122 to perform “what if” scenarios. These scenarios use real data from the clients 102 selected but do not overwrite the active valuation profiles 128 assigned to the client program 126. The purpose of this “fine-tuning” functionality is for the user 150 to determine the optimal valuation based on their risk assessments against the client data, doing comparisons to the actual posted valuation profile 128.

Each fine-tuning pass creates a results table. The results table shows (1) the valuation by tier (currency value), (2) the valuation of the overall asset and (3) the retention percentage.

These results are saved each time to a log, so that the user can compare results against each pass.

Once the user 150 has completed the fine-tuning, the status is changed to active. It should be noted that as long as the valuation profile 128 remains in development status, it may be deleted. However, once it is active, it can not be deleted, only made inactive.

Calculating Borrowing Base

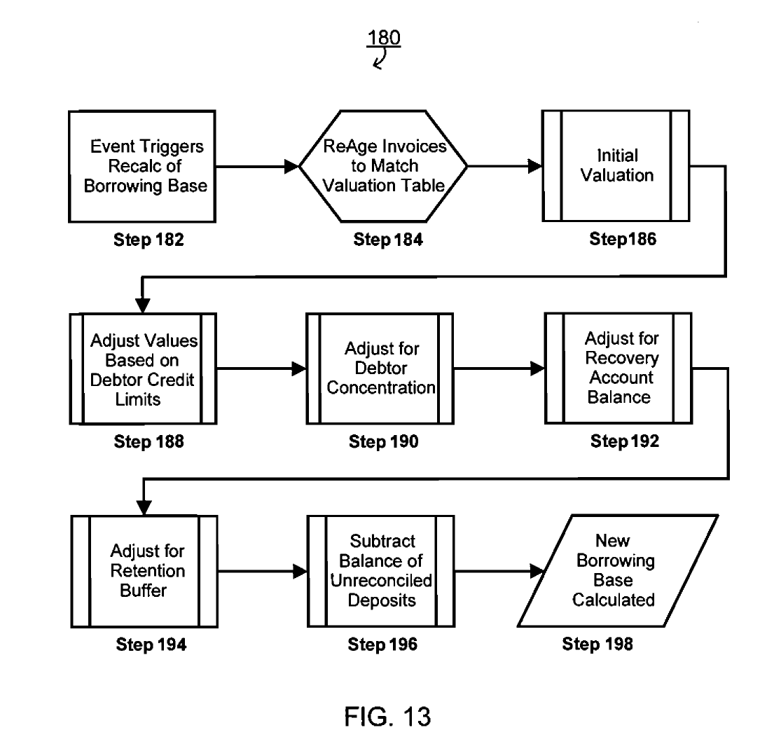

FIG. 13 is a diagram illustrating the steps for the borrowing base calculation process flow 180. The Valuation profiles 128 are used to value the total AR ledger 122 and calculate the borrowing base of each ledger.

Both ABL summary and detail are calculated based on the total owing by aging by debtor 120. The system calculates the borrowing base automatically at any time an event occurs that could affect the borrowing base amount. Events that trigger a recalculation of the borrowing base include (1) new e-documents received (invoices, journal entries, credit memos, cash applications), (2) any new draw is funded, (3) the valuation profile assigned to the ledger is modified, (4) the credit limit of one or more of the client's debtors is modified, (5) fees are charged to the client, (6) deposits are received, (7) deposits are reconciled, (8) client is refunded money from the recovery account, (9) reversals are performed and (10) daily recalculation for aging purposes.

The borrowing base calculation steps are (1) an event occurs that causes the borrowing base valuation to be recalculated, (2) re-age the ledger to fit the valuation aging columns and sort debtors into tiers, (3) first pass result—initial valuation (without any debtor credit limit or debtor adjustment), (4) check, calculate and adjust, if required, for debtor credit limits. If a valuation is above an individual debtor credit limit, then the value is reduced to match that credit limit, (5) calculate and adjust, if required, for debtor concentration, (6) calculate and adjust for the recovery account, (7) calculate and adjust, if required, for the retention buffer, (8) subtract balance of un-reconciled deposits and (9) result after debtor credit limit, debtor concentration checks, recovery account, retention buffer, and un-reconciled deposit adjustment(s), thus providing the new borrowing base.

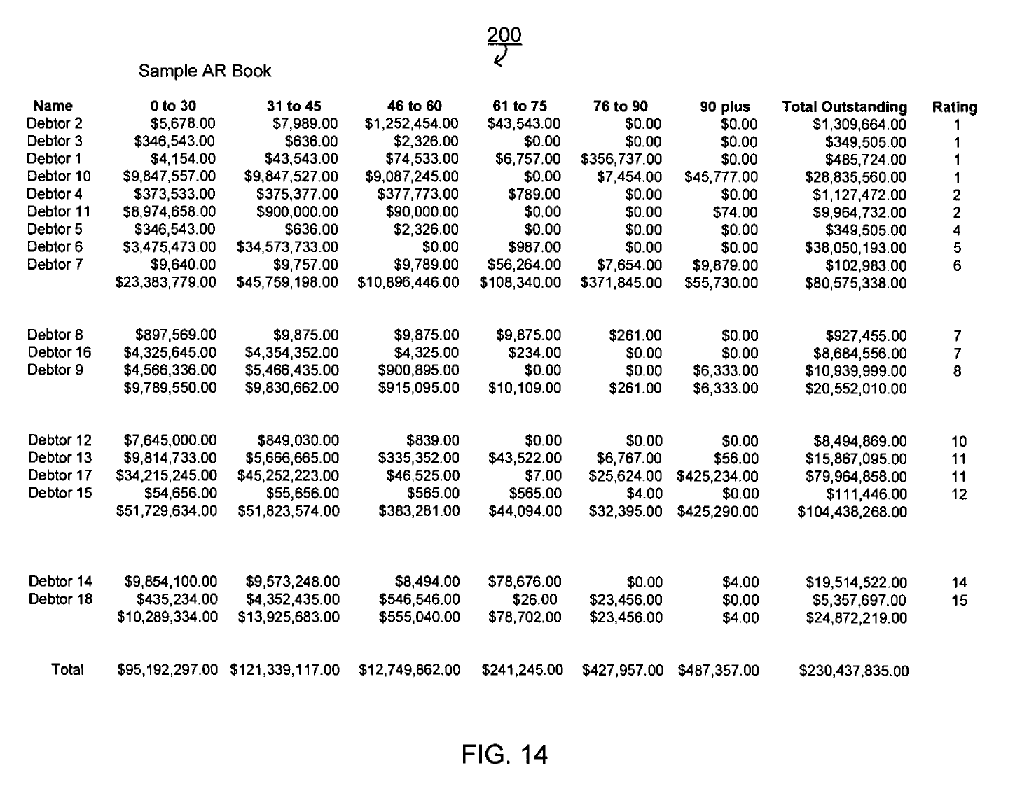

FIG. 14 is an example illustrating a sample client's accounts receivable book, debtors and their associated rating prior to valuing the borrowing base 200.

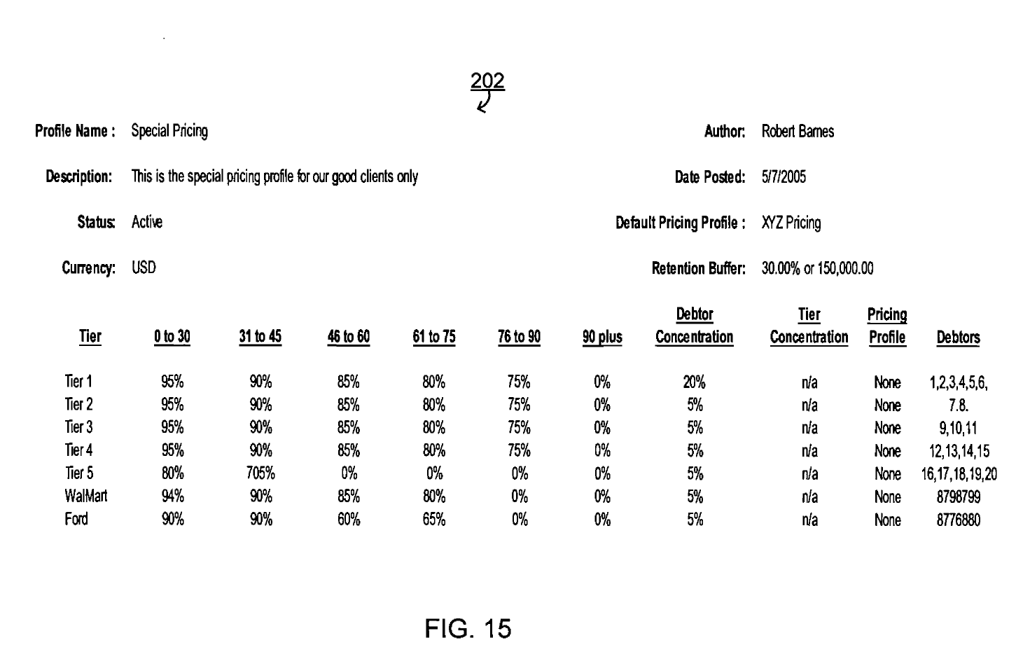

FIG. 15 is an example illustrating the use of a pricing profile to determine the borrowing base 202. It should be noted that the debtor column on the right represents the debtor ratings associated with the tier. For this example, tier 1 ages debtors with ratings 1 through 6.

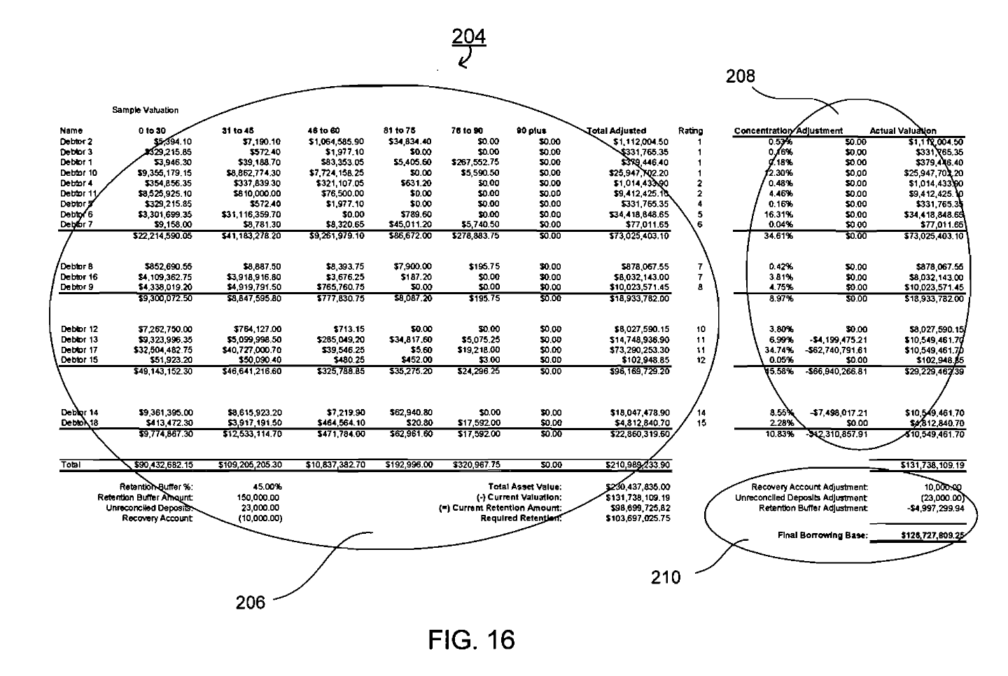

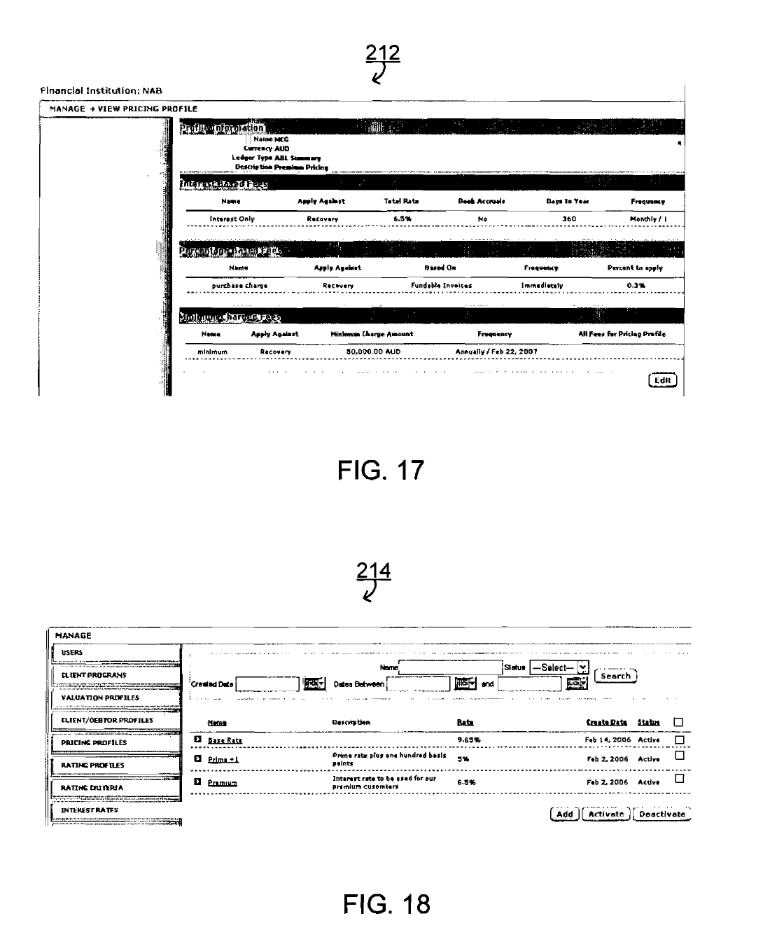

FIG. 16 is an example illustrating the results when applying a valuation profile against reorganized accounts receivable debtors 204. The data is selected in FIG. 17 below may be processed utilizing the steps discussed below and providing the results given in FIG. 16.

The material included within section 206 of FIG. 16 illustrates steps 1 through 3. In step 1, the debtors are organized into tiers based on their ratings (only tier 1-5 pertain). Then in step 2, each of the debtors invoice amounts are multiplied by the percentage value of the valuation profile aging column for those invoices in that tier/column combination leaving the amount accepted for that debtor. For example, debtor 2 in FIG. 14 had $5,678 in aging column 0 to 30 of tier 1. The percentage from FIG. 15 valuation profile tier 1 (0 to 30) is 95%. The resulting amount shown in FIG. 16 debtor 2 section 206 is $5,394.10. In step 3, the adjusted amounts are added to yield the total adjusted column on the far right of section 206.

Referring to section 208 in FIG. 16, step 4 illustrates that debtor credit limits reduce the amount any one debtor can occupy for that respective tier. For example, if debtor 2 had a credit limit of $5,000 then only the $5,000 would be accepted not the estimated $5,394.10. Next in step 5, the debtor concentration parameter (see FIG. 8) for each tier is applied against the total adjusted in FIG. 16 for each debtor to restrict the debtor to only contribute that percentage to the borrowing base. For example, in FIG. 16 section 208, the concentration percentage adjustment for debtor 17 of the overall borrowing base is 34.74%. However, the debtor concentration parameter (see FIG. 15) for that debtor is 5%. Therefore, the debtor 17 contribution is reduced by $62,740,791.61.

Steps 6 through 9 in section 210 illustrate the recovery account balance adjustment, the retention buffer adjustment and the un-reconciled deposits adjustment.

From FIG. 16, an example of the calculations show that the total asset value is $230,437,835.00. The initial valuation based on aging and debtor tier is $210,989,233.90. The amount adjusted for debtor credit limits and debtor concentration is $131,738,109.19. The amount adjusted for recovery account if $131,748,109.19 and the adjusted for retention buffer amount is $131,748,109.19. The amount adjusted for un-reconciled deposit balance is $126,727,809.25. Thus, the final borrowing base valuation, as shown at the bottom of section 210, is $126,727,809.25.

It should be noted that debtor concentration is calculated against the total accounts receivable valuation. It should further be noted that the system also checks the credit limit of the debtor 120 to see if the borrowing base amount based on that debtor 120 does not exceed the debtors credit limit. Should this be the case, the credit limit amount applies for that portion of the ledger that is based on that debtor 120. For example if we assumed that debtor 14 had a credit limit of $11 million then the total value of the debtor before adjustment for concentration would have been $11 million and not $18 million as shown.

When calculating the available funds, the borrowing base is compared to the client's credit limit; the total amount of outstanding draws is subtracted from the lesser of the two amounts.

Pricing profiles provide the capability to configure the fees and interest applied to a client's ledger that is associated to a valuation profile.

FIG. 17 is a screen image of an example pricing profile page 212. The pricing profile page 212 contains the basic pricing profile 130 information including name, description, currency, profile type, ledger type and any additional fees as configured. The financial institution user manages the pricing profile 130 via a GUI provided by the ABL application 116.

Configuration of a pricing profile 130 includes (1) entering the pricing profile name, currency, ledger time (summary or detail) and description, and (2) adding fees. Fees are configurable and a financial institution 108 can add any number of fees to a pricing profile 130. Fee types may be interest base, per transaction, percentage based, minimum charged or minimum funding level.

The interest-based fee allows the financial institution 108 to charge the client 102 monthly interest against their total utilized funds.

Per transaction fees allow the financial institution 108 to charge a fixed amount per transaction, for various transaction types, including per draw, per invoice, etc. This allows the financial institution 108 to charge a certain amount per each invoice in the system, each debtor 120 for the client, etc. The financial institution 108 could also charge an amount per client ledger, for example. If the financial institution 108 desired to charge the client 102 a yearly fee, regardless of funding, they could set up a per transaction charge based on the client AR ledger 122, and set the frequency to be an annual charge.

Percentage-based fees allow the financial institution 108 to charge a specified percentage against a selected amount. This amount could be the draw amount per draw, or it could be based on an average or sum of values over a specified period of time.

Minimum charge fees allow the financial institution to determine a minimum charge that applies periodically. The financial institution 108 can use this to ensure that they receive a minimum amount of revenue for a given time period. At the end of the specified period, the ABL system calculates the total amount of revenue earned based on the fees configured in the list. If the total earned is less than the minimum required amount, the client is charged the difference.

Minimum funding level fees allow the financial institution 108 to charge the client a fee if the client 102 does not fund up to a certain amount over a specified period of time. This fee can be a percentage of the difference between the required funding level and the actual funding level or as a fixed amount.

Assigning Pricing Profiles to Valuation Profiles

Only one active default pricing profile is assigned to a valuation profile 128. A valuation may also have one active retention draw pricing profile assigned to it. The first step in assigning pricing profiles 130 to valuation profiles 128 is to locate the desired valuation profile 128 by first accessing the list of valuation profiles 128 from the “manage” option on the main menu (the search capability may be used if necessary). Selecting the valuation profile 128 name hyperlink allows for viewing the valuation profile 128 details. Then, selecting the edit button causes the valuation profile 128 to be displayed in edit mode. Next, selecting the pricing profile link displays the current pricing profile 130 assigned to the valuation profile 128 (if one exists). Next, the search capability is used to locate the desired pricing profile 130 (the pricing profile details may be viewed from this table). Finally, selecting the “associate” button associates the pricing profile 130 to the valuation profile 128. It should be noted that changes as outlined above preferably do not take effect until the following day.

Maintaining Interest Rates

FIG. 18 is a screen image illustrating an example interest rates list page 214. Interest rates are maintained by financial institution users having the appropriate permissions. It should be noted that all interest rates are entered and displayed as percentages rather than basis points. The values are stored in the database as basis points. Screens that display basis points typically display the values as percentages.

Interest rate lists may be accessed by selecting the manage option from the financial institution main menu. Selecting the interest rates option from the available management criteria causes a list of interest rates to be displayed. The search criteria at the top of the interest rates list is used to locate an interest rate. Search criteria options include name, current rate, status and crate date, as well as a date range. The date range searches on all rates that were active within the selected range of dates. Finally, the desired search criteria may be entered and then the search button selected.

Interest rates may be added by selecting the add interest rate button to display the add interest rate page. The add interest rate functionality is essentially the same as the modify functionality.

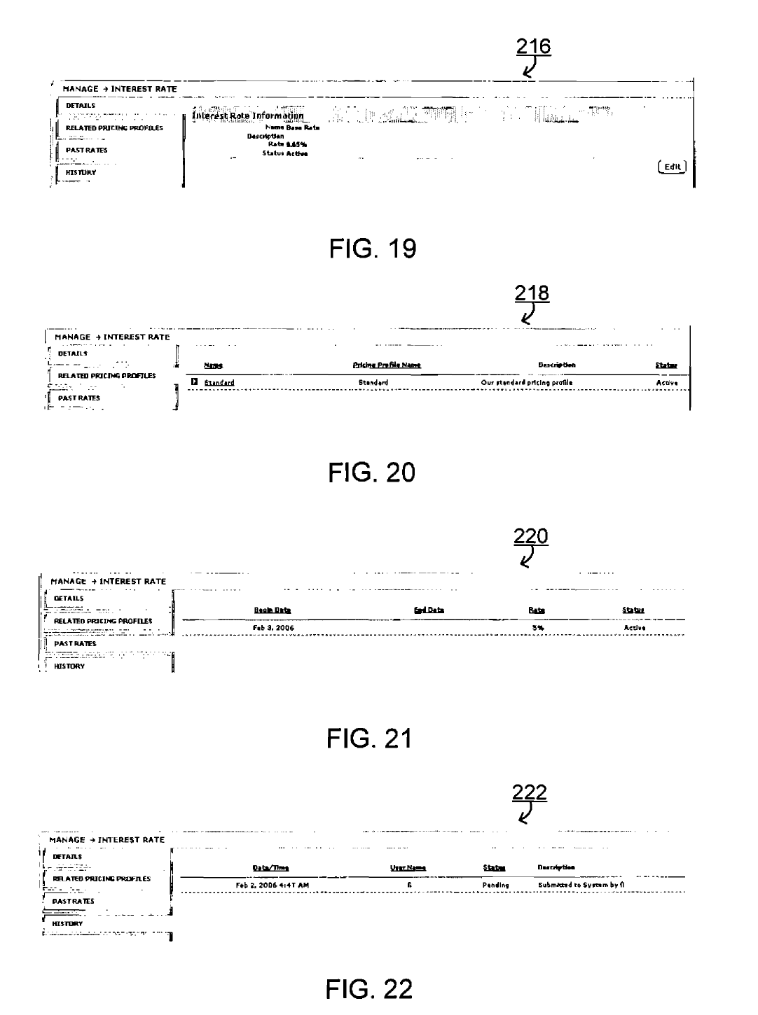

FIG. 19 is a screen image illustrating an example interest rate detail page 216. Selecting the underlined interest rate name causes the associated interest rate details to be displayed. Interest rates may be modified by selecting the edit button to display the edit interest rate page. The edit interest rate page has the same fields as the previously described view page.

FIG. 20 is a screen image illustrating an example related pricing profiles tab 218. All pricing profiles that currently use the interest rate are displayed.

FIG. 21 is a screen image illustrating an example interest rate detail—past rates tab 220. Past interest rates may be displayed.

FIG. 22 is a screen image illustrating an example interest rate detail—history tab 222. Changes to the interest rate record may be displayed.

The ABL system provides the ability to automatically update interest rates in the ABL system through an integration process with the financial institution's internal system.

Verification Profiles

FIG. 23 is a diagram illustrating the ABL verification profile element relationships 224. Verification profiles 128 have elements for client programs 126 and client AR ledgers 12.

Verification profiles 128 can be associated to any number of client programs 126 and client AR ledgers 122. Verification profiles 128 apply to client AR ledgers 122 associated with the client program 126 unless the client AR ledger 122 has a specific verification profile 128 assigned.

Verification profiles 128 can be associated to any number of client AR ledgers 122. Verification profiles 128 specifically assigned to a client AR ledger 122 override the verification profile 122 assigned to the client program 126.

Groups

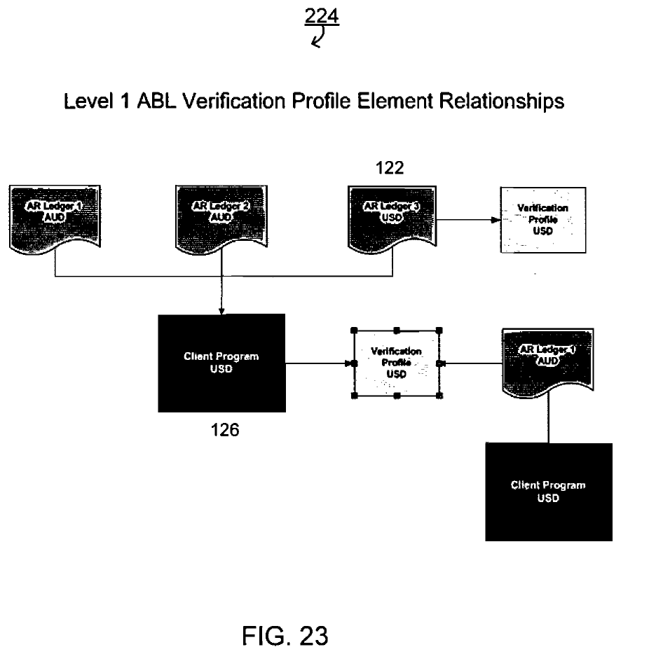

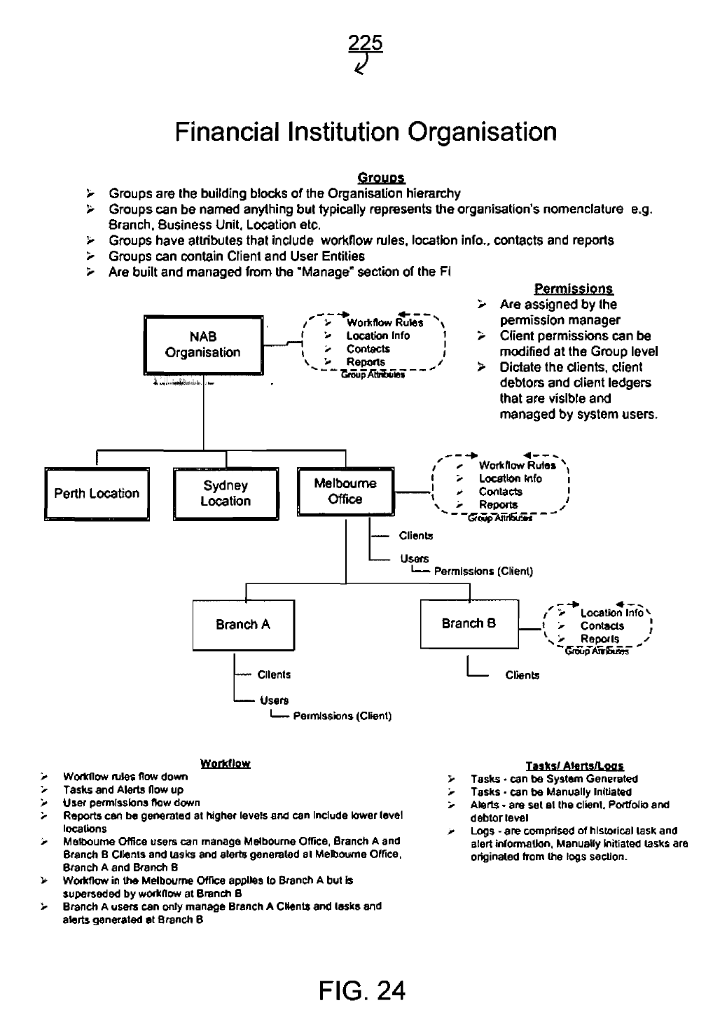

FIG. 24 is a diagram illustrating an example group hierarchy for a financial institution 225. The present system uses a group concept to manage the organizational hierarchy. Groups 138 can be used to represent locations, branches, and departments, among others, as necessary. The groups 138 can be used to represent a financial institution's organizational structure or any other structure necessary for assisting the organization in managing clients, user notifications and reporting. The diagram in FIG. 24 illustrates how groups 138 work to facilitate the organization, permissions, and tasks and alerts, associated with the financial institution.

Groups 138 are the building block of an organizational hierarchy and thus, clients 102 are organized into groups 138. When clients 102 are created they automatically belong to a group 138. Group names are not restricted but typically represent the organizational nomenclature such as branch, business unit, and location, among others. Groups 138 have attributes that include workflow rules, location information, contacts and reports, among others. Groups 138 can contain client 102 and user 150 entities and are built and managed from the “manage” section of the financial institution. Clients 102 can also be moved between groups 138.

Client permissions are a set of permissions pertaining specifically to a client 102 and to the client's debtor. Client permissions are active at the group level. Client permissions are assigned by the permission manger and can be modified at the group level. Permissions determine the clients 102, client debtors 120 and client AR ledgers 122 that are visible and managed by system users.

Workflow rules and user permissions flow down, while tasks and alerts 148 flow up the hierarchy. Reports can be generated at higher levels and can include lower level locations. For example, in FIG. 24, the Melbourne office users can manage Melbourne office, branch A and branch B clients, and tasks and alerts 148 generated at the Melbourne office branch A and branch B. Further, workflow in the Melbourne office applies to branch A, but is superseded by workflow at branch B. Branch A users can only manage branch A clients and tasks and alerts 148 generated at branch B.

Unless a user 150 is specifically assigned to an alert or task 148, client tasks and alerts 148 go first to users 150 assigned to the client's assigned group 138. Groups 138 can also have sub-groups. If a task or alert 148 is issued within a group where no users have the necessary role to action the task or alert 148, then the task goes to the next higher group 138. This can repeat until the task has reached the top of the hierarchy.

Permissions flow downward in the hierarchy so that a user 150 with permission at a higher group level also has those same permissions for all lower groups 138. Reports can use the hierarchy as a roll up and organization mechanism.

Groups 138 can have location information. Workweeks and holidays can be set at the group level for workflow and apply to subordinate groups if not set at those levels. Time zone and currency can be set at the group level. Daylight saving time is managed by the system and is accounted for by the central facilitator 106 application. For example, when the system recognizes a time zone change any group 138 having business hours assigned immediately operate on the new time zone.

Modification to a hierarchy does not take affect until the next day. All changes to a hierarchy are logged and are viewable. The capability to brand at the group level includes field sensitivity to regions. For example, a brand is for New Zealand and also controls the fields displayed.

A retry period can be set at the group level for tasks. The clients 102 and debtors 120 to which the financial institution user has visibility are based on the user's client permission and hierarchy assignment. Portfolios do not apply to groups 138 and are managed separately. Client permissions can be modified at the group level. Permissions pertaining to debtor add/disable/activate, for example, are unrelated to client permission.

Tasks can be system generated and can be manually initiated. Alerts are set at the client, portfolio and debtor level. Logs contain historical task and alert information. Manually initiated tasks are originated from the logs section.

Groups 138 consist of attributes and entities and are maintained in the system via the financial institution program in the “manage” function. During the initial system set up, a single high level organizational group is added. It is not necessary to establish groups 138 beyond this level; however, most organizations prefer to use groups 138 to help them manage the system in line with their business unit organization and reporting. In addition, groups 138 help to manage tasks and alerts 148, workflow, and the organization of clients.

FIG. 25 is a screen image illustrating an example group list of the financial institution program 226. Groups 138 are maintained in the financial institution program from the “manage” function and only users 150 having the appropriate permissions may perform group management functions. Details may be viewed by selecting the group 138, client 102 or employee name, for example. Selecting a group icon expands the view and show the employees and/or clients within that group 138. New clients or companies can be added by selecting the icon to the right of an item.

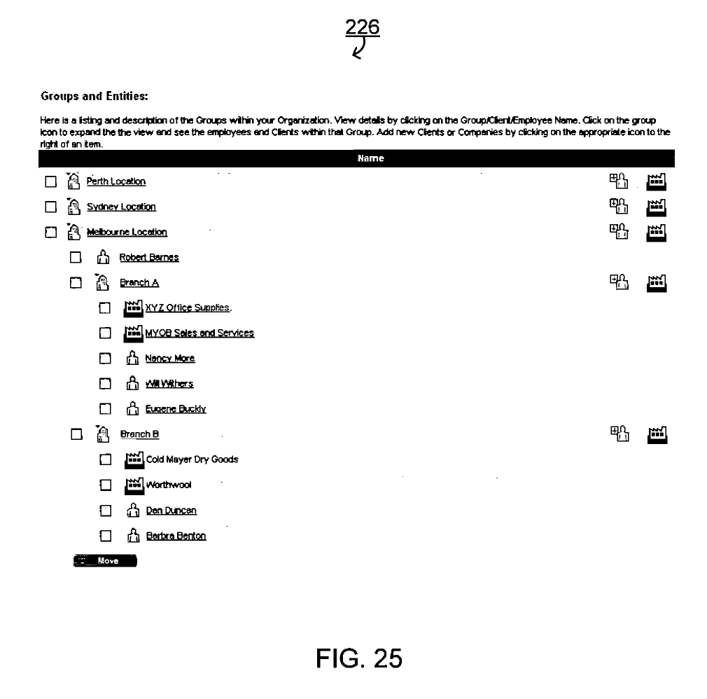

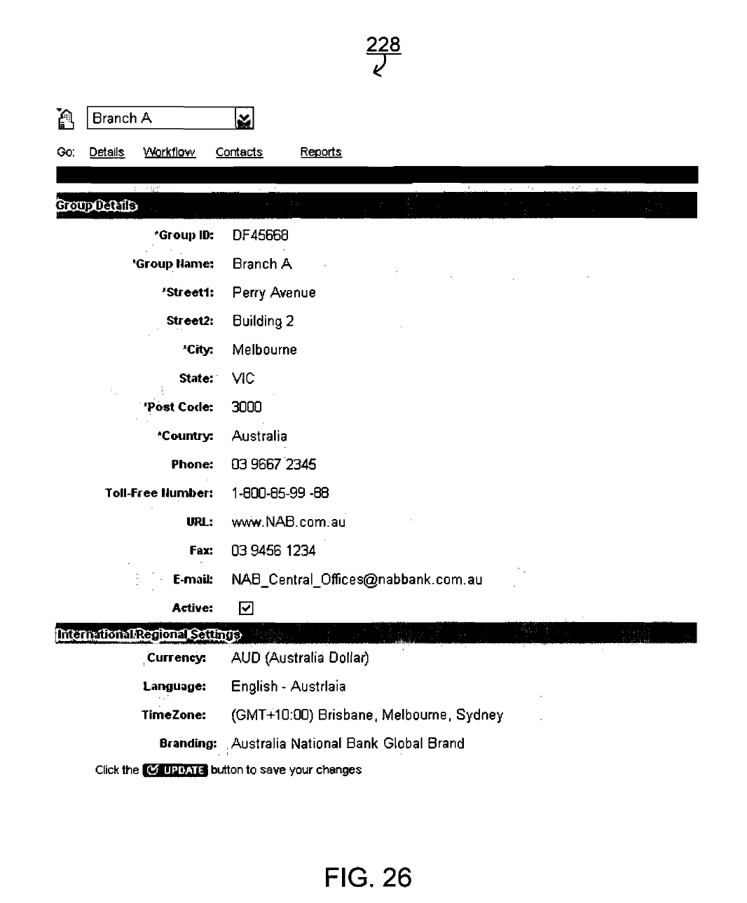

FIG. 26 is a screen image illustrating an example group details page 228. Group details may provide information such as a group ID, name, address information, telephone, URL, fax, email and whether the group is active, for example. International or regional settings such as currency, language, time zone and branding may also be provided. The group name is available in the pull-down menu at the top of the screen. Another group 138 may be selected from the pull-down menu.

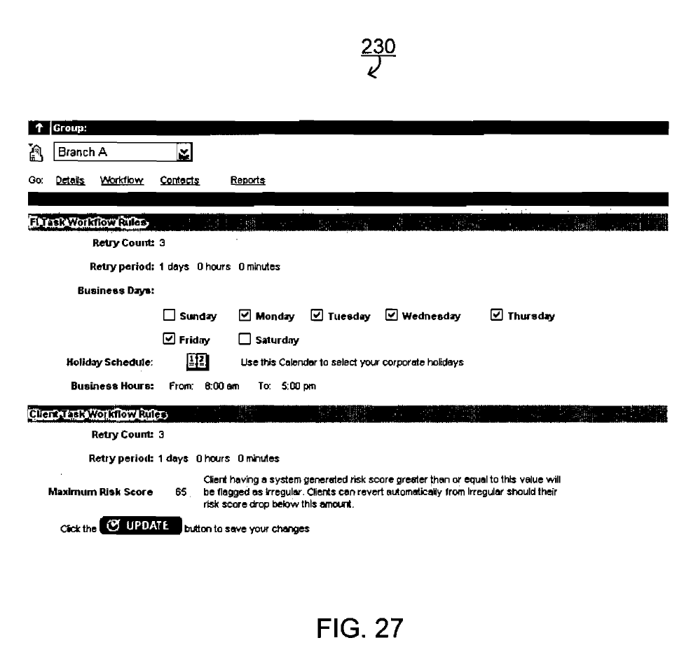

FIG. 27 is a screen image illustrating an example workflow page 230. Again, the group name is available in the pull-down menu at the top of the screen, and another group 138 may be selected from the pull-down menu. In the exemplary workflow screen, a financial institution task workflow rules section prescribes a retry count, retry period, defines business days and hours, and holiday schedule. Client task workflow rules such as, retry count, retry period, and maximum risk score are also provided. Of course, these workflow rules are exemplary only and could be varied in many ways to fit a particular workflow, as would be understood by one of skill in the art.

Group entities consist of users and clients. One can add or move entities by using the group manage interface provided in the financial institution program manage function.

Client permissions enable users to perform the necessary management functions used to maintain the client information, such as for example, ledgers, debtors, and client details, among others. Users with client permission can, therefore, perform those permissions for all clients 102 associated with the group 138 to which they belong.

Portfolios (Client and Debtor)

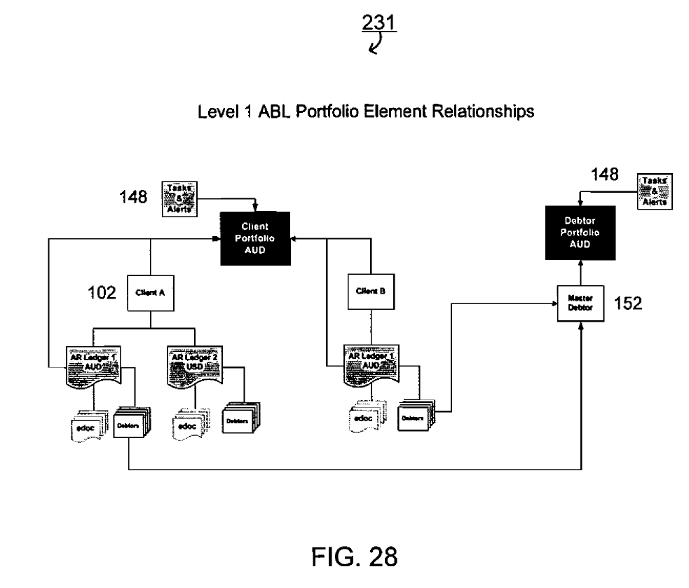

FIG. 28 is a diagram illustrating the ABL client/debtor portfolio element relationships 231. Portfolios may be either client or debtor type. A client portfolio 140 has elements for (1) clients and (2) client tasks and alerts. A debtor portfolio 142 has elements for (1) master debtors and (2) debtor tasks and alerts.

The financial institution user builds client portfolios 140 by associating clients 102 to the portfolio using the user interface. The financial institution user can build any number of portfolios. Portfolios are currency specific; the client 102 must typically have a ledger in the same currency as the portfolio before they can be associated. Clients 102 may belong to any number of portfolios. The portfolio has a variety of queries that can be performed against the client's ledger. The ability for the financial institution 108 to configure portfolios is a powerful tool in evaluating the risk and borrowing base lending opportunities for the clients 102 in the selected portfolio. For example, the financial institution 108 may place all clients 102 in a given industry into the same portfolio. In this way the financial institution 108 can evaluate the strength or risk of the selected industry in relation to future lending opportunities.

The financial institution 108 has a wide variety of tasks and alerts that can be configured at the portfolio. This enables the financial institution 108 to set watches across a number of clients instead of just one single client.

The financial institution user builds debtor portfolios by associating debtors 120 to the portfolio using the user interface. The financial institution user can build any number of portfolios. Portfolios are currency specific; therefore, the debtor 120 belongs to a client AR ledger 122 in the same currency as the portfolio in order to “associated.” Debtors 120 belong to any number of portfolios. The portfolio has a variety of queries that can be performed. The ability for the financial institution 108 to configure portfolios is useful in evaluating the risk and borrowing base lending opportunities for the debtors 120 belonging to the selected portfolio. For example, the financial institution 108 may place all debtors 120 in a given industry into the same portfolio. In this way the financial institution 108 can evaluate the strength or risk of the selected industry in relation to future lending opportunities for those debtors.

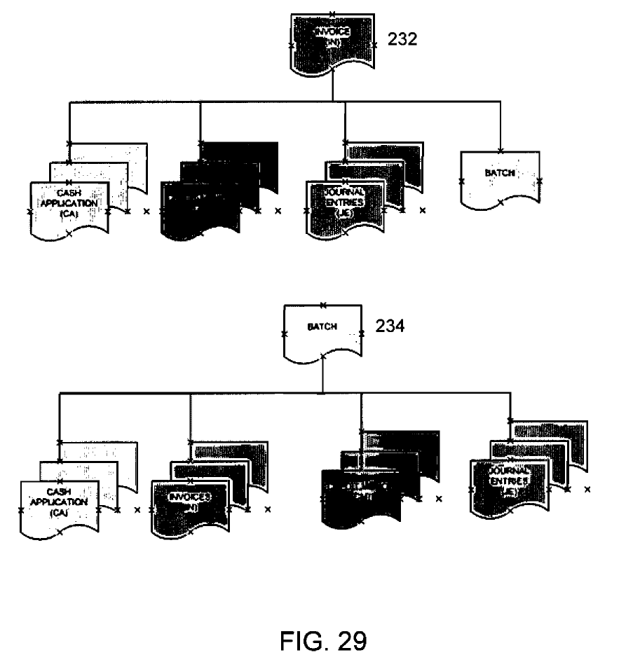

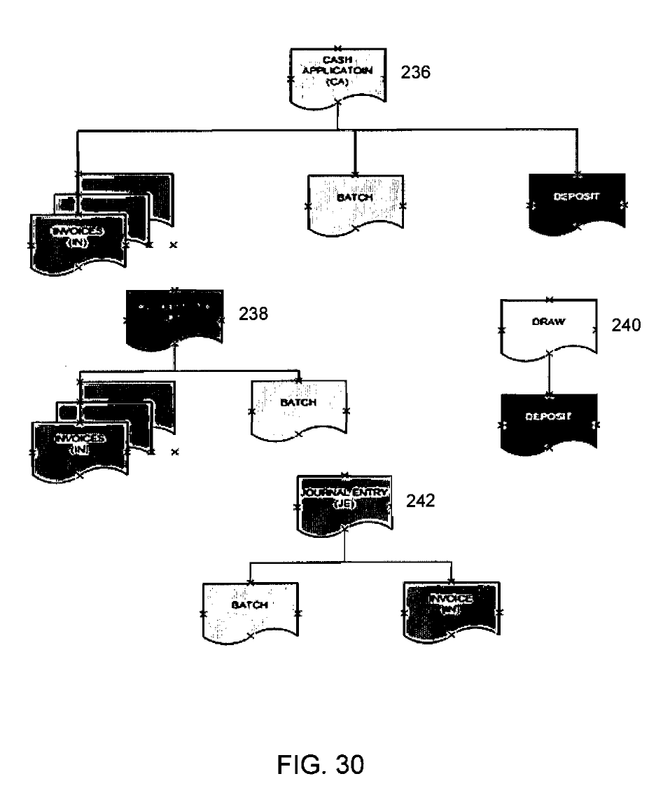

FIG. 29 and FIG. 30 are diagrams illustrating the ABL application electronic documents. Electronic documents 144 are building blocks of the ABL Application. Electronic documents 144 provide the capability for system users to view document details, document history, and link to related documents. The two primary users of the system are clients 102 and financial institutions 108. The view of each user may differ depending upon the pertinent data for that user type. Electronic documents 144 may include invoices, batches, cash applications, credit memos, draws and journal entries.

An invoice 232, as in FIG. 29, could include cash applications, credit memos, journal entries or a batch. A batch 234 could include cash applications, invoices, credit memos or journal entries.

A cash application 236, as in FIG. 30, could include invoices, a batch and a deposit. A credit memo 238 could include invoices and a batch. A draw 240 could include a deposit. A journal entry 242 could include a batch and an invoice.

FIG. 31 is a screen image illustrating an example draw page 246 in an ABL application. Funding requests (draws) are part of the funding process. Draws are used to obtain funds. Outstanding draw amounts are included in the facility fee. The draw document provides important information as to the status and history of the draw. In addition, the draw displays details regarding applied cash in the form of deposits and non-funded cash. Draws are typically submitted by the client 102 using the client interface. However, draws can be submitted by a financial institution 108 using the financial institution interface.

There are several rules for submitting a draw. (1) If approval is required, system work flow dictates who is notified for approval. (2) Funding request are auto-approved when system defined auto approval criteria are met. (3) When a draw is approved, it reduces the available funds and increases the amount utilized. (4) When deposits are paid into the client's account, the deposits are applied against the oldest draw first. (5) The status of a draw may be submitted, approved, closed, cancelled, partial pay or rejected. (6) From the deposits tab, users can link to and view the deposit details. (7) From the history tab, users can view draw history information such as date, time, and by whom the draw was submitted, and may see each status change.

Submitted status indicates that a client 102 has made a draw request. Approved status indicates that the financial institution 108 has approved the draw request. Closed status indicates that the draw is fully paid and is therefore closed. Canceled status indicates that the draw has been canceled by the financial institution 108 or the client 102. Partial pay status indicates that one or more deposits has been made against the draw, but that the draw is still not closed. Rejected status indicates that the financial institution 108 or system has rejected the draw request.

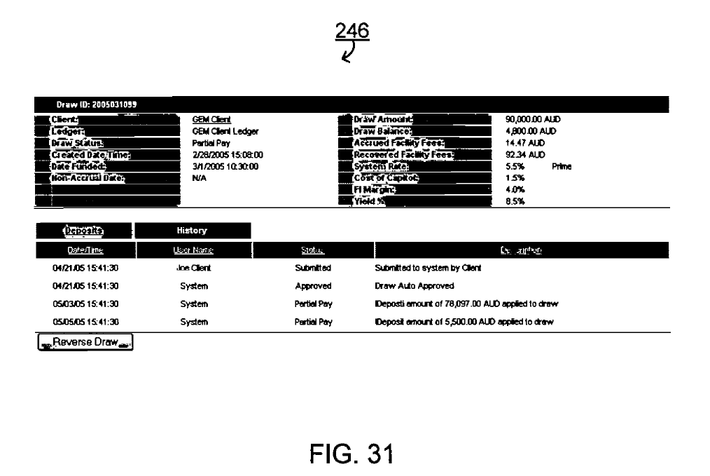

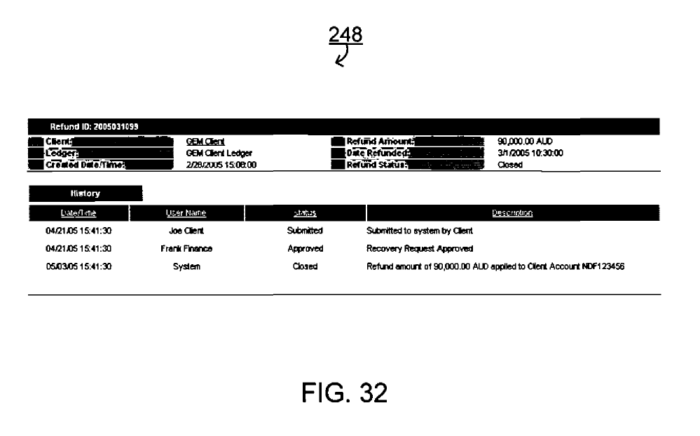

FIG. 32 is a screen image illustrating an example recovery refund page 248 in an ABL application. Recovery refunds 248 are part of the reserve account processing and allow clients 102 to withdraw excess funds from the recovery account and to place them into their working capital account. An additional benefit is that the recovery refund 248 contains details regarding fees that were extinguished as a result of the refund. Details regarding recovery refunds and the reserve account are covered in greater in the section below covering the reserve account. Recovery refunds 248 are typically submitted by the client 102 using the client interface; however, they can be submitted by financial institution 108 using the financial institution 108 interface.

There are several rules for submitting a recovery refund 248. (1) If approval is required, then system work flow dictates who is notified for approval. (2) The recovery refund 248 may be automatically approved if system defined auto approval criteria are met. (3) When a recovery refund is approved, it reduces the recovery account balance. (4) From the reserve account function, users can link to and view a list of recovery refunds 248. (5) From the history tab, users can view recovery refund history information such as, date, time, user submitting the recovery refund 248, and each status change.

The status of a recovery refund 248 may be submitted, approved, closed, canceled or rejected. Submitted status indicates that a client 102 or financial institution 108 has made a recovery refund 248. Approved status indicates that the financial institution 108 has approved the recovery refund 248. Closed status indicates that the recovery refund 248 has been completed and is therefore closed. Canceled status indicates that the recovery refund 248 has been canceled by the financial institution 108 or client 102. A recovery refund 248 may be canceled using the reversal button. Rejected status indicates that the financial institution 108 or the ABL system has rejected the recovery refund 248.

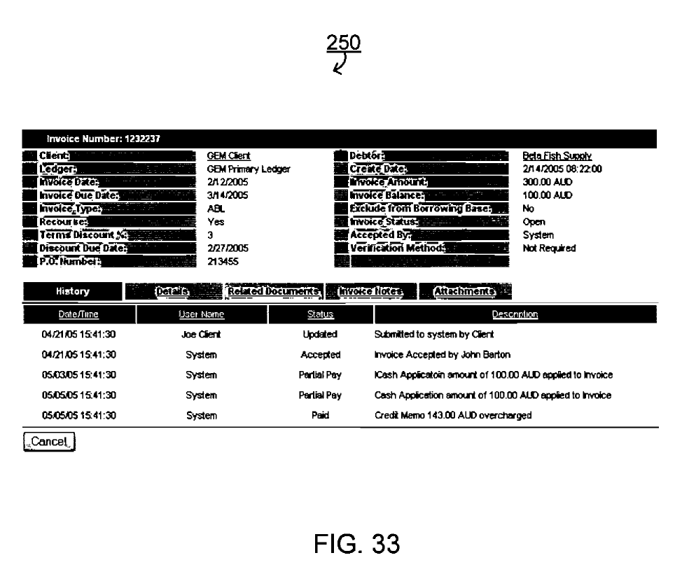

FIG. 33 is a screen image illustrating an example invoice page 250 in an ABL application. The invoice is the primary document within the ABL application. It should be noted that for an integrated client, the invoice represents the open item on the accounts receivable/debtors ledger.

Invoices comprise the borrowing base and knowing the history around the life cycle of an invoice is also important. Typically invoices are uploaded into ABL by the detailed client, however, for summary clients they are entered using the direct entry feature. It should be noted that for an integrated client the invoice represents the open item on the AR/debtors ledger. Invoices have the following attributes: (1) invoices can be integrated directly from the AR ledger 122 of the client 102, file uploaded by the client 102 or financial institution 108, or directly entered into the system by the client 102 or financial institution 108, (2) the client's debtor 120 must be in the system and validated before invoices can be applied to a borrowing base or accepted into the asset base, (3) each invoice has a related documents tab where users can view related documents such as credit memos, PY, journal entry, among others, (4) invoices can be paid by one or more payments, (5) invoices can be charged back if it exceeds the charge back date for that client/debtor criteria, (6) invoices can be adjusted via journal entry (positive or negative), (7) invoices can have one or more credit notes applied, (8) invoices have a history tab displaying relevant events that have happened to the invoice, such as date and time entered into system and how entered (direct, import), among others, (9) system can apply payments both directly and automated (also applies to credit notes and journal entries as well), (10) invoices can have attachments, and (11) invoices can typically be cancelled only if all associated electronic documents have been reversed or cancelled.

ABL invoices may have a status of open or closed. An open invoice may have sub-status of open/unloaded, open/error, open/accepted or open/partial pay. An open/uploaded sub-status indicates that invoices have uploaded to the central facilitator 106 and applies for integrated invoices and file upload invoices. An open/error sub-status indicates that an invoice has an error, such as for example, a debtor not in the system or an invoice date not within an accounting period. If integrated, then error handling is handled by the central facilitator data collection support team. An open/accepted sub-status indicates that an invoice has been added to the system, though it may not necessarily be part of the borrowing base. An open/partial pay sub-status indicates that a payment, journal entry or credit memo has been partially applied.

A closed invoice may have sub-status of closed/fully paid, closed/rejected or closed/canceled. A closed/fully paid sub-status indicates that an invoice has been closed due to full payment, though journal entries and credit memos may also apply. A closed/rejected sub-status indicates that an invoice is not allowed in the system, and may have been directly rejected or did not pass various requirements, such as, for example, amount currency, among others. A closed/canceled invoice has been canceled.

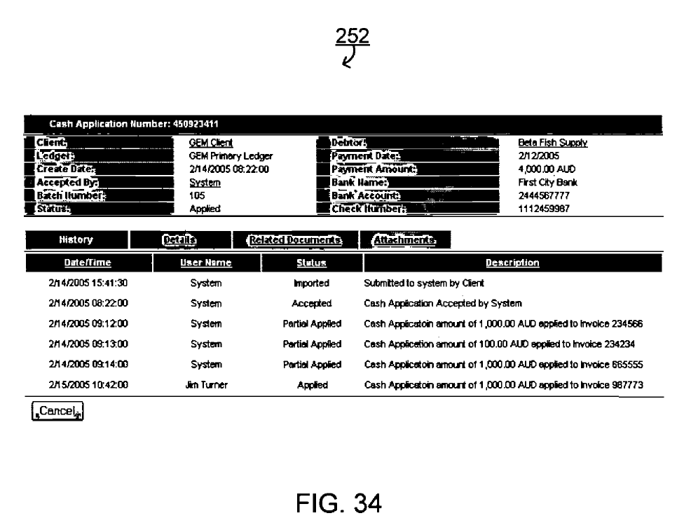

FIG. 34 is a screen image illustrating an example cash application page 252 in an ABL application. The cash application page 252 is similar to the invoice page and has similar functionality for applying cash into the system.

Payments (cash applications 236) provide visibility to partial and full invoice payments. Cash applications 236 are recorded by clients 102 in their accounting packages and then uploaded into the ABL application. Cash application 236 are generated whenever the client records a full or partial payment against an invoice. This information is typically used for internal system calculations and estimates such as the borrowing base, payment trends, and dilution. Cash applications 236 have the following criteria: (1) cash applications 236 can be applied against one or more invoices, (2) cash applications 236 can be integrated directly from a lock box, (3) if the client is an integrated client, then payments are received as specific cash applications 236 to an open item off the AR/debtors ledger, (4) cash applications 236 typically have capability to directly assign or via file upload (it should be noted that integrated clients are different as described above), (5) paid in full flag denotes that the cash application 236 was for full payment of the invoice regardless of the invoice amount, (6) related document tab showing, (7) document ID of the related document, (8) document type (in this case, an invoice), (9) date the elated document was created, (10) view hyperlink to view the related document, (11) payment has a history tab showing, (12) date received into the system and type of receipt (direct/upload), (13) when status changed and who made change (system or user, plus date and time), (14) typically every instance that the payment was applied, for example if applied against 10 invoices, (15) cash applications 236 can have attachments, (16) cash applications 236 can be cancelled if they are ALB detail client.

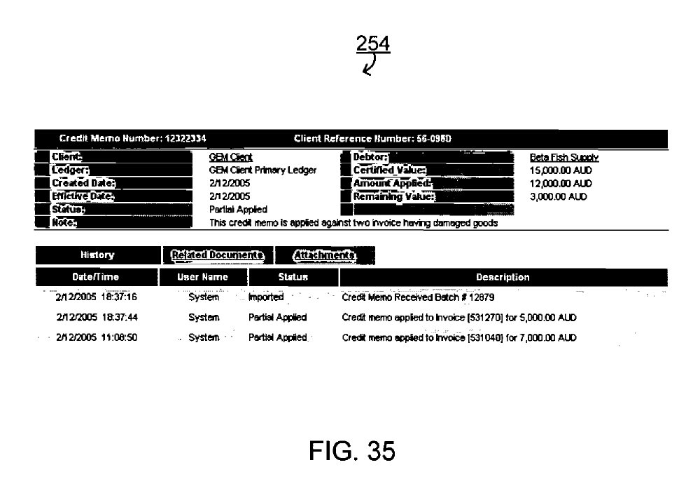

FIG. 35 is a screen image illustrating an example credit memo 254 page in an ABL application. Credit memos 254 are a method for clients 102 to apply credits that their debtors 120 have taken against invoices they have submitted to the ABL system. Credit memos 254 have the following criteria: (1) credit memos 254 can apply to an individual or multiple invoices, (2) credit memos can include a related document tab containing a list of one or more invoices to which the credit memo 254 was applied, and a hyperlink to view the invoice details, (3) history tab listing historical events that have occurred to the credit memo 254, such as date, time and invoice number, and amount of credit memo 254 applied to that particular invoice, (4) attachment capability provides a way for the user to attach a related document in electronic form such as an invoice of damaged goods report, and (5) an optional note field whereby the client may enter a note related to the credit note.

Credit memos 254 may have status of uploaded, applied, partial applied, canceled or error. Uploaded status indicates that the credit memos 254 have been uploaded to the system. Applied status indicates that the credit memo(s) have been fully applied against one or more invoices 250. Partial applied status indicates that the credit memos 254 have been partially applied against one or more invoices 250. Canceled status indicates that the credit memo(s) 254 have been canceled out of the system, such as be a client via a journal entry, for example. Error status indicates that the credit memo(s) 254 contain an error, such as an invalid debtor or client number, for example.

Credit memos 254 may be input directly or uploaded into the system. Further, credit memos 254 may have attachments, and can be modified by a journal entry.

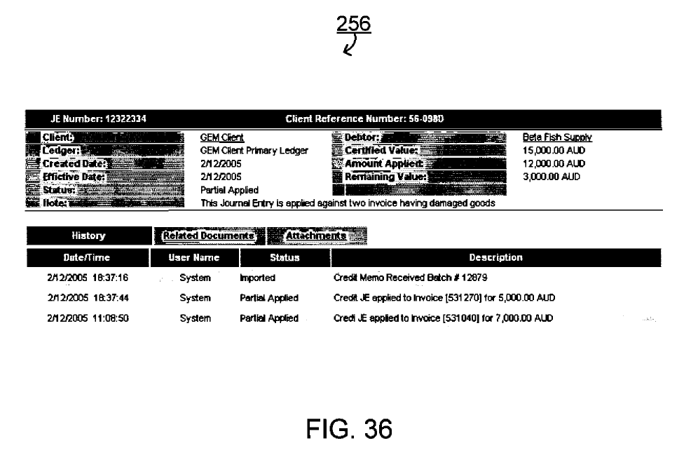

FIG. 36 is a screen image illustrating an example journal entry 256 page in an ABL application. Journal entries 256 allow for the adjustment of invoices. They may add to or reduce the amount of the invoice 250. Journal entries 256 have the following criteria: (1) they are submitted by the client 102 wither directly or uploaded, (2) can be positive or negative amounts, (3) apply against invoices (one or more), (4) have a history tab typically displaying historical events associated with the journal entry 256, such as when uploaded into the system and how or when applied to invoices, among others, (5) have a related documents tab typically displaying a list of all invoices to which the journal entry was applied and a hyperlink to view the invoice details, (6) have optional description field supplied by the client 102 and used for descriptive purposes, (7) have attachments, a way for the user to attach a related document in electronic form such as an invoice of damaged goods report, and (8) note containing info relating to purpose of journal entry

Journal entries 256 have status of uploaded, applied, partially applied, canceled and error. Uploaded status indicates the journal entry 256 has been uploaded into the system. Applied status indicates the journal entry 256 has been fully applied to related invoices. Partially applied status indicates that the journal entry 256 has only been partially applied to related invoices. Canceled status indicates that the journal entry 256 has been cancelled out of the system, such as canceled by a client, for example. Error status indicates the journal entry 256 contains an error, such as an invalid debtor or client number, for example.

Journal entries 256 may have attachments.

The status of the journal entry 256 is changed to “canceled” when the full amount of the journal entry 256 has been reduced to zero.

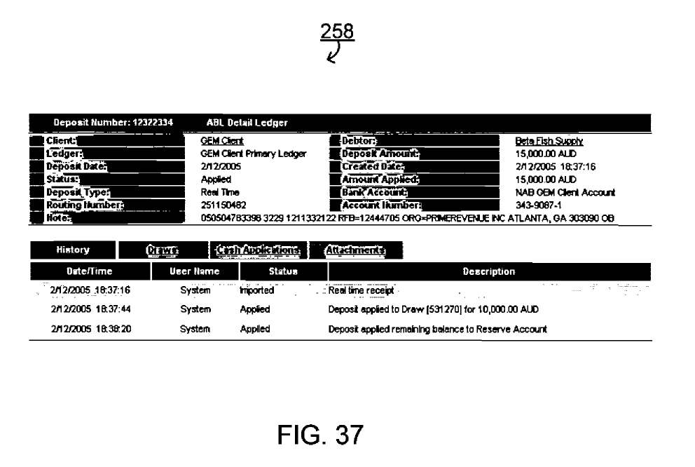

FIG. 37 is a screen image illustrating an example deposit 258 page in an ABL application. Deposits 258 are funds paid to the bank by the client 102 or a client's debtor 120. Debtor deposits are typically made for the purpose of paying the client for invoices due. Deposits 258 are typically real time, however, the system allows for processing of batch deposits. Deposits 258 have the following criteria: (1) are submitted by the financial institution 108 either directly via system integration, or uploaded in a batch, (2) apply against draws, and apply against oldest draw first, (3) have header information containing the client 102, debtor 120 and client bank account to which the deposit 258 is made, (4) have a history tab displaying historical events associated with the deposit, such as when the deposit 258 was uploaded or passed into the system and how or when the deposit 258 was applied to invoices, for example, (5) have a related draws tab displaying a list of draws to which the deposit was applied and a hyperlink to view the invoice details, (6) related cash applications tab displaying a list of cash application 236 to which the deposit has been applied (A hyperlink is provided to view the associated cash applications 236. And another hyperlink associates cash applications 236 with the draw.), (7) have an optional description field may be used for descriptive purposes, (8) have attachment capability, a way for the user to attach a related document in electronic form such as, for example, a list of invoices that were paid as part of the deposit (typically available only on batch input).

For deposit type, valid values are “batch” or “real time.”

Deposits 258 have status of uploaded, pending—auto match, pending—other, applied—auto match and applied—manual match. Uploaded status indicates that the deposit 258 has been uploaded into the system and applies for batch only. Pending—auto match indicates that the deposit 258 requires client review and approval. Pending—other indicates that the deposit 258 requires review and approval. Applied—auto match indicates that the deposit 258 has been fully applied to all related cash applications 236. Applied—manual match indicates that the deposit 258 has been fully applied to all related cash applications 236.

Deposits 258 may have attachments. The financial institution's banking system can issue a command to the ABL system to reverse a deposit 258. Detailed and summary clients having the correct permissions assigned have the ability to mark the deposit 258 as non-funded cash without cash applications 236. (The financial institution would need to review and approve such action.) Detailed and summary clients having the correct permissions assigned also may mark deposit 258 as required to pay down draws without cash applications 236. A 100 percent deposit would pay down draws.

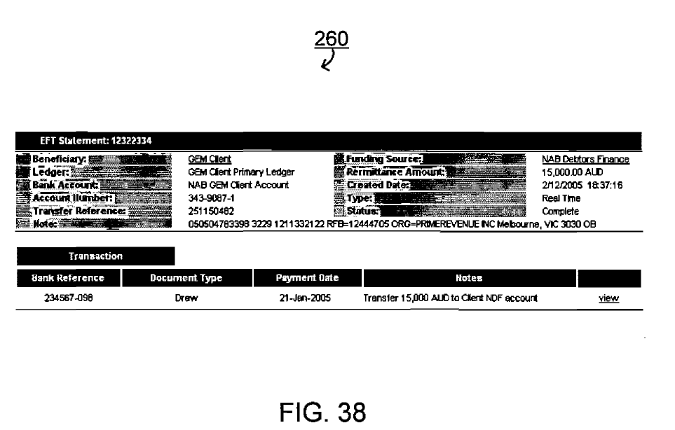

FIG. 38 is a screen image illustrating an example electronic funds transfer page 260 in an ABL application. The electronic funds transfer (EFT) is used to capture the transfer of funds between bank accounts. Therefore, the EFT is directly related to transactions that post money from one account to another electronically and confirms the transfer of funds.

EFTs typically have the following attributes: (1) are generated by the financial institution's internal banking system directly via system integration or uploaded in a batch, (2) are related to draws or reserve payments and is a one to one relationship, (3) have header information containing the beneficiary, funding source, to bank account information date created and payment type, (4) financial institution 108 and client bank account corresponding to the parties making and receiving the deposit 258, (5) have a history tab displaying historical events associated with the EFT, such as when the EDT was uploaded or passed into the system and how or when the EFT was applied to a draw or reserve payment (history tab has the link to view the related document.), (5) description field supplied by the banking system and used for descriptive purposes, and (6) deposit type, valid values are “Batch” or “Real Time.

An EFT may have status of uploaded and complete. An uploaded status indicates that the EFT has been uploaded into the system (in batch only). A complete status indicates that the EFT statement has been associated to the related draw or reserve payment.

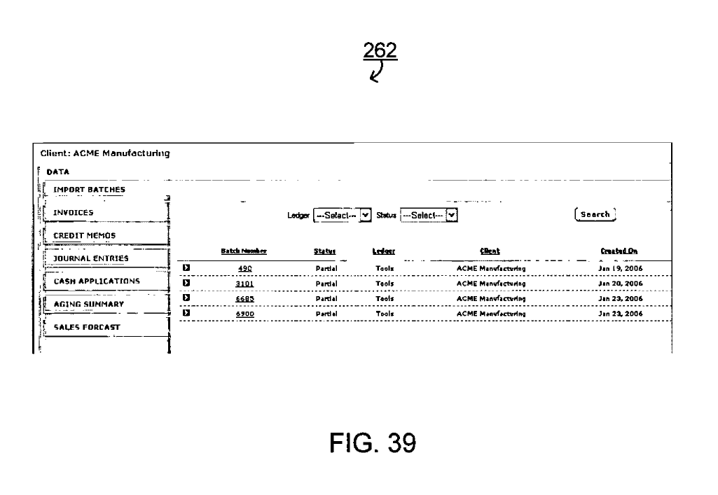

FIG. 39 is a screen image illustrating an example batch list page 262. The ABL system employs a batch processing technique for uploading electronic documents 144 and debtors 120 to the ABL application 116. Batch processing provides the capability to manage data records before they have been processed into the system. All management of exceptions and approvals of electronic documents 144 and debtor data records are performed within their associated batch file. Batches can themselves can be reviewed and modified by the financial institution 108 to suit the financial institution's requirements. In addition, the batch contains all the information regarding the electronic documents 144 and debtors 120. This is extremely important should the financial institution 108 ever need to back-out a bath of records.

Batches are created as a result of a file upload from the client 102 or via direct data entry. The upload can be initiated via several mechanisms. Typically the files are uploaded from the client interface. The electronic documents 144 addressed include the debtor, journal entry, credit memo, invoice, and cash application document types.

A batch defines a set of document types that have been uploaded or directly loaded into the system and help to track and organize them for later reference. Batches may include any number of record types including debtors, invoices, credit memos, journal entries, and cash applications 236. Batches may be created any time one or more of debtors, invoices, credit memos, journal entries and cash applications, are uploaded into the system. A batch includes the status of each individual record uploaded in that batch.

When multiple currencies exist within the batch, a new batch is created for each currency type. Each new batch references the original batch.

Batches include an error count for the errors that exist within the batch. Batches can be modified to correct erroneous data or to remove invalid documents. Historical information indicating when the batch was loaded is included in the batch. A batch includes the client name, ledger and a hyperlink to client details. A “details” hyperlink is included in the batch and displays a listing of all records contained in the batch. Users can hyperlink and view recorded details.

A batch may have status of pending, approved, rejected, canceled, errors and closed. Pending status indicates the batch has been uploaded but not yet approved. Approved status indicates that the batch has been either directly approved by the financial institution or automatically approved by the system, if available. Approved batches have no errors. Rejected status indicates that the system of financial institution 108 has rejected the batch. Canceled status indicates that the batch has been canceled by the client 102. Errors status indicates that a batch remains in an error status until all debtor errors have been corrected. Only records having errors are excluded from being added into the system. Other records are added to their respective data store. For example, new debtors now appear in the system and can be viewed and modified. Closed status indicates that all records on the batch have been fixed or removed.

The batch list includes a listing of batches that have not been closed. The financial institution 108 and the client 102 use the pending batch list to access the debtor error records contained in the batch and make the necessary corrections. The financial institution 108 can also set the clients AR ledger 122 so that all batches must be reviewed, and then accepted or rejected by a financial institution 108 user having the appropriate permissions.

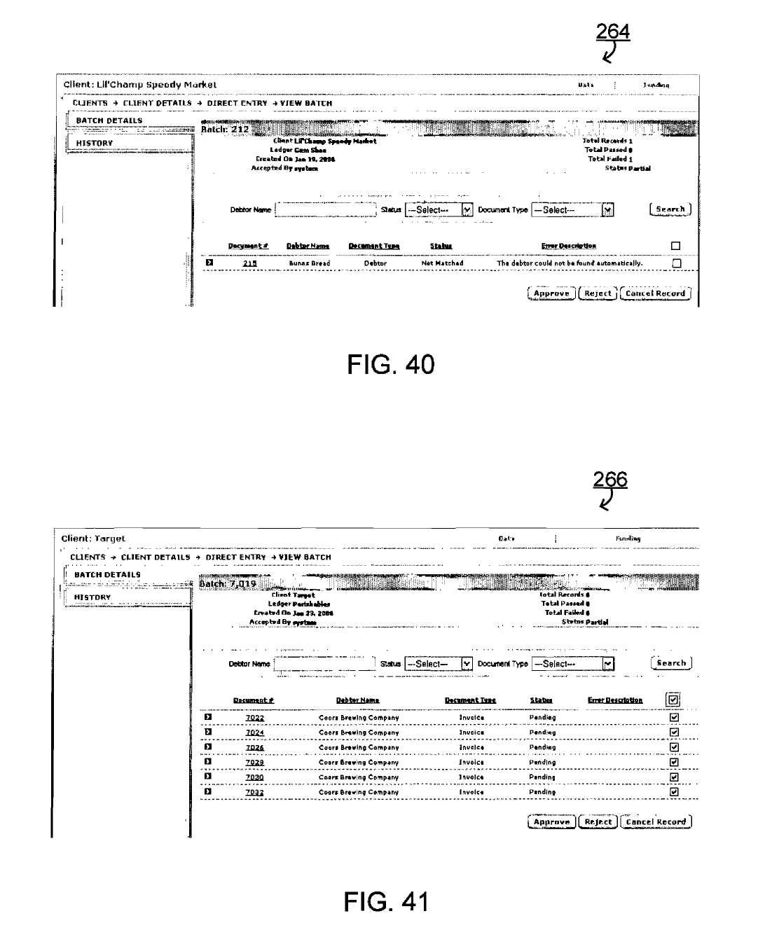

FIG. 40 is a screen image illustrating an example debtor batch list page 264 page and FIG. 41 is a screen image illustrating an example invoice batch list page 266. The financial institution 108 and the client 102 view the batch detail records in order to correct debtor errors. The batch details page has the facility to search and find records having invalid debtors 120. Users can associate the invalid debtor to an existing debtor. In the case where the debtor 120 does not exist, the user can also add the debtor to the ABL system. When new debtors are added or an erroneous debtor is associated, the financial institution 108 must verify and activate the debtor 120 before any debtor e-documents 144 can be accepted. The detailed batch record has two tabs, a history tab as in FIG. 41 and a details tab as in FIG. 40.

Managing Client Web Page Elements

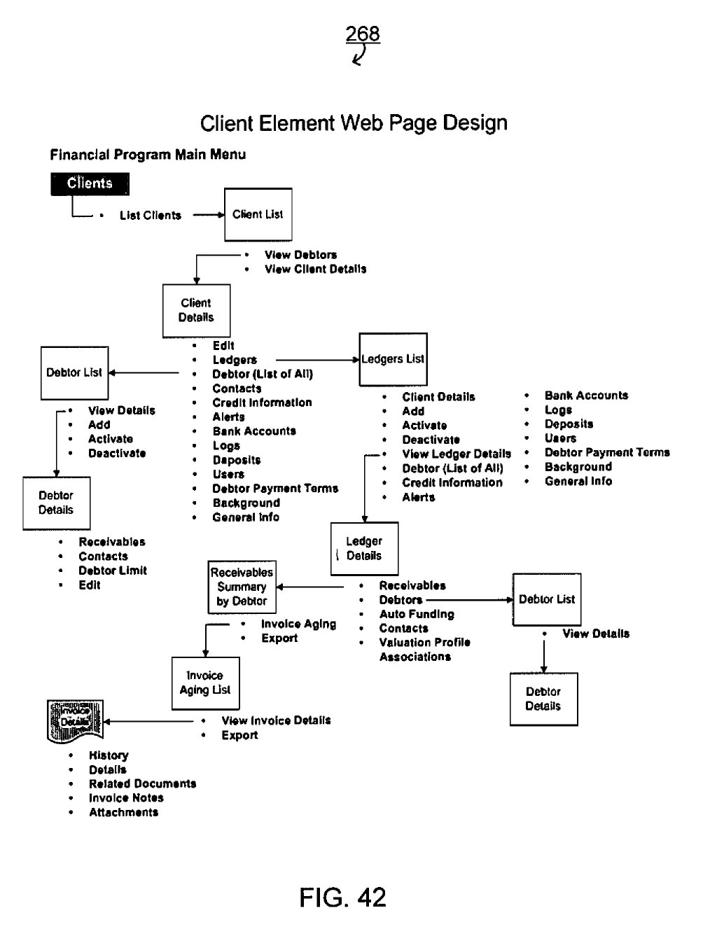

FIG. 42 is a diagram illustrating the client element web page design 268. The client web page diagram illustrates how the application web pages are organized within the financial institution function of the ABL application 116 from the perspective of the client element. The organization of these elements demonstrates their incorporation as building blocks into the system architecture to enhance design and functionality for the client 102.

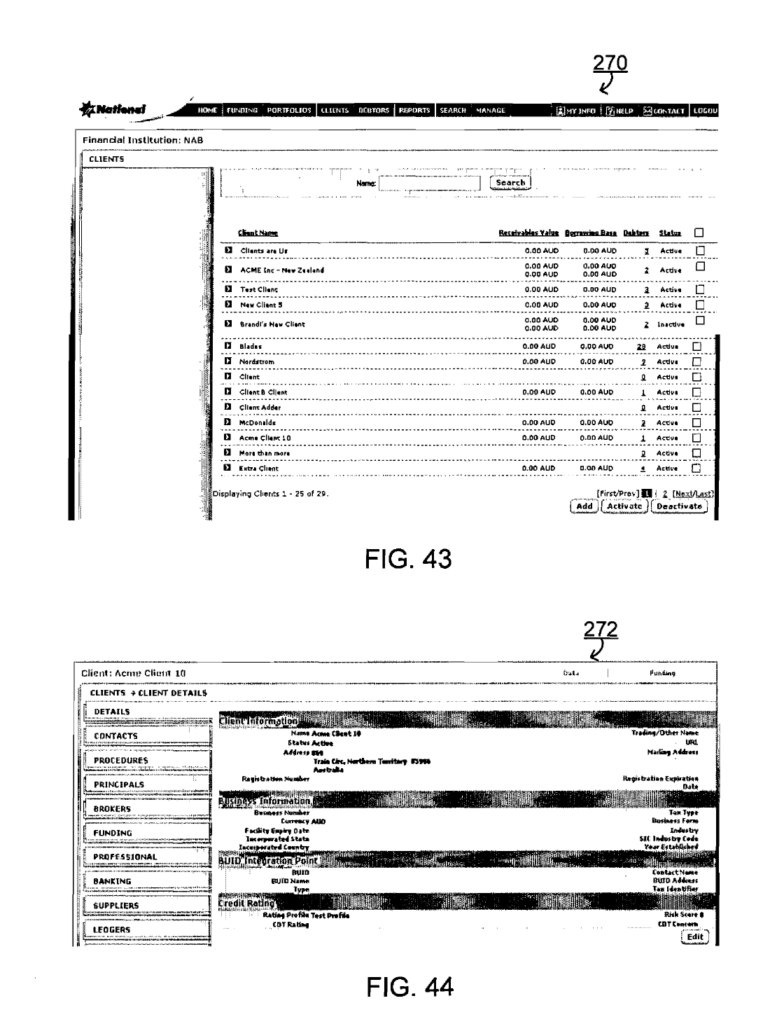

FIG. 43 is a screen image illustrating an example client list page 270. The client list is a list of the clients 102 that exist in the system without regard to ledgers. From the client list, the user has access to the client name, total receivables value, borrowing base, number of debtors and current status. Clients 102 may be added, activated or deactivated.

FIG. 44 is a screen image illustrating an example client details page 272. The user may view the client information that the financial institution 108 has on file. The user may also edit the client 102 information.

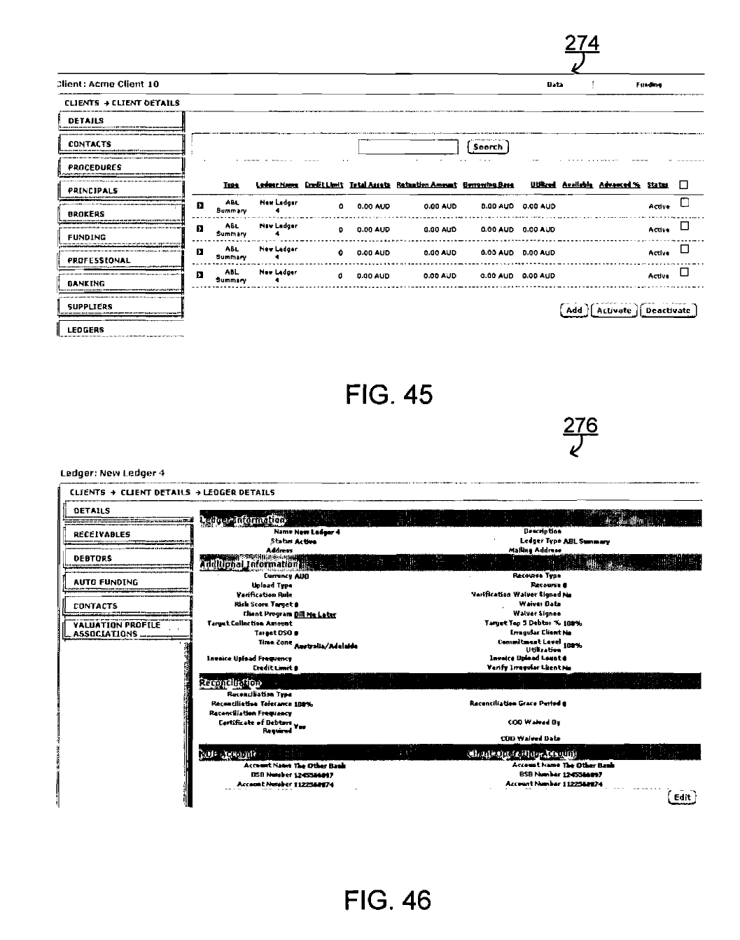

FIG. 45 is a screen image illustrating an example client ledgers list 274. Information shown on the client ledgers list includes ledger name, type, credit limit, total assets, retention amount, borrowing base, utilized, advanced percentage and status. From the client ledgers list page, the financial institution 108 user may view client AR ledgers 122, activate or deactivate ledgers, select a ledger name to view details or add a client 102.

FIG. 46 is a screen image illustrating an example client ledger details page 276. From the client ledger details page 276, the user may view ledger details, view or modify the auto funding, view the list of accounts receivables associated with the selected ledger, edit the ledger details, view valuation profiles associations, view ledger contacts or view a list of debtors 120 associated with the ledger.

Managing Debtor Web Page Elements

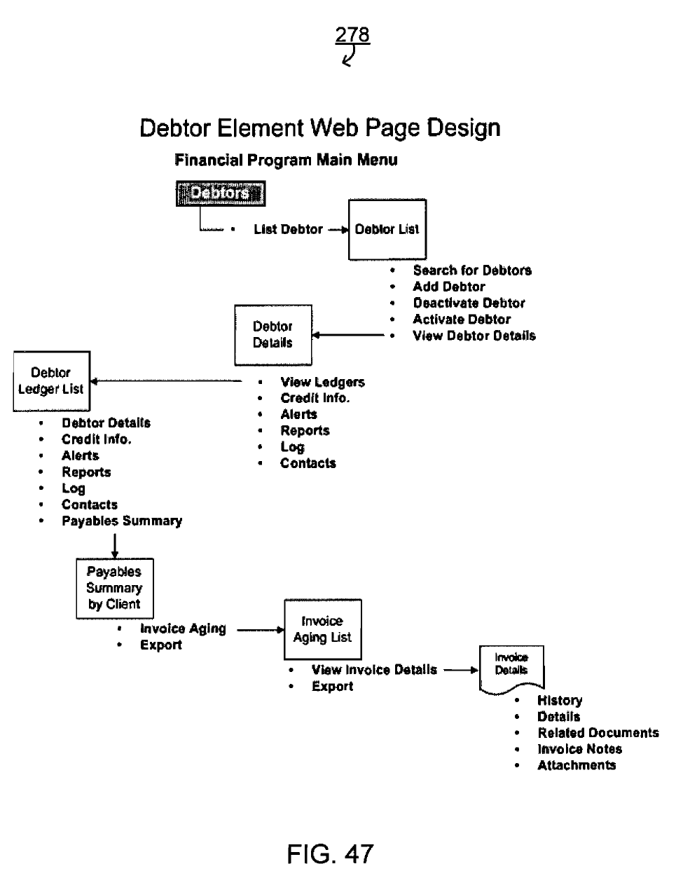

FIG. 47 is a diagram illustrating the debtor element web page 278 design. The debtor web page 278 diagram illustrates the organization of the application web pages within the financial institution function of the ABL application 116. The organization is from the perspective of the debtor element. The organization of these elements demonstrates how they are incorporated as building blocks into the system architecture to enhance the design and functionality for the debtor.

The debtor list allows the user to search for debtors, add a debtor, deactivate a debtor, activate a debtor or view debtor 120 details. The debtor details functionality allows the user access to view ledgers, credit information, alerts, reports, log and contacts. The debtor ledger list allows user access to debtor details, credit information, alerts, reports, log, contacts and payables summary. The payables summary by client 102 allows access to invoice aging and export. The invoice aging list allows access to view invoice details and export. Invoice details provides access to history, details, related documents, invoice notes and attachments.

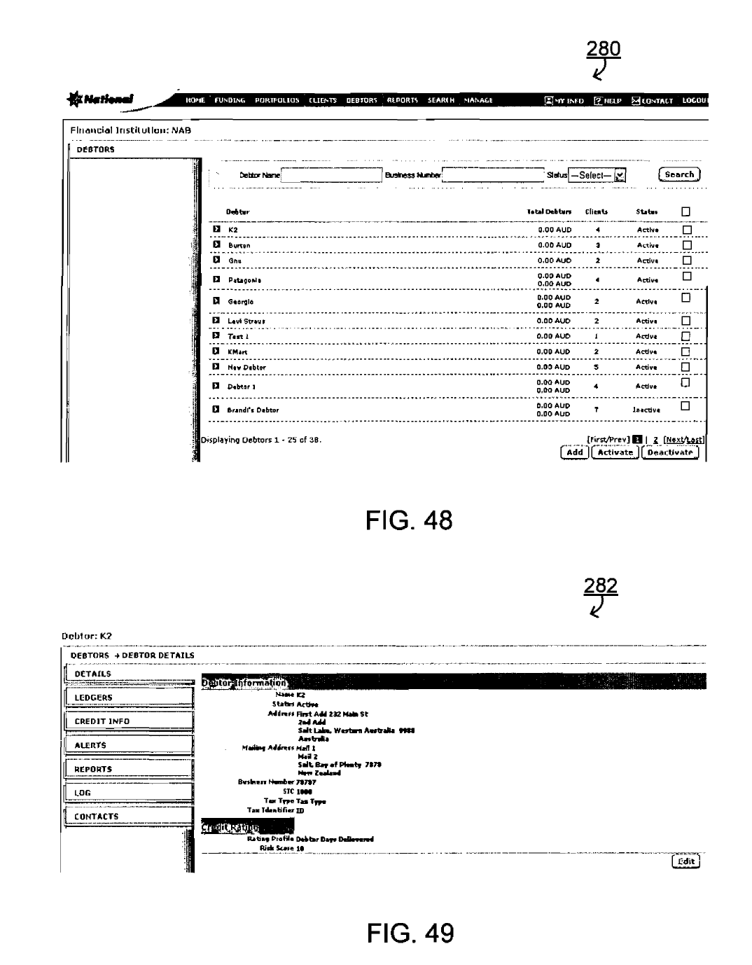

FIG. 48 is a screen image illustrating an example debtor list page 280. From the debtor list page 280, the user may access and maintain debtors. The list includes all debtors 102 in the system independent of ledger.

The debtors 102 are listed in alphabetical order, and if attached to multiple ledgers and currencies they are listed multiple times. The debtors list displays the debtor name, payables value (total debtors), clients and status.

From the debtor list page 280, the user may search for debtors by entering the debtor name (whole of partial) into the debtor textbox. Debtors 120 may also be searched address by entering the address (whole of partial) in the address field. Additionally, the debtors 120 may searched by status, business number or any combination of the previous fields.

A user may deactivate a debtor by clicking the checkbox and the associated deactivate button.

A user may activate a pending or deactivated debtor by clicking the check box and the associated activate button.

FIG. 49 is a screen image illustrating an example debtor details page 282. From the debtors details page 282, the user may access the details for the selected debtor 120 as well as the contacts that have been created for this debtor 120.

The user may edit debtor information. The contact tab provides access for viewing and adding a new contact. The ledgers tab provides access to debtor accounts payable ledgers. The credit info tab provides access to debtor credit information, and the log tab allows access to log information. Alerts may be configured via the alerts tab. The reports tab provides access for running reports.

Managing Application Table Elements

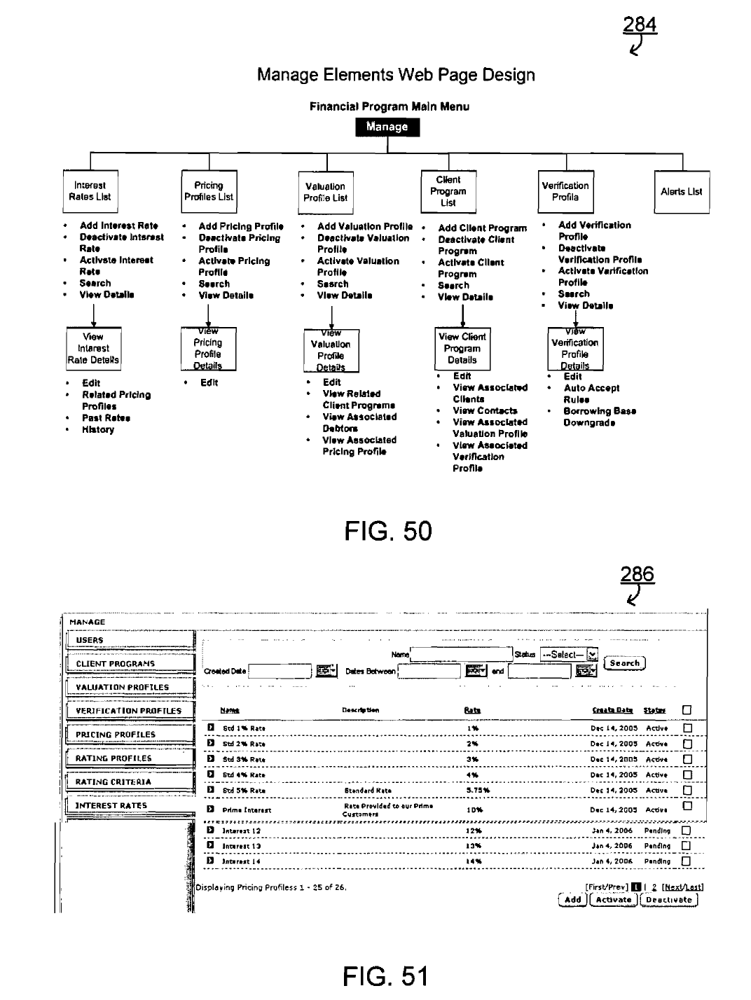

FIG. 50 is a diagram illustrating the manage elements 284 web page design. The ABL application uses a unique design structure of table elements that when combined enable financial institution users to configure the ABL application as required to meet their specific business needs. The table element design structure provides design benefits such as a building block concept, reusability, error checking, visibility, currency specific, searchable.

The building block concept allows the tables to be logically segmented in sub tables. This logical segmentation allows the financial institution to associate table elements to clients, debtors, portfolios and other table elements. The element relationships as presented in FIG. 3 above illustrate the building block concept.

Reusability provides that once a table entry has been created, it can be reused again and again. This reduces the amount of work by the financial institution 108 to set up and manage the ABL application 116.

Error checking allows the application to track each interrelationship and do not allow the financial institution user to deactivate a table element that is associated with another active element. Error checking also ensures that only table elements of the same currency can be associated.

The system allows for visibility of any relationships whereby table elements have been associated to one another. This helps the financial institution 108 to understand the impact upon the system when making changes to a table element.

Regarding currency, each table element contains specific currency related information. Currency specific table elements can only be associated with other table elements of like currency.

Table elements are organized into searchable lists (extensive search capability) from which they can be viewed, edited, activated and deactivated.

The financial program main menu provides for managing the interest rates list, pricing profiles list, valuation profile list, client program list, verification profile, alerts list.

FIG. 51 is a screen image illustrating an example interest rates list 286 web page for managing interest rates. From the interest rates list 286 web page, the financial institution user may add an interest rate, view interest rate details, deactivate an interest rate, activate an interest rate and search for interest rates.

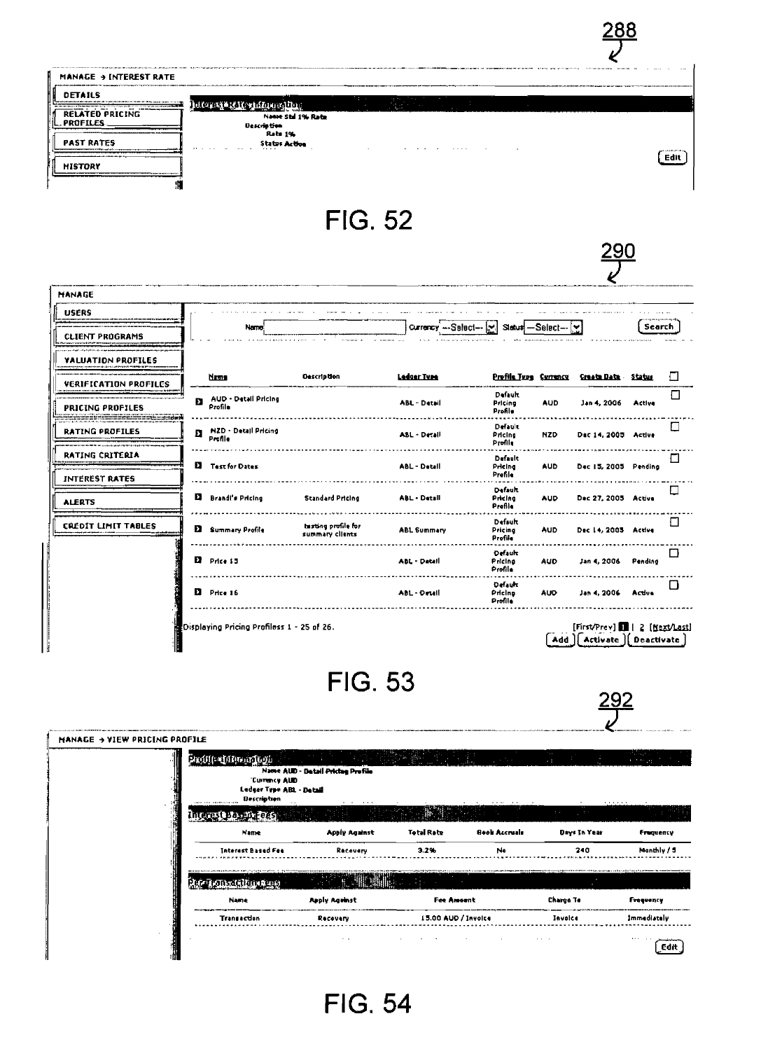

FIG. 52 is a screen image illustrating an example interest rates detail page 288 for accessing interest rate information. From the interest rates details page 288, financial institution users may edit the interest rate profile, view related pricing profiles 130 that are using that interest rate profile, view past rates for that profile and view the history of changes made to the interest rate profile.

FIG. 53 is a screen image illustrating an example pricing profile list page 290 for accessing pricing profiles details. From the pricing profile list page 290, the financial institution user may add a pricing profile, view pricing profile details, deactivate pricing profiles, activate pricing profiles and search for pricing profiles.

FIG. 54 is a screen image illustrating an example pricing profile details page 292. From the pricing profile details page 292, financial users may edit the pricing profile.

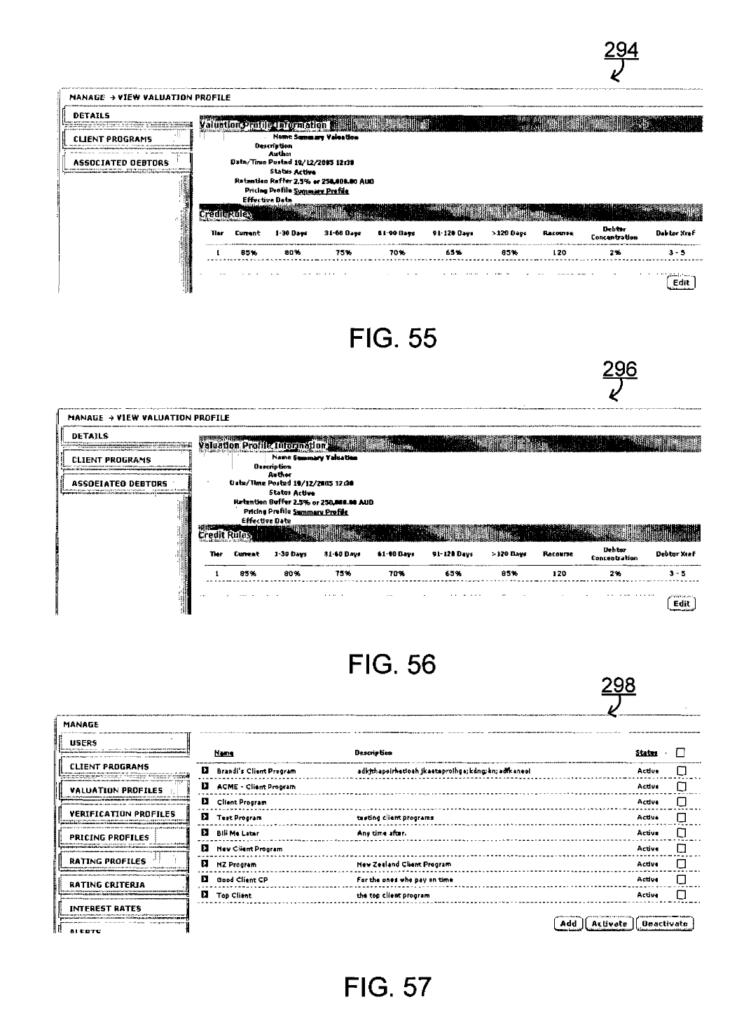

FIG. 55 is a screen image illustrating an example valuation profile list page 294. From the valuation profile list page 294, the financial institution user may add a valuation profile 128, view valuation profile details, deactivate valuation profiles 128, activate valuation profiles 128 and search for valuation profiles 128.

FIG. 56 is a screen image illustrating an example valuation profile details page 296. From the valuation profile details page 296, the financial user may edit the valuation profile 128, view any associated client program 126 and view any associated debtors 120.

FIG. 57 is a screen image illustrating an example client program list page 298. From the client program list page 298, the financial user may add a client program 126, view client program details, deactivate client programs 126, activate client programs 126 and search for client programs 126.

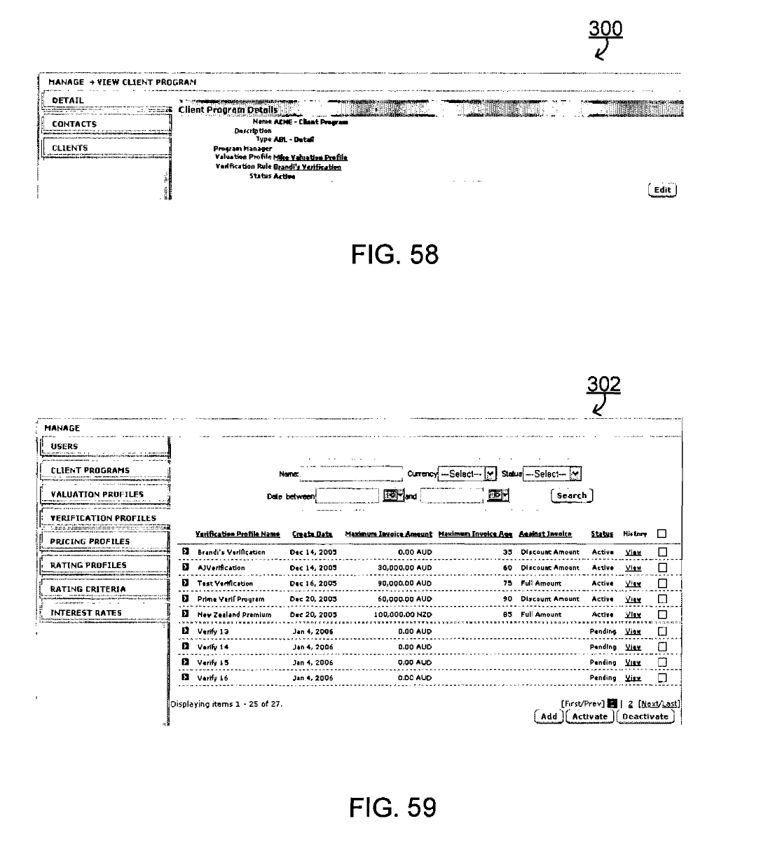

FIG. 58 is a screen image illustrating an example client program details page 300. From the client program details page 300, the financial user may edit the client program 126, view and edit client program contacts, view client program clients, view and edit the associated verification profile 136, and view and edit the associated valuation profile 128.

FIG. 59 is a screen image illustrating an example verification profile list page 302. From the verification profile list page 302, the financial user may add a verification profile 136, view verification profile details, deactivate verification profiles 136, activate verification profiles 136 and search for verification profiles 136.

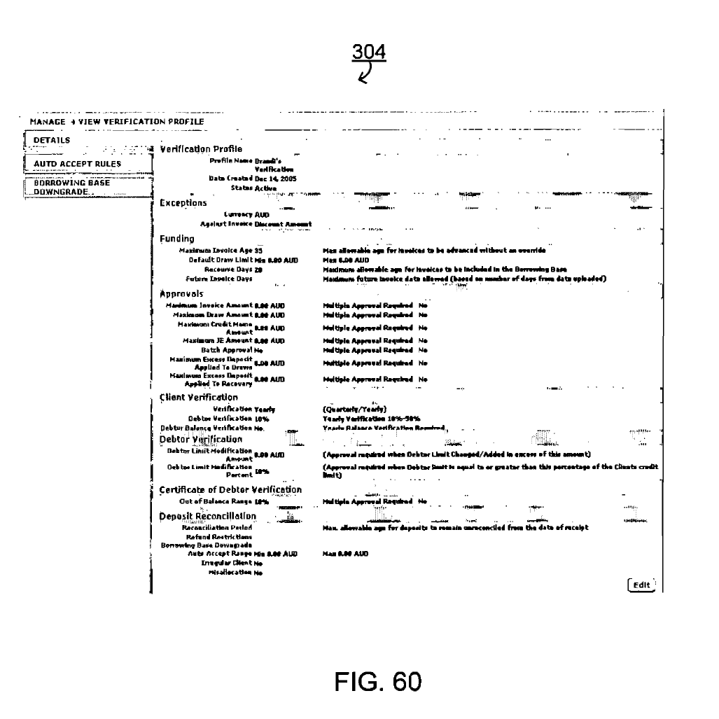

FIG. 60 is a screen image illustrating an example verification profile details page 304. From the verification profile details page 304, the financial user may edit the verification profile 136, work with the auto accept rules and manage the borrowing base downgrade parameters.

ABL Risk Scoring

Risk scoring is an integral part of the ABL application 116 and is used throughout the ABL system 100 to initiate alerts, calculate the borrowing base and perform portfolio queries. Clients 102 and debtors 120 each have an associated risk rating. The risk rating is determined by the risk profile developed by the financial institution 108 and assigned to the client 102 and debtor 120. ABL risk scoring uses a combination of manual and system generated risk scoring criteria combined with a weighting of those scores to generate a risk rating. The financial institution 108 uses the risk and rating configuration capabilities to define the risk score rating criteria. The rating profile consists of risk score rating criteria. The calculated risk score is determined via the weighting criteria that is set in the rating profile. Rating profiles may be client 102 or debtor 120 related but can not be both since the client 102 and debtor 120 have different rating criteria. Rating criteria is either system generated or manually configured by the financial institution 108.

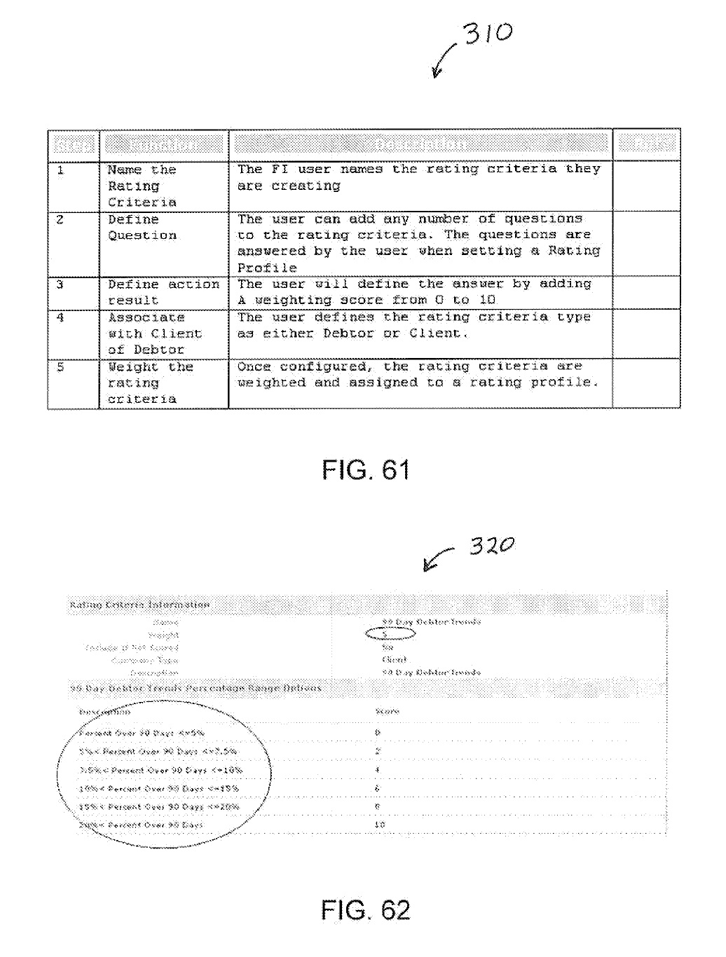

FIG. 61 is a table illustrating exemplary steps for configuring manual rating criteria 310 in an ABL application. The establishment of rating criteria is required prior to setting up the rating profile in an ABL application. (1) The first exemplary step is to name the rating criteria. The financial institution user names the rating criteria that are created. (2) Defining the question is the next step. The user can add any number of questions to the rating criteria. The questions are answered by the user when setting a rating profile. (3) The next step is to define an action result. The user defines the answer by adding a weighting score from 0 to 10. (4) The next step is to associate with a client 102 or debtor 120. The user defines the rating criteria type as either debtor 120 or client 102. (5) Finally, the rating criteria are weighted. Once configured, the rating criteria are assigned to a rating profile.

FIG. 62 is a screen image illustrating an exemplary rating criteria configuration page 320 in an ABL application. Typically, only users with the credit manager role have the functionality to set-up and manage rating profiles. Once the rating criteria are established, the user creates the rating profiles for a debtor 120 or client 102. As an example, a rating profile could be created for all debtors 120 in a given business, e.g., retail.

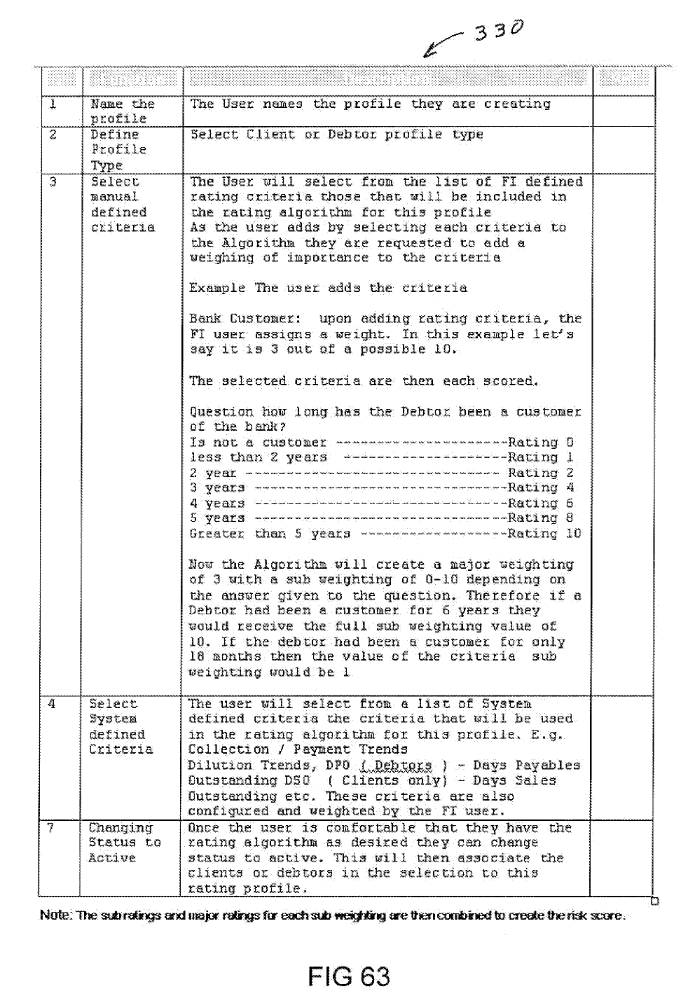

FIG. 63 is a table illustrating exemplary steps required for defining a rating profile 330 in an ABL application. The credit manager not only defines the rating profile, but also weights each rating criteria within the profile. (1) The user names the profile being created, and then (2) selects either client 102 or debtor type. (3) The user selects from a list of financial institution 108 defined rating criteria, those to include in the rating algorithms for this profile. With each criteria selected, the user adds a weighting of importance. Upon adding rating criteria, the financial institution 108 user assigns a weight, for example, 3 out of a possible 10. The selected criteria are then each scored. Rating values can be assigned, for example, corresponding to the length of time that a debtor has been a customer of the bank. If the debtor is not a customer, the rating is zero, if the debtor has been a customer for less than two years, the rating is one, and so on up to a rating of 10 for greater than five years. Next, the algorithm creates a major weighting of three, with a sub weighting of 0-10, dependent upon the answer to the previous question regarding the debtor's length of time as a customer. Thus, if the debtor has been a customer for six years, they would receive a full sub weighting value of 10, and if the debtor has only been a customer for 18 months, then the sub-weighting value is one.

(4) The user then selects from a list of system defined criteria, those to be used in the rating algorithm of this profile. Examples of system defined criteria include, but are not limited to, collection/payment trends, dilution trends, days payable outstanding (DPO), days sales outstanding (DSO), among others. These criteria are also configured and weighted by the financial institution user. (5) The status can be changed to active once the user is satisfied that the rating algorithm is as desired, thus associating the clients 102 or debtors in the selection to this rating profile.

The sub ratings and the major ratings for each sub weighting are then combined to create the risk score.

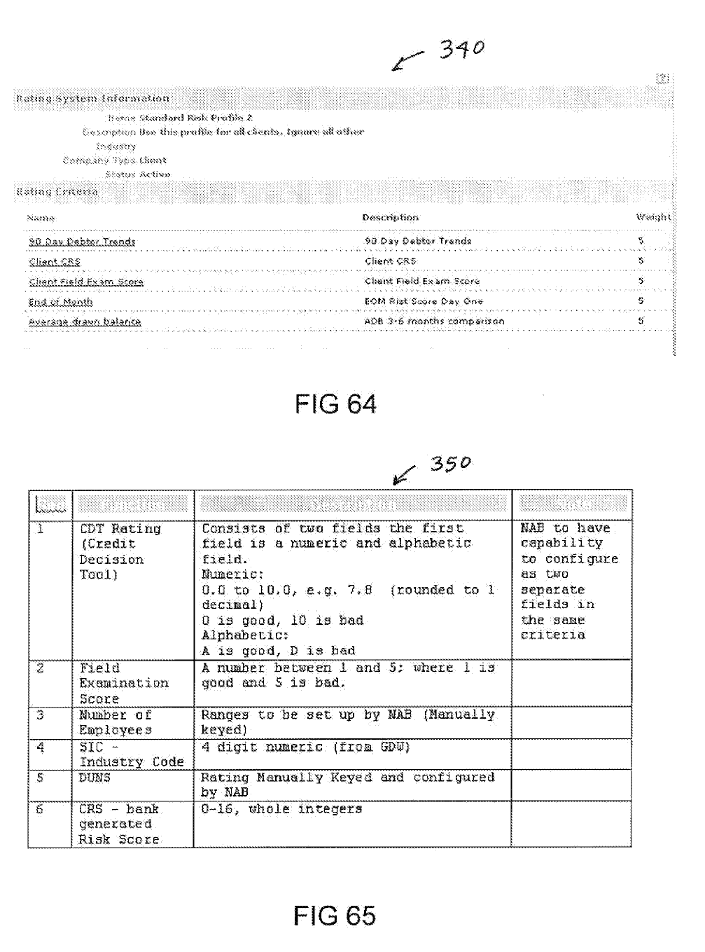

FIG. 64 is a screen image illustrating an exemplary rating profile configuration page 340 in an ABL application. The system provides the capability to display client 102 risk score trends and associated analysis for each risk score. The risk score trend is a list of clients 102 or a single client's risk score trend. The current risk score and risk score history and percent of change over the past year are shown. Portfolio capability is described in further detail below.

The credit manager sets tasks and alerts based on client 102 and debtor risk score changes. The task and alert is assigned to a user for a defined action. The task and alert (T&A) is removed for the users home page, based on the criteria, by setting the T&A up. Users associated with the debtor or client/debtor receive the debtor tasks and alerts. The credit manager role in conjunction with the hierarchy settings define the escalation required for each task.

Debtor risk score rating profiles are assigned at the master debtor record, and the rating criteria applies to all client debtors associated with the master debtor. The client debtor risk score is maintained at the client ledger and is automatically adjusted as the system rating criteria changes. The customer defined rating criteria applies to all client debtors associated with the master debtor.

FIG. 65 is a table illustrating exemplary specific company manually defined client rating criteria 350. Exemplary functions include credit decision tool (CDT) rating, field examination score, number of employees, SIC—industry code, DUNS, and CRS—bank generated risk score. The CDT rating contains two fields, numeric and alphabetic. For example, the numeric field could be 0.0 to 10.0 range where 0 is good and 10 is bad. The alphabetic field could be from A (good) to D (bad), for example. The field examination score typically ranges from 1 (good) to 5 (bad). Number of employees is typically manually keyed and set up by NAB. The SIC is a four digit numeric code from GDW. The DUNS rating is typically manually keyed and configured by NAB. The CRS is typically a whole integer in the range 0-16.

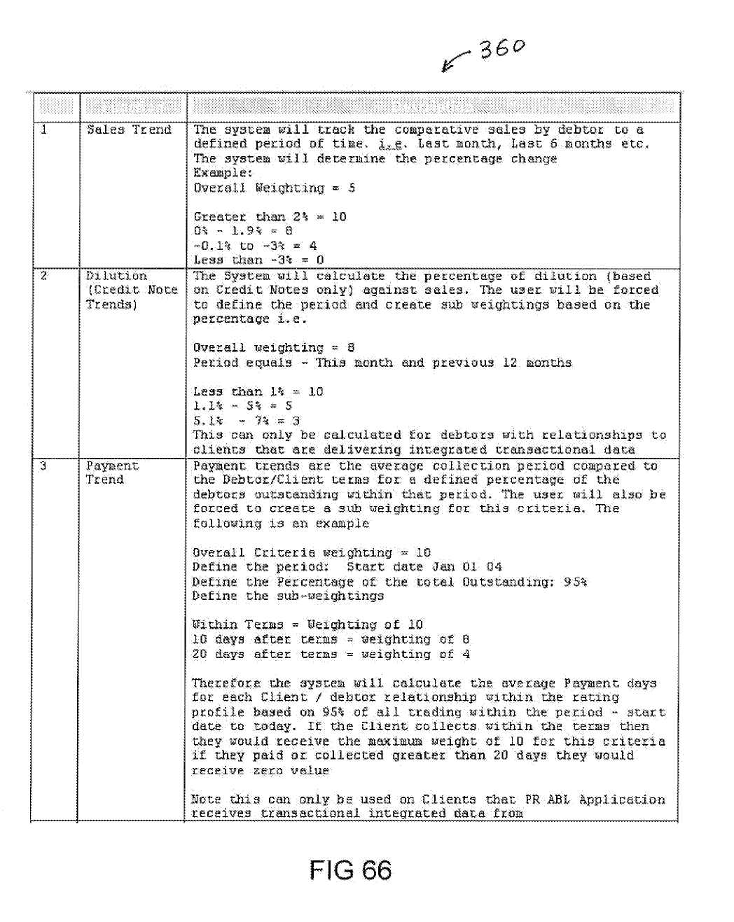

FIG. 66 is a table illustrating exemplary client system generated rating criteria 360. The rating criteria can be implemented into a rating profile as desired by the financial institution 108 and subsequently associated to a desired client 102 or client program. Exemplary functions include (1) sales trend, (2) dilution (credit note trends), and (3) payment trend. For sales trend, the system typically tracks the comparative sales by debtor to a defined period of time, e.g., last month, last six months, etc., and determines the percentage change. For dilution, the system calculates the percentage of dilution (based on credit notes) against sales. The user defines the period and creates sub weightings based on the percentage. Payment trends are the average collection period compared to debtor/client terms for a defined percentage of the debtors outstanding within the period. The user also creates a sub weighting for this criteria.

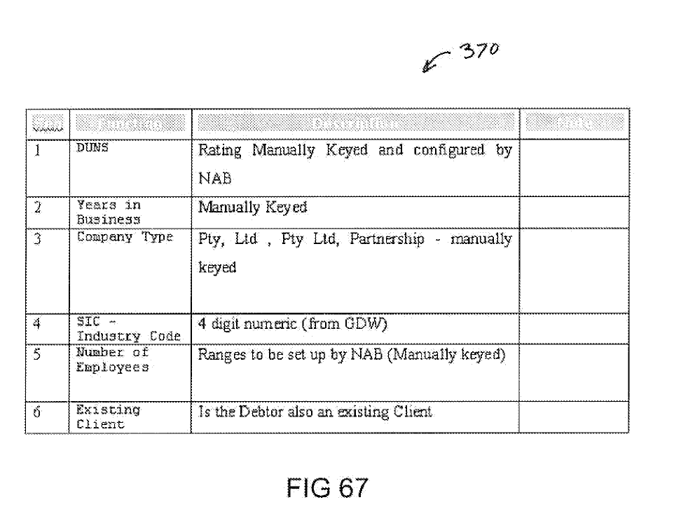

FIG. 67 is a table illustrating exemplary specific company manually defined debtor rating criteria 370. Exemplary functions include DUNS, years in business, company type, SIC—industry code, number of employees, and existing client 102. The DUNS rating is typically manually keyed and configured by NAB. Years in business is typically manually keyed. The company type is typically manually keyed. The SIC is a four digit numeric code from GDW. Number of employees is typically ranges set up by NAB and manually keyed. Existing client 102 provides information as to whether the debtor is also an existing client 102.

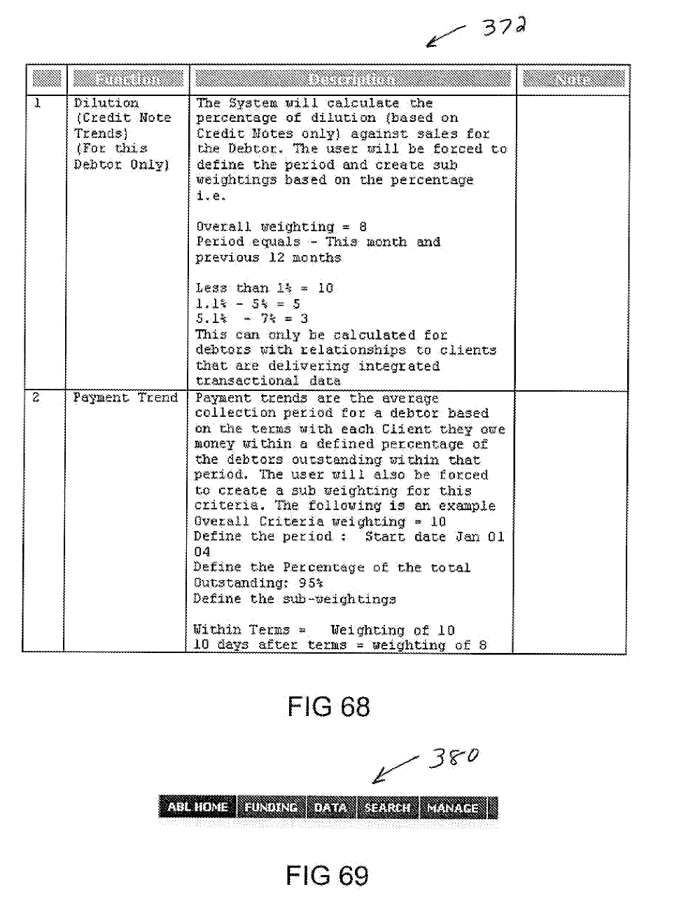

FIG. 68 is a table illustrating exemplary debtor system generated rating criteria 372. The rating criteria 372 are typically implemented into a rating profile as desired by the financial institution 108 and subsequently associated to a desired master debtor or client program. Typical functions include dilution and payment trend, and are as described above.

Client Interface

FIG. 69 is a screen image illustrating an exemplary navigation menu 380. The home page is typically the first page a client 102 sees upon logging into the ABL application. The home page is the main page for the client interface and has a navigation menu across the top of the page that enables the client 102 to perform various system tasks. Further, the navigation menu is also available on all other web pages. From the navigation menu, the client user can access funding, data, search, and manage capabilities.

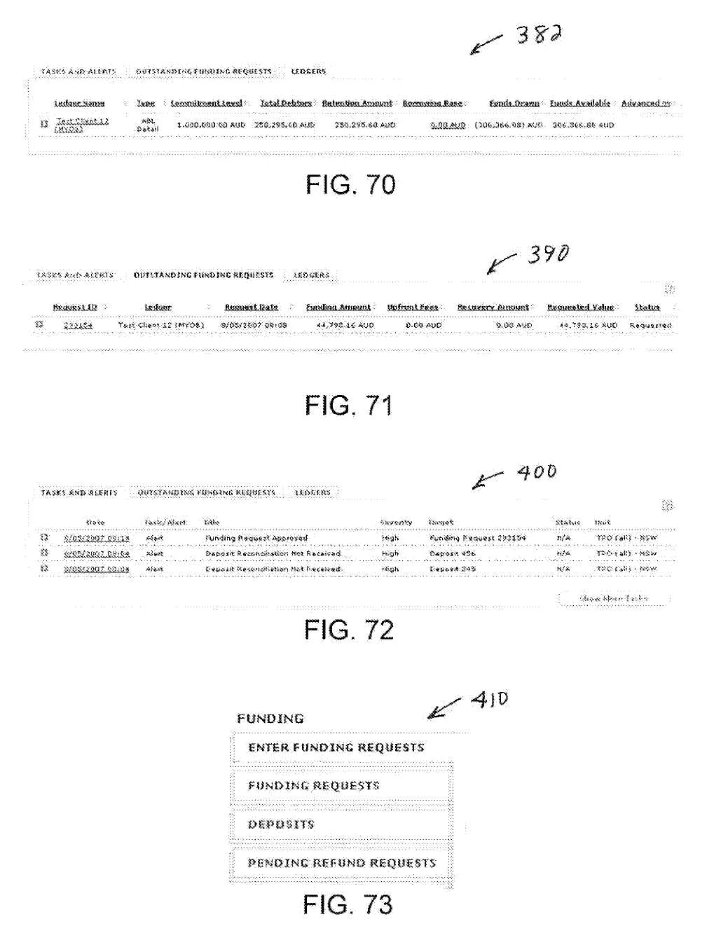

FIG. 70 is an exemplary screen image illustrating a ledgers list tab 382. The client program home page provides ABL clients 102 with a quick view of the ledger list, outstanding funding requests and most recent tasks and alerts. The ledger list tab provides summary information for each of the ledgers, including the commitment level, total assets, retention amount, borrowing base, and funds drawn, funds available, and advanced percentage. The client 102 accesses individual ledger details from the ledgers list tab and can view the detailed information for the selected ledger and perform funding requests.

FIG. 71 is an exemplary screen image of an outstanding funding request tab 390. The outstanding funding requests tab provides a list of pending funding requests and their current status.

FIG. 72 is an exemplary screen image of a tasks and alerts tab 400. The tasks and alerts tab provides a list of current alerts and assigned tasks for the client 102. The client 102 can select a task or alert and view additional details and also can action the task or alert as necessary.

FIG. 73 is screen image of an exemplary funding request tab 410. Client's use the funding tab on the navigation menu bar to access the funding web page. The funding functions provide the capability to enter funding requests, view funding requests, view deposits, and view pending refund requests. The enter funding requests tab is the default tab from the funding page.

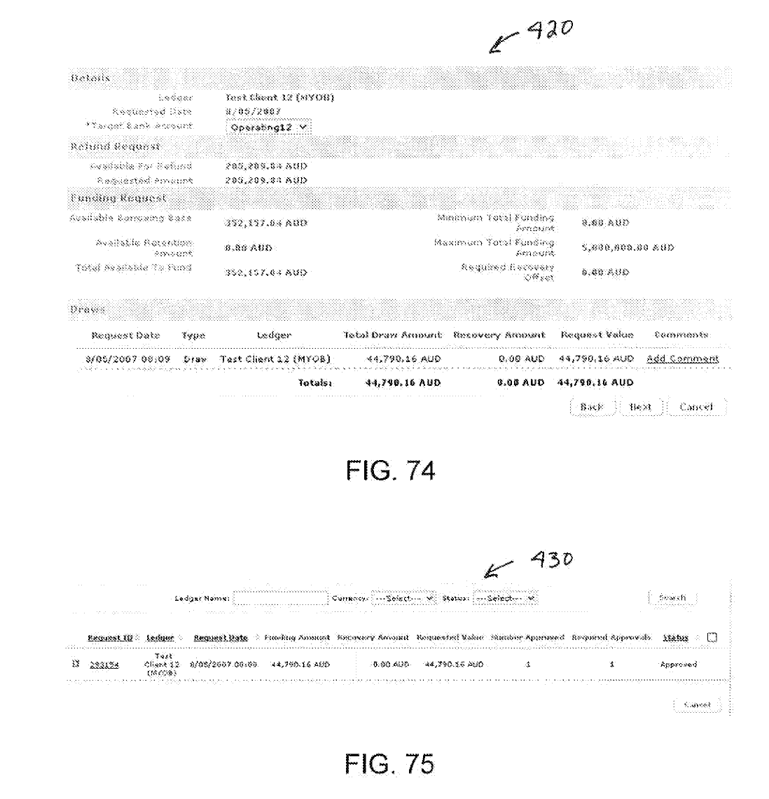

FIG. 74 is a screen image illustrating an exemplary funding request page 420 and showing an associated refund request. From the funding requests tab, the client 102 is presented with a list of ledgers available to fund against. Upon selecting the desired ledger, the funding request page 420 is displayed. From the funding request page 420, the client 102 enters the desired funding amount to draw and continues to the next step. The system then displays the details of the request to the client 102, including any related upfront fees (as applicable). The client 102 also selects an account for depositing the funds and then continues to the next step. The client 102 is presented with a confirmation screen to accept all details before submitting the request to the financial institution 108. At each step, the client 102 has the ability to accept and proceed to the next step or to cancel the funding request.

FIG. 75 is screen image illustrating an exemplary funding request list page 430. By accessing the funding requests tab, the client 102 can view a list of open and approved funding requests. The client 102 may cancel a pending funding request if not already approved. A search capability is provided to assist the client 102 when looking for funding requests on subsequent pages.

The client 102 can view the deposits list page by accessing the deposits tab. Deposits 258 are actual payments that have been received from debtors. Deposits can be cash payments, checks, and electronic funds transfers, among others. From the deposits list page, the client 102 can view a list of deposits, search for specific deposits, and view the details of the deposits by selecting the request ID field. Deposits are discussed further in the deposit reconciliation section below.

From the pending refund requests page, the client 102 can view a list of submitted refund requests that have not been approved. Clients can view refund request details by selecting the bank reference number, cancel a refund request, or search for a specified refund request.

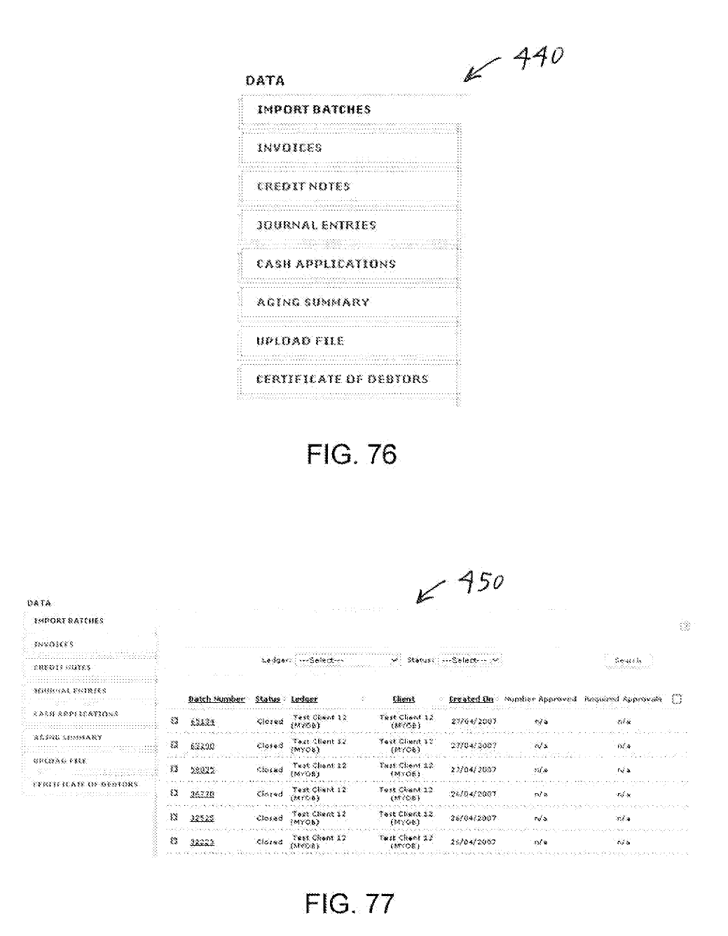

FIG. 76 is a screen image illustrating an exemplary data tab 440. The data function enables the client user to view and manage batch uploads, perform direct entry of accounting transactions, enter and submit an aging summary, upload files, and enter and submit a certificate of debtors (COD).

When uploading files, the client user selects accounting files on his workstation and downloads them to the ABL application for processing. Each downloaded file is displayed on the import batches tab. Accounting transactions are entered on the invoices tab, the credit notes tab, the journal entries tab, and the cash applications tab. These entries are considered direct entries. The aging summary is entered via the aging summary tab and is used to enter the month end reconciliation aging information in summary form. A COD is entered via the certificate of debtors tab. The COD is created whenever the client user is required to enter summary information regarding the current month activity at scheduled times; data entered is compared with transaction values maintained internally within ABL. If the figures do not reconcile within tolerances then the financial institution 108 is alerted of the discrepancy.

FIG. 77 is a screen image illustrating an exemplary batch list page 450 in an ABL application. (FIG. 77 expands upon the information shown in FIG. 39 above.) A batch defines a set of document types that have been uploaded or directly loaded into the system and help to track and organize them for later reference. Batches can contain any number of record types including debtors, invoices, credit notes, journal entries, and cash applications 236. A batch is created any time one or more of the following are uploaded into the system; debtors, invoices, credit notes, journal entries, and/or cash applications. A batch contains the status of each individual record uploaded in that batch, and a count of errors that exist within the batch. Batches can be modified to correct erroneous data or to remove invalid documents. Batches have historical information as to when they were loaded, and contain client name, ledger, and hyperlink to client details. Batches have a “Details” hyperlink that displays a list of records contained in the batch. Users can hyperlink and view record details.

The import batches tab displays a list of batches submitted by the client 102. The financial institution 108 and client use the pending status of a batch to identify open batches that require attention. The financial institution 108 can also set the clients ledger so that all batches must be reviewed and accepted or rejected by a financial institution 108 user having the appropriate permissions.

The direct entry online forms are accessed from the data page and are designed to be used by summary clients 102 that do not have the ability to upload their transaction data or by detail clients 102 requiring a one off manual entry as an adjustment. Once the direct entry has been completed, all data records entered are typically submitted via a batch file into the ABL system. From the data tab, clients 102 select the direct entry record type, such as, for example, invoices, credit notes, cash applications, or journal entries. Once the direct entry record type is selected, a list of debtors and their associated ledgers is displayed, the client 102 then selects the debtor/ledger for which the records are entered.

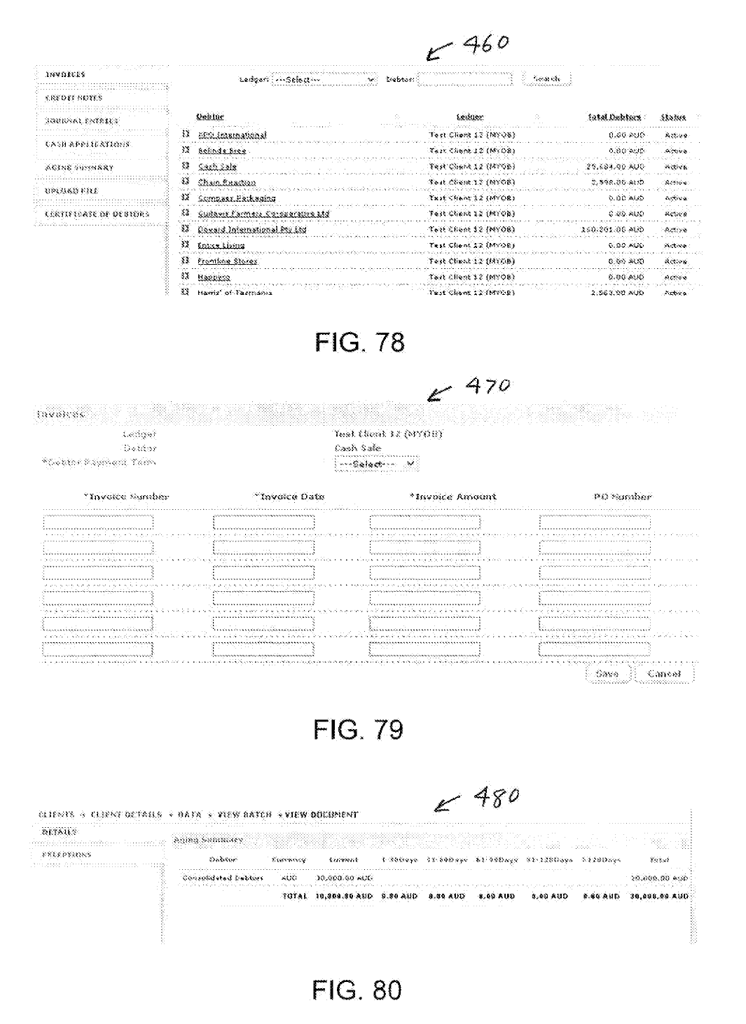

FIG. 78 is a screen image illustrating an exemplary debtor select list page 460. Once the debtor/ledger is selected the client 102 enters the required data and the desired number of direct entry records.

FIG. 79 is a screen image illustrating an exemplary invoice direct entry page 470.

FIG. 80 is a screen image illustrating an exemplary aging summary batch record 480. This aging summary page is designed to allow the client 102 to enter their summary aging information through the ABL web interface. This page is for ABL—summary clients who do not have the ability to upload their aging information or detail clients who do not have the capability to submit a detailed aging via the data upload. The reconciliation process begins when the client 102 enters his aging summary from the aging summary entry page. Once entered, the ABL system compares the reconciliation file to invoices already in the ABL system. If required, a list of invoice exceptions is generated. As part of the batch process a report of all exceptions for the period is presented to the client 102 and financial institution 108. The client 102 or financial institution 108 uses the exceptions list by uploading additional data file(s), entering adjustments through the direct entry screens, or if necessary canceling the current aging summary and uploading a new one. Once the reconciliation is balanced within tolerance levels, the client 102 has access to the certificate of debtors (if required).

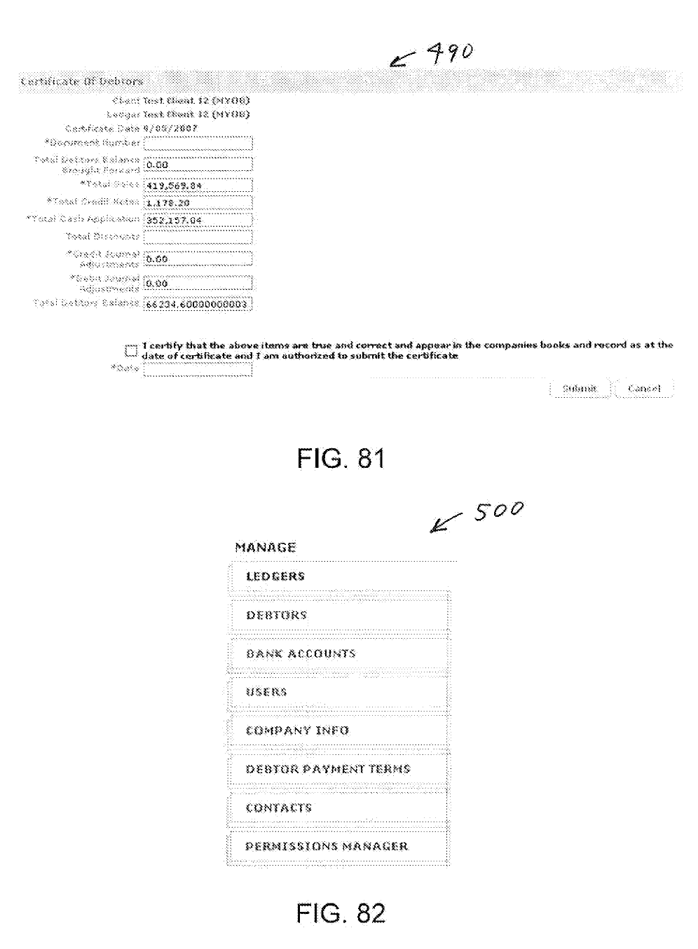

FIG. 81 is a screen image illustrating an exemplary certificate of debtors page 490. The financial institution 108 may require the client 102 to complete a certificate of debtors each month. If this is the case, then the client 102 uses the ledger specific form available from the certificate of debtors tab to submit the required reconciliation information. From the COD form, the user is presented with the total balance brought forward from the previous month end, as well as the current month end total balance. The client 102 then completes the certificate of debtors and submits for processing. If any of the items do not balance within tolerance levels, the COD is deemed out of balance, and the client 102 makes any necessary corrections. Tolerance levels for the certificate of debtors are based on the tolerance levels set up in the reconciliation configuration.

FIG. 82 is a screen image illustrating exemplary features available on the manage function tab 500. From the manage function tab, the client 102 can manage ledgers, debtors, bank accounts, users, company info, debtor payment terms, contacts and permissions. The ledger tab provides the client 102 with the capability to view a list of ledgers and access ledger details. The ledger details tab is the default page displayed when accessing a ledger. Other available tabs consist of receivables, debtors, auto funding, contacts, reserve account and borrowing base.

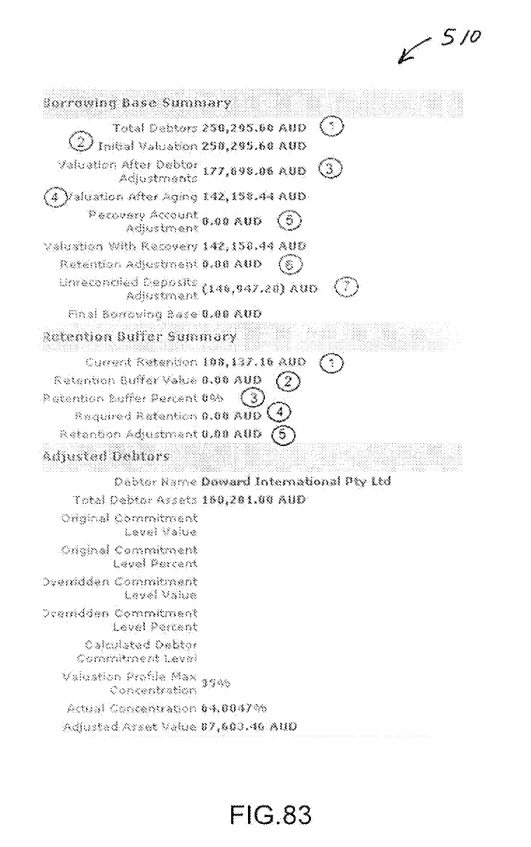

FIG. 83 is a screen image illustrating exemplary details provided by the borrowing base visibility page 510. From the ledger details page the client 102 has visibility to borrowing base details. The purpose of the ABL borrowing base visibility is to provide the user with increased visibility and understanding into how the borrowing base figure was derived. Key summary values as well as certain key detail information are provided to help the client user understand what affected the borrowing base outcome. The borrowing base visibility page displays a worksheet using the summary values derived from each major step of the borrowing base calculation. The summary values displayed consist of the components that make up the borrowing base; total debtors for ledger, initial valuation, valuation after debtor adjustments, valuation after aging, recovery account adjustment, retention adjustment, and unreconciled deposits. The defined components are: (1) Total debtors for ledger is the sum of invoice balance on outstanding invoices to active debtors. (2) The initial valuation based upon whether invoices should be valued based on full invoice balance or discounted invoice amount (as per debtor payment terms). (3) The valuation after debtor adjustments consists of comparing each debtor's total debtors value against debtor credit limit. Then compare each debtor's total debtors value against concentration percentage (from valuation profile). Adjusting the debtor valuation as necessary (is the lesser of the total debtors value, the debtor credit limit and debtor concentration value). (4) Applying aging valuation rules to invoices is the process of sorting invoices by age and including into the borrowing base oldest invoice first (newest invoices held back as required). Invoices are aged with appropriate recourse type applied (monthly recourse, invoice, etc.). Invoices past recourse are excluded from borrowing base. And finally, aging values from valuation profile are applied to invoices remaining in the borrowing base. (5) The recovery account balance is adjusted by the recovery account buffer and amounts not calculated for refund. (6) Adjust for retention buffer (as necessary), taking into account the retention buffer setting on the valuation profile for percentage of borrowing base of the amount. (7) Adjust for unreconciled deposits based on borrowing base downgrade settings (as necessary).

From the receivables tab, the client 102 can view details about the receivables in his ledger. The receivables consist of the invoices that have been uploaded into the system and are still calculated in the borrowing base. They are organized by debtor and display summary information for each debtor and each aging column as defined in the valuation profile. By selecting a debtor, the client 102 can see the age of each receivable and its details. The client 102 has the option to download the display into CSV, Excel or PDF format.

From the debtors tab a list of all the debtors within that ledger is displayed along with total invoices, borrowing base, concentration, percentage retention amount, advance percentage, and payment terms for each debtor. The client 102 can view the debtor details by selecting the debtor name.

The auto funding tab allows the client 102 to set up auto funding rules. The auto funding rules are used to initiate funding requests automatically.

The reserve account tab provides the visibility into the retention and recovery components of the reserve account. Details regarding the recovery account are found the recovery account further on in this document.

Reserve Account

The reserve account is an important component of the ABL application and is instrumental in maintaining the system's financial balance. The reserve account has two main components, the reserve retention and the reserve recovery account. The reserve account resides at the client ledger level. The reserve retention is the difference between the client's 102 total assets and the total borrowing base. Since this portion of the collateral is not included in the borrowing base, it cannot be funded against and thus, can be used as reserve collateral.

The recovery account acts as a reconciliation account as well as the funded portion of the reserve account, as necessary. All interest and fees are reconciled through this account. The recovery account is also used to process non-funded cash and any other necessary transactions. The recovery account contains the individual transactions, which are then summed together to determine the balance in the recovery account. The financial institution 108 can configure a buffer amount to always hold in reserve. If the recovery account balance is greater than this buffer amount, the difference is available to the client 102 as a refund. When refunds are processed, the refund amount applies down to the oldest recovery items first, paying them off and closing the transactions.

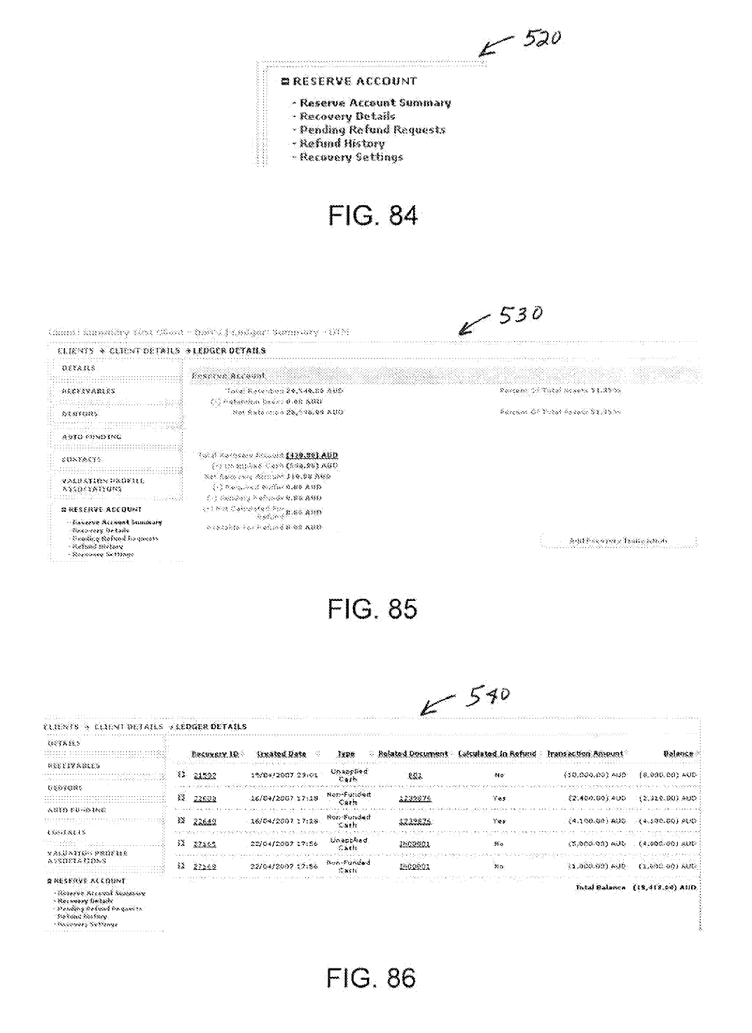

FIG. 84 is a screen image illustrating exemplary reserve account tab 520 functionality. The reserve account tab is accessed from the client ledger display. The reserve account tab provides access to reserve account summary, recovery details, pending refund requests, refund history, and recovery settings.

FIG. 85 is a screen image illustrating an exemplary recovery account summary page 530. The reserve account summary page 530 displays a quick summary view of the amounts currently held in retention and in the recovery account. If funds are available to the client 102 in the recovery account, the client 102 may request a refund for those available funds or the financial institution 108 may perform this request for the client 102.

FIG. 86 is a screen image illustrating an exemplary recovery account details page 540. The recovery account details page 540 displays a list of all open items currently in the recovery account. The recovery account details page 540 is accessed from the reserve account summary total recovery hyperlink or the reserve account tab “Recovery Details” hyperlink. Fees and interest configured in the client's pricing profile are calculated and applied based on the frequency determined in the pricing profile. At the time the fee is applied, a debit is created in the recovery account for the amount of the fee being charged. When deposits 258 are received into the ABL system, they are entered as unapplied cash into the recovery account. Unapplied cash increases the total recovery account balance, but is subtracted from it to create the net recovery balance. The net recovery balance is used in the borrowing base valuation to affect the overall total borrowing base. The unapplied cash is subtracted from borrowing base in a separate step. The net recovery balance is also used to calculate the available for refund amount. Unapplied cash amounts are recorded as credits to the recovery account (negative amounts), but are not available for refund to the client 102. They are held in the recovery account until the corresponding deposits 258 are reconciled, and then the unapplied cash items are applied accordingly and closed out.

Non-funded cash is money received from deposits 258 that are refunded back to the client 102 instead of being used to pay down open draws. Non-funded cash includes an amount of the deposit 258 related to the portion of the invoices not included in the borrowing base (e.g., 20 percent refunded to the client 102 and 80 percent to pay down draws), deposits 258 received in excess of open draws (if all draws are paid in full, and there are remaining deposit amounts to apply to draws, these amounts become non-funded cash), deposits 258 received against invoices past the recourse period, deposits 258 received against invoices purchased but not funded (e.g., debtor not in borrowing base), and any other deposits 258 received which do not relate to purchased invoices, among others. Non-funded cash items are entered as credits into the client's 102 recovery account (negative amounts to the financial institution 108).

The financial institution 108 has the ability to manually add debits or credits to the recovery account. The user enters the deposit type, adjustment, non-recurring fee, adjustment type )credit or debit), account code, collection type, amount, and description. An adjustment deposit type is a manual entry into the recovery account. As an example, the financial institution 108 requires the client 102 to deposit a certain amount upfront into the recovery account to be held at all times as collateral. Therefore, the client 102 deposits the funds to the financial institution 108, and the financial institution 108 enters this amount as a credit into the recovery account. Then, with the buffer set on the recovery account, this amount is held as collateral and not released to the client 102 until the financial institution 108 chose to release those funds.

A non-recurring fee is a specific manual deposit type. It is initiated manually by the financial institution 108 user through the manual recovery transaction add screen. The user selects the transaction type of “non-recurring fee”, enters an amount, and a description. Typically, the non-recurring fees are always credits.

To charge the client 102 a fee, the “Credit” adjustment type is selected. The financial institution 108 user could alternately select the “Debit” adjustment type to credit the client 102 back for a fee. This could be used in cases where the financial institution 108 chose to give the client 102 credit back for a portion of a fee charged.

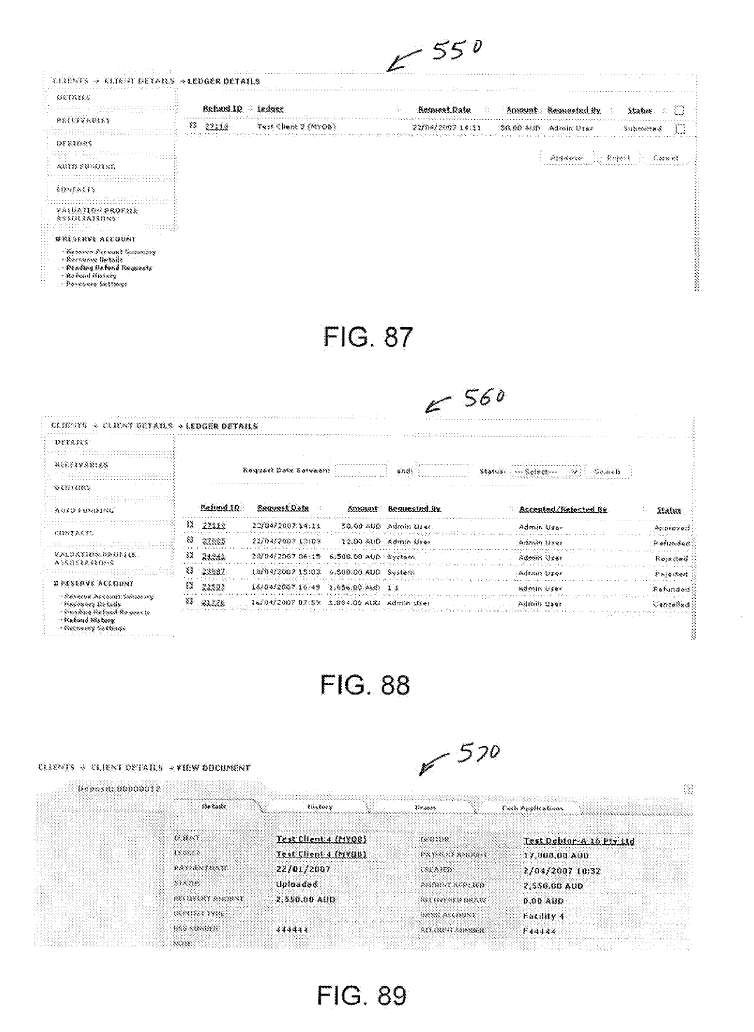

FIG. 87 is a screen image illustrating exemplary reserve account pending refund requests 550. The pending recovery refund page is accessed from the reserve account tab “Recovery Details” hyperlink, or the client details funding tab. The financial institution 108 is presented a list of pending refund requests that require manual acceptance. The user is then able to accept or reject refund requests from this page. The financial institution 108 has the capability to set up rules to automatically accept refund requests as desired. Only refund requests 550 that fall outside of these configured parameters require manual acceptance from the financial institution 108.

FIG. 88 is a screen image illustrating an exemplary reserve account refund history page 560. The reserve account refund history 560 displays a list of recovery refund requests, along with their statuses. The user is able to select a request and view the details of that request. If the refund request was accepted, the detail record also includes a list of recovery items that were paid out with that request, and the amounts applied to those recovery items.

Deposit Reconciliation

Deposits are reconciled against both draws and invoices, reducing the collateral as well as paying down against open draws. The basic steps for this reconciliation process are, capture deposit information, deposit entered as unapplied cash, determine minimum immediate refund amount, match deposits to cash applications aging invoices, and apply remaining deposit balance to draw(s) and/or recovery account as necessary.

FIG. 89 is a screen image illustrating an exemplary deposit page 570 in an ABL application. (FIG. 89 expands upon the information shown in FIG. 37 above.) The system captures and stores information on deposits received. Once the deposit data is captured, the deposits are matched to the appropriate client ledger and are reconciled against draws and invoices.

In addition to this header information, deposits include a related deposits tab, draw tab, attachments tab, and a history tab. This information allows the user to view and link back to the draws that the deposit applied to, as well as cash applications 236 related to the deposit. Please see the electronic documents section of this document for more information on how the deposit documents are stored and displayed.

When deposits are received, the client 102 is immediately refunded the minimum possible amount of non-funded cash.

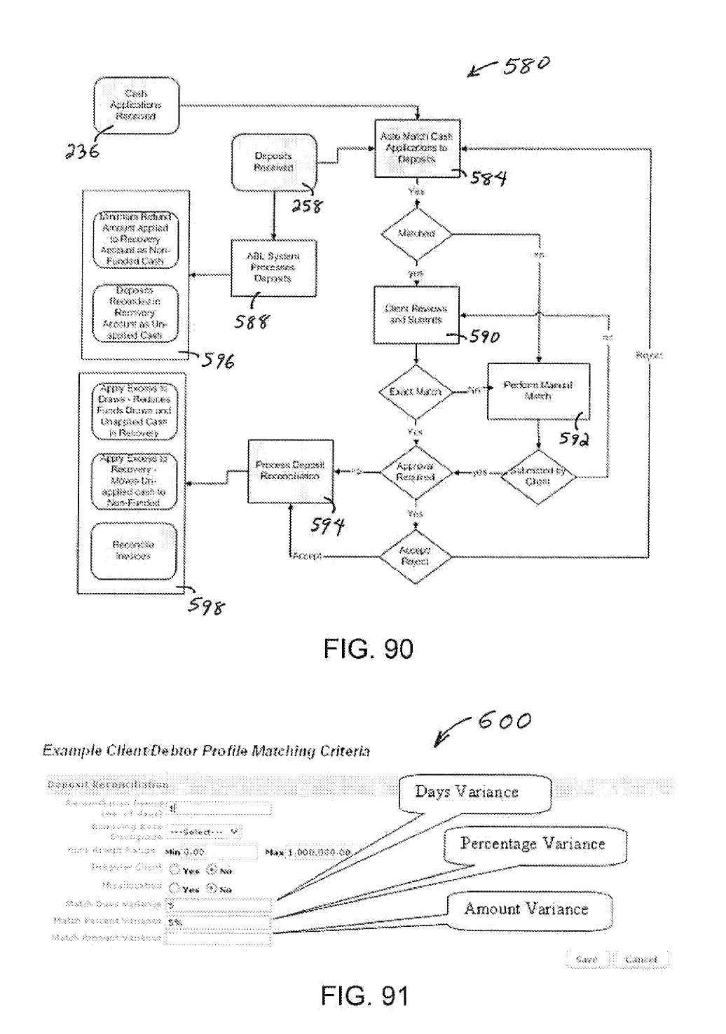

FIG. 90 is a process map illustrating an exemplary matching process 580 for a detailed integrated client. When reconciling deposits 258 for ABL detail clients, deposits 258 are matched to invoice related cash applications 236. ABL detail clients are also known as integrated clients as they directly upload accounting transaction information into the ABL application.

With an integrated client, cash application 236 information is received and uploaded into the system through integration process with the client's accounting system. Cash applications 236 are matched automatically 584 to deposits 258, if possible. The client 102 has the capability to manually reconcile (or match) 592 any unmatched items (appropriate permissions are required).

The client 102 has the capability to review 590 matched items before accepting and submitting the reconciliations to the financial institution 108. Once the client 102 submits the reconciliations, the financial institution 108 has the capability to review and modify, if necessary, before accepting the reconciliations. Cash applications 236 are not actually applied to the invoices until the financial institution 108 has accepted the reconciliation.

The financial institution 108 has the capability to configure auto-accept rules for reconciliations. This allows the financial institution 108 to control how closely they monitor reconciliations on a per client 102 basis.

The system attempts to match cash applications 236 back to the unreconciled deposits using date and amount matching criteria. This solution allows the bank to configure date and amount variance parameters to better match its client's reconciliation trends. The expected result is to affect a high number of automated matching 584 between deposits 258 and cash applications 236 and reduce the need for manual matching 592.

FIG. 91 is a screen image illustrating exemplary profile matching criteria 600 available from a client debtor profile. The profile matching criteria 600 are configured in the deposit reconciliation section of the client debtor program associated with the client's ledger. The profile matching criteria 600 includes a day variance field, percentage variance field, and an amount variance field. The days variance field is numeric, and contains valid values with a range from 0 thru 99. The default value is zero. When set to zero, the date matching must be exact and when set to 1 through 99, date matching is performed on a date range. The percentage variance field is a percentage, valid values are 0 thru 100 percent, in whole percentage increments. The default value is zero. When set to zero percent the amount matching must be exact, and when set to 1 through 100 percent, amount matching is performed on the range based on the value entered, and may not be used in conjunction with the amount variance field. The amount variance field is a dollar amount based on the currency value set in the client/debtor profile, has valid positive values of 0 thru 999,999,999.99. The default value is zero, and when set to zero, the amount matching must be exact. When set to any value other than zero, matching is performed on the range based on the value entered and may not be used in conjunction with the percent variance field.

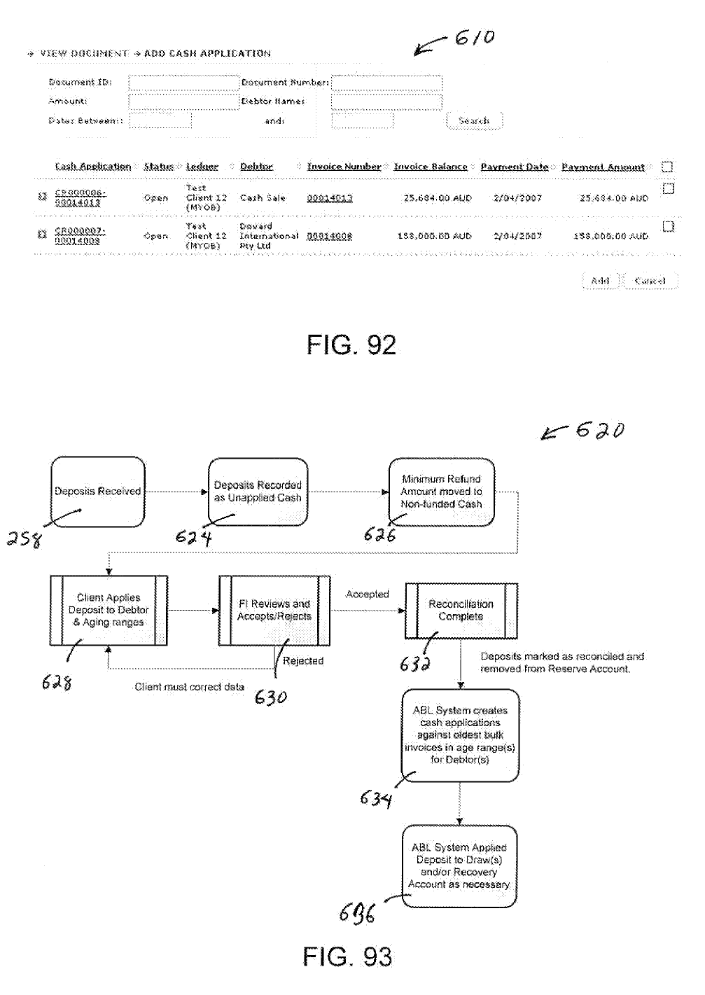

FIG. 92 is a screen image illustrating an exemplary cash application add page 610. The deposit reconciliation matching process uses the day variance field, the percentage variance field, and the amount variance field, to determine if a cash application 236 matches a deposit 258. The primary match between a deposit 258 and a cash application 236 is typically an exact match on the deposit date and the cash application date, and an exact match on the deposit amount and the sum of the cash application amounts. (Cash applications 236 with the same number and date). A secondary match criterion is applied if the primary criteria are not met and the day variance field is not equal to zero. The secondary match determines the date range, based on the day variance field value, by taking the deposit date and computing a future and past date range base upon the value.

As an example, if the variance field value is 2, and the deposit date is Dec. 15, 2006, then the beginning date range is Dec. 15, 2006−2 days=Dec. 13, 2006. The ending date range is Dec. 15, 2006+2 days=Dec. 17, 2006. The calculated date range is Dec. 13, 2006 thru Dec. 17, 2006. The date range is used to select the cash applications 236 having a date that falls within that range. The deposit amounts are compared with the selected cash application amount from the beginning date (Dec. 13, 2006) through the ending date (Dec. 17, 2006). A match is made when the first cash application 236 having the same amount as the deposit amount is found, and no further checking is required. (A single cash application 236 includes the cash applications having the same number and date.)

Finally, a subsequent match is performed if no match is found using the primary and secondary match criteria and either the variance percent field or the variance amount field is entered. The subsequent match checks whether the day variance field is not zero, then determines the date range. If variance percent field is not=0%, then variance range is calculated. The deposit amount is multiplied by the variance percent field value. The result is subtracted from the deposit amount to determine the beginning amount, and the deposit amount is used as the ending amount.

As an example, if the deposit amount is $1000 and variance percent field value=5%, then 5% of $1000 is $50. Subtracting $50 from $1000 leaves $950. Therefore, the calculated range is $950 through $1000. If the variance amount field is not zero, then a variance range is calculated. Use the deposit amount and subtract the value in the variance percent field. The resulting value is the beginning range amount. The deposit amount is the ending range amount. If a date range is calculated, the range is used to select the cash applications 236 having a date that falls within that range. Otherwise, only those cash applications 236 having the same date as the deposit are considered. Once the cash applications 236 satisfying the date criteria have been identified, the cash application 236 amounts are compared to the calculated amount range. The selected cash application 236 is one having an amount that falls within the range and is nearest the deposit amount. Exceptions can occur. When a cash application 236 is split across multiple invoices; it is first summed into a single comparison amount when matching against the deposit. Such cash applications 236 have the same cash application number and date. Only deposits 258 without any cash applications 236 can be considered for exact matching.

The client or financial institution user manually matches any exception items that the system could not determine via the automatic match process. An interface is provided for the client 102 to process these exceptions. The process for reconciling deposits manually for summary clients uses a separate user interface.

FIG. 93 is a process map illustrating an exemplary matching process 620 for a summary client. Summary clients do not have invoice detail stored in the system, therefore cash applications 236 are not matched at a detail level. Instead, the client 102 enters the amount of the deposit 258 that applies to specific aging categories per debtor 120. The system automatically creates cash applications 236 against the oldest bulk invoices 628 in the applicable aging category for the specified debtor 120.

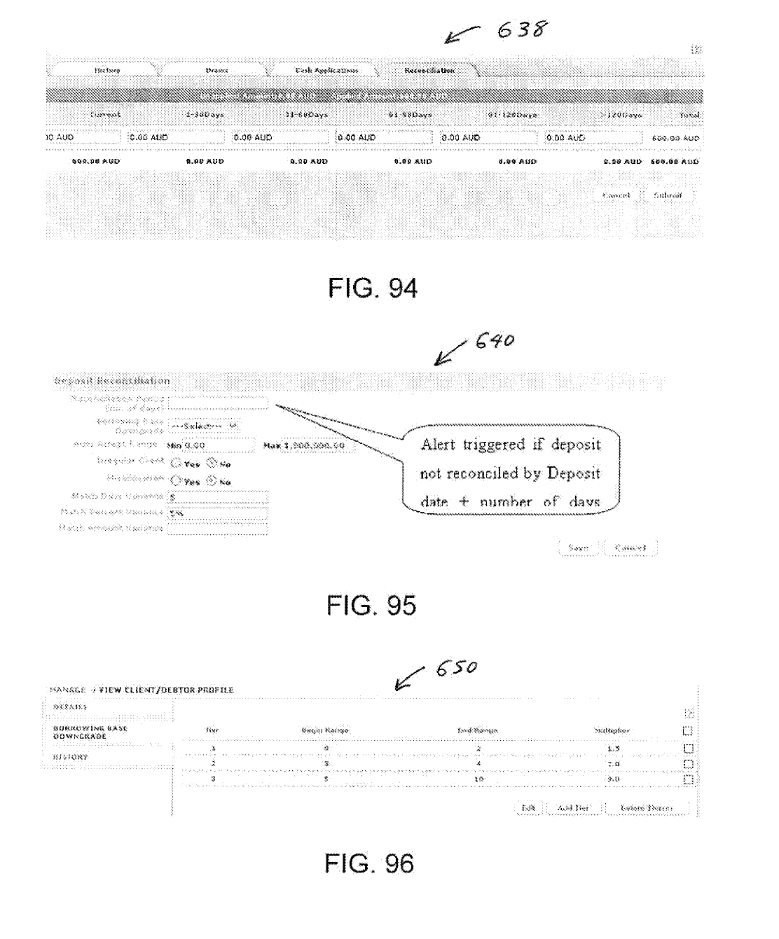

FIG. 94 is a screen image illustrating an exemplary manual reconciliation tab 638 of the summary client deposit document. After deposits are reconciled, the system automatically calculates the amount that is applied to the oldest draws and/or the recovery account, as well as any additional non-funded cash amount to refund to the client.

The financial institution 108 configures a deposit reconciliation period for the client. If deposits 258 are left unreconciled beyond the approved setting, the client 102 may have certain restrictions placed on their account, depending on the settings the financial institution 108 has chosen to configure. These restrictions help to ensure the safety of the financial institution 108 portfolio while at the same time encouraging the client 102 to reconcile their deposits 258 in a timely manner. This parameter is set in the client debtor profile.

The financial institution 108 is able to determine the required reconciliation period for the client ledger. This parameter is a number of days. The client 102 has this set number of days from the time the deposit 258 is received to reconcile outstanding unreconciled deposits.

FIG. 95 is a screen image illustrating an exemplary deposit reconciliation section 640. The deposit reconciliation section 640 contains the reconciliation period number of days parameter. The number of days parameter is specified in the client/debtor profile.

The financial institution 108 has the capability to configure tasks/alerts to be automatically generated and sent to the users as set up by the financial institution 108. The alerts include an alert notifying when unreconciled deposits have exceeded their reconciliation period and an alert notifying the financial institution 108 when client 102 is consistently applying funds only to the oldest invoices, regardless of which invoices were actually paid for by the deposit.

FIG. 96 is a screen image illustrating an exemplary borrowing base downgrade table tab 650. The financial institution 108 has the option to downgrade the client's borrowing base if unreconciled deposits 258 exceed their reconciliation period. The financial institution 108 may enter parameters to increase the value of the deposits 258 as it affects the borrowing base. The default of this parameter is one, therefore the deposits are included at their full amount against the total assets to decrease the overall borrowing base. However, the financial institution 108 also has the ability to create a tiered schedule, based on the number of days the deposits 258 have exceeded their reconciliation period, to determine how much to decrease the borrowing base. This parameter is configured on the client/debtor profile.

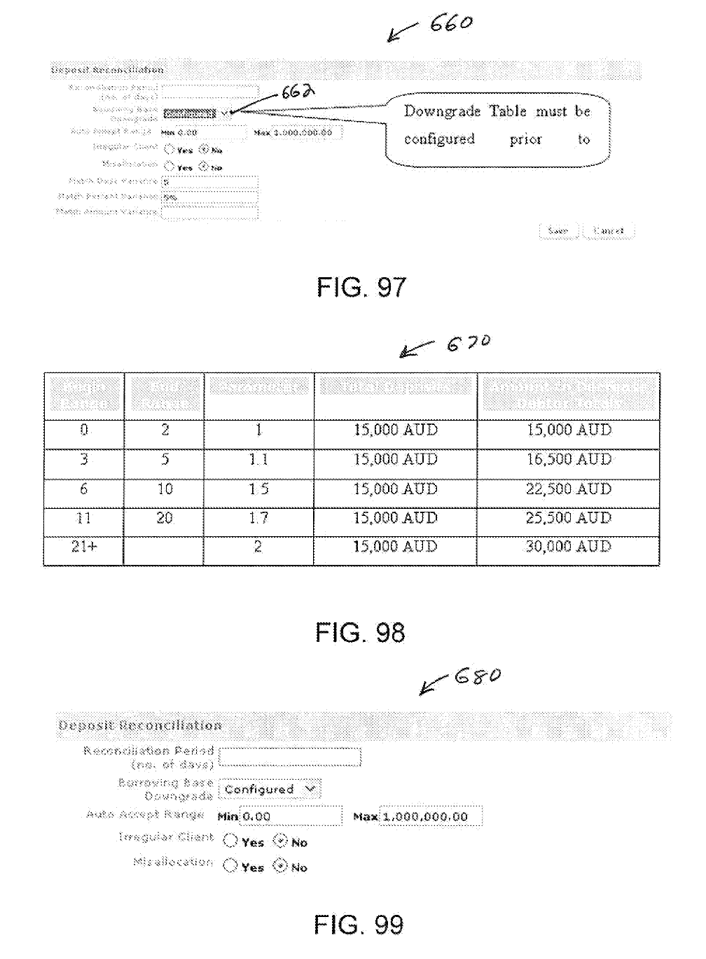

FIG. 97 is a screen image illustrating an exemplary “Configured” parameter 660 in the client debtor profile. In order to properly activate the downgrade capability, the downgrade table is configured and the drop down menu for the borrowing base downgrade 662 in the deposit reconciliation section of the client debtor profile is set to “Configured”.

FIG. 98 is an exemplary illustration 670 of the effect of the tiered parameter on the client's borrowing base. This setting only affects how much the client's borrowing base is adversely affected by the unreconciled deposit totals. This does not increase the actual amount of the deposits, nor does it increase the actual amount applied against draws.

FIG. 99 is a screen image illustrating exemplary “Auto Accept” parameters 680 on the client debtor profile. The financial institution 108 is provided with the ability to configure rules to auto-accept deposit reconciliations submitted by the client. This allows the financial institution 108 to choose how closely to monitor client reconciliations. These rules are configured on the client debtor profile.

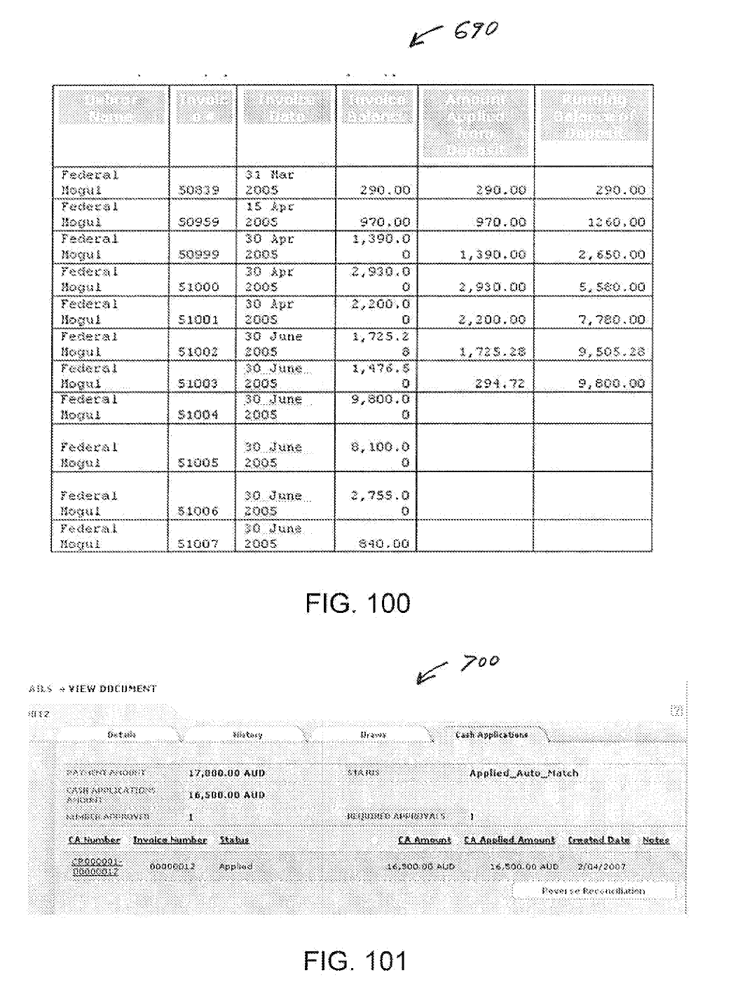

FIG. 100 is an exemplary illustration of identified invoice misallocations 690. The potential misallocation of funds feature initiates a task that notifies the financial institution 108 in cases where it appears the client 102 is simply applying all deposits against the oldest invoices first, rather than towards the actual invoices that are being paid for on the deposit 258. Clients 102 do this attempting to keep their borrowing base valued as highly as possible—they can keep the invoices that are past their maximum tenor off the financial institution 108 books, while keeping newer invoices, which are valued more highly, in the borrowing base. This task is typically applicable only for ABL detail clients. To determine the potential for misallocation of funds, the system analyzes the pattern of applying money to the oldest invoices first, with the final amount not matching the invoices they are applied to. A common indicator that the client 102 is misallocating funds is a combination of the deposit 258 being applied to the oldest invoices along with an odd remainder amount that is applied as a partial cash application 236 against an invoice to balance out the deposit 258. Therefore, in the example, a deposit 258 is received from Federal Mogul for 9,800.00. The deposit 258 is intended to pay for invoice #51004. The client 102 chooses to apply the deposit 258 as cash applications 236 against the oldest invoices out to the debtor 120 first. In FIG. 100, all invoices were paid in full, with a partial cash application 236 applied to invoice #51003. Partial cash applications occur, but the combination of the partial cash application along with the fact that the deposit 258 was reconciled against the oldest cash applications 236 first indicates the likelihood that the deposit 258 was misallocated.

FIG. 101 is a screen image illustrating an exemplary cash application tab 700 with the reverse reconciliation button. The system provides the capability for financial institution users to correct misapplied deposits 258 and cash applications 236. This correction is known as a reversal. Reversals are preformed from the deposit electronic document cash application tab. FIG. 101 is a screen image illustrating the cash application tab with the reverse reconciliation button.

Portfolios

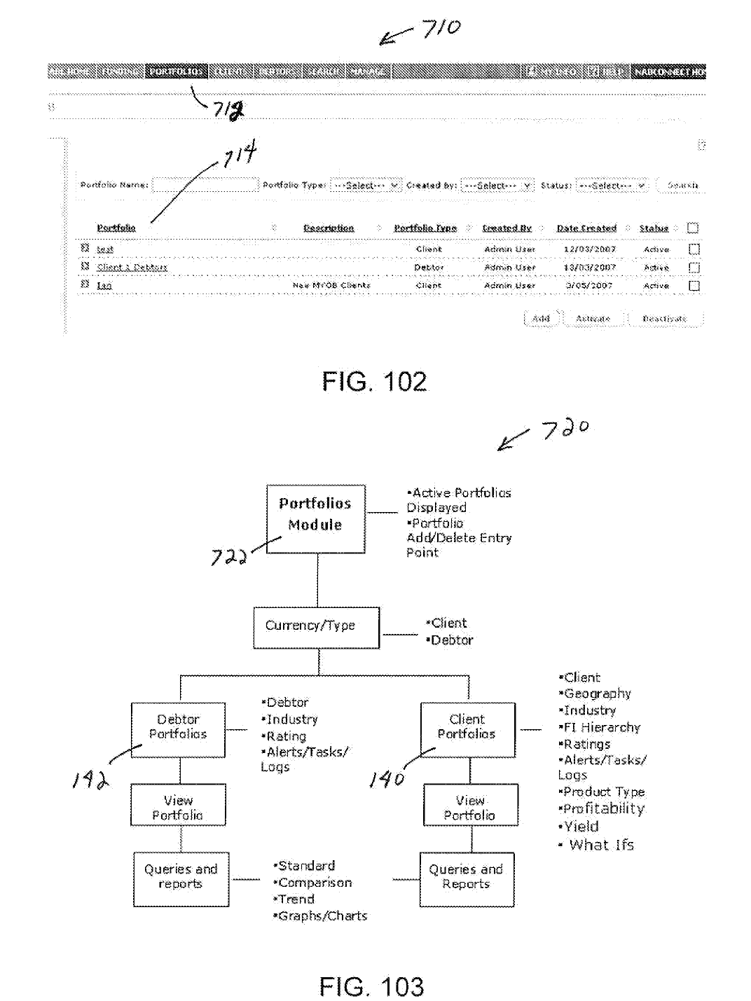

FIG. 102 is a screen image 710 including an exemplary navigation menu 712 and a portfolio list page 714. Financial institution users access the portfolio function via the navigation menu. From the list page, users can view and modify existing portfolios, add a new portfolio, and activate or deactivate a portfolio.

FIG. 103 is a diagram 720 illustrating exemplary components of a portfolio. The portfolio 722 functionality provides the financial institution 108 with the capability to create, organize, monitor and report on ABL clients 102 and debtors 120 within a financial institution's 108 entire ABL lending universe. The financial institution 108 user can create client portfolios 140 consisting of a single client 102 or multiple clients. The financial institution user can create debtor portfolios 142 consisting of a single debtor 120 or multiple debtors. The financial institution 108 can create, organize and monitor portfolios 722 according to multiple grouping criteria, such as, currency, geography, groups (hierarchy), geographical (country, state), industry, and risk scores, for example.

Portfolio queries provide comparisons, trends and statistics between the clients 102 or debtors 120 contained in a portfolio. Client portfolio queries typically fall into five categories: performance, aging analysis, risk analysis, ineligibles, and yield. Debtor portfolio queries typically fall into four categories: collections, concentration, dilution and aging analysis. Query results can be downloaded in XML, CSV or PDF format, for example.

Any number of portfolios 722 can be constructed by the financial institution user. Each portfolio 722 may be further defined by a risk group or any number of risk groupings. A risk group is a grouping of clients 102 or debtors 120.

Portfolio access is controlled by the financial institution portfolio owner. Read and update capabilities can be granted to others who may need access to the owner's portfolio 722. Portfolios 722 can be removed or modified without any consequence to application processing.

The financial institution 108 can configure client and debtor task and alerts on ay portfolio. The task and alert reports on the clients 102 or debtors 120 within the portfolio 722. Portfolios 722 can be deactivated. When a portfolio 722 is deactivated, it is longer used to produce reports or perform reporting. No history is maintained for deactivated portfolios 722 with the exception of when and who performed the deactivation. Valid statuses for a portfolio are “Active” and “Deactivated”.

To construct and add a portfolio 722 to the financial institution 108, users select the add button from the portfolio list. The add portfolio page is displayed. From the add portfolio page, the user enters the portfolio name, description, portfolio type (either client or debtor) and the currency.

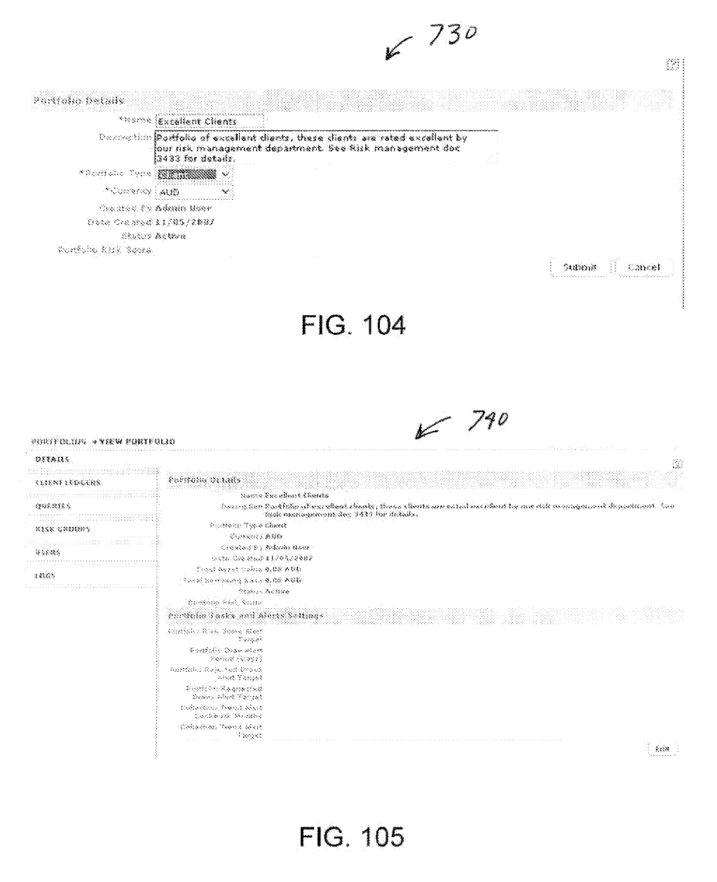

FIG. 104 is a screen image illustrating an exemplary configured portfolio add page 730. Once added, the portfolio 722 is ready to be configured. The client 102 selects the desired portfolio 722 from the portfolio list page 714. FIG. 105 is a screen image illustrating an exemplary client portfolio details page 740. The client portfolio details page 740 is displayed for the selected client portfolio 140. The user configures the portfolio 722 by adding client ledgers via the client ledgers tab, risk groups from the risk groups tab, and optionally adding user and user access privileges via the users tab.

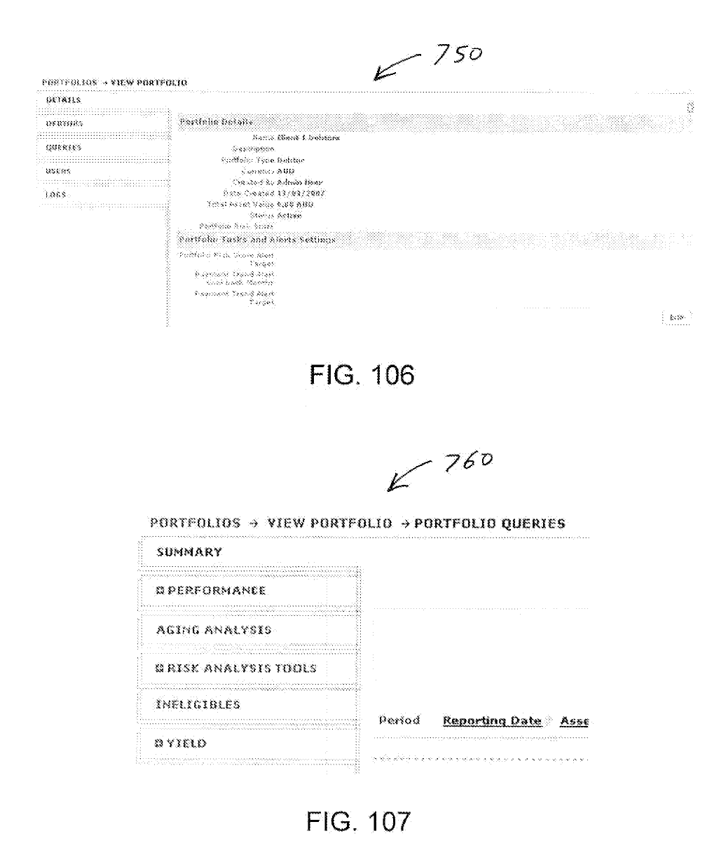

FIG. 106 is a screen image illustrating an exemplary debtor portfolio details page 750. For a debtor portfolio 142, the user configures the portfolio 722 adding debtors via the debtors tab and user access privileges via the users tab.

FIG. 107 is a screen image illustrating an exemplary client portfolio query page 760 with associated query tabs. The client portfolio details page 740 queries tab provides the user with the facility to view queries based on the clients 102 selected in the clients tab. Once accessed, the queries page provides the user with access to summary, performance, aging analysis, risk analysis tools ineligibles and yield.

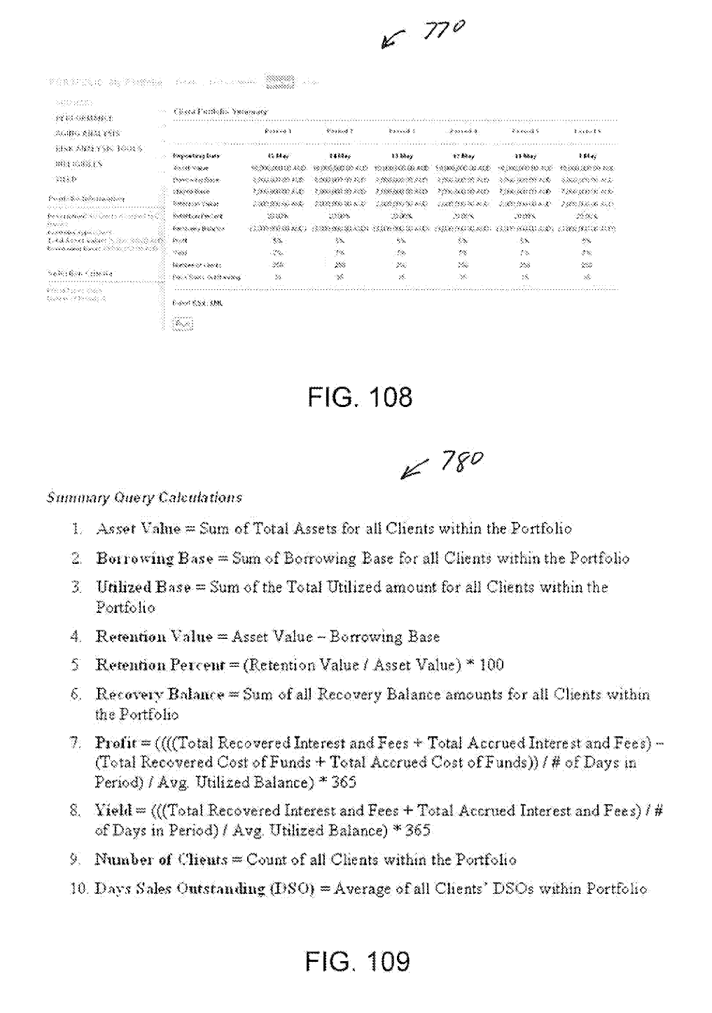

FIG. 108 is a screen image illustrating an exemplary client summary portfolio query 770. When first accessing the client portfolio query page 760, the summary tab is displayed by default. From the summary tab the financial institution 108 can access and run the client summary portfolio query 770. The client summary portfolio query 770 displays the outstanding balances of the client portfolio 140 summarized over the specified time periods up to the last nightly process (for the last close of business day). The user has the capability to define the type of reporting periods to compare (days, weeks, months, years), as well as the number of periods to compare (e.g., 6 weeks, 5 months, etc.).

FIG. 109 is an exemplary depiction of summary query calculations 780. The fields displayed in the summary portfolio query 770 and their associated formulas are shown. Calculations for the query results are based upon the reporting period requested.

The performance queries are accessed from the client portfolio query page 760. The performance queries include (1) client performance query and (2) BUID performance query.

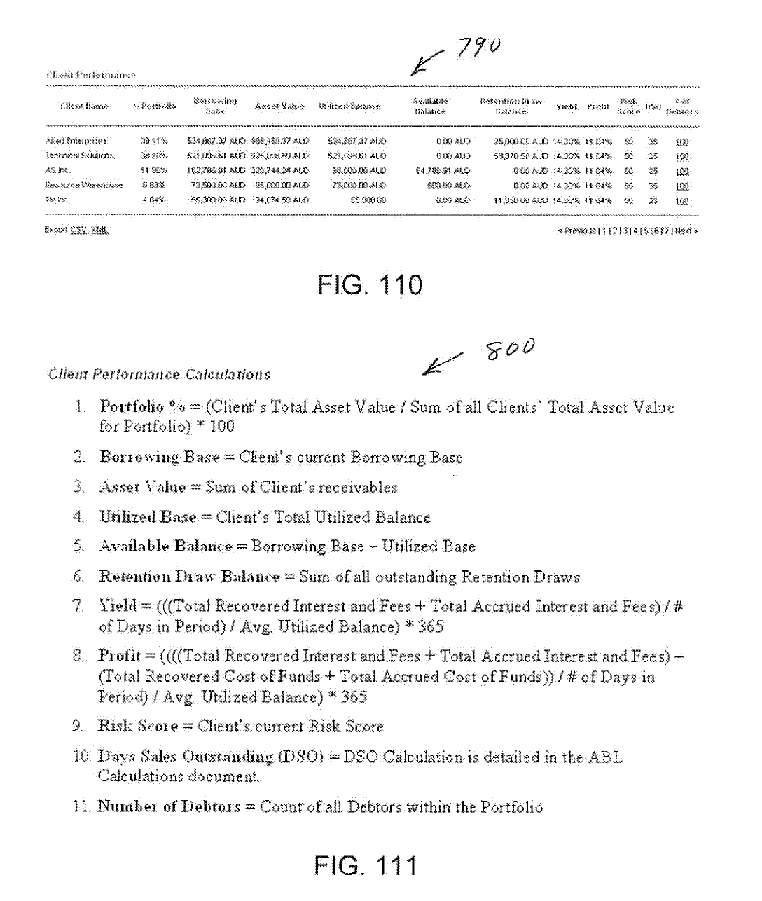

FIG. 110 is an screen image illustrating an exemplary client performance query 790. The client performance query 790 displays the concentration percentage, total assets, borrowing base, utilized balance, available balance, retention draw balance, yield, profit, risk score, DSO and number of debtors for each client 102 in the portfolio. By default, the results are sorted by the highest portfolio concentration percent to the least.

FIG. 111 is an exemplary depiction of client performance calculations 800. The fields displayed in the client performance query 790 and their associated formulas are shown. The user may select on the number of debtors to view the list of debtors for that client.

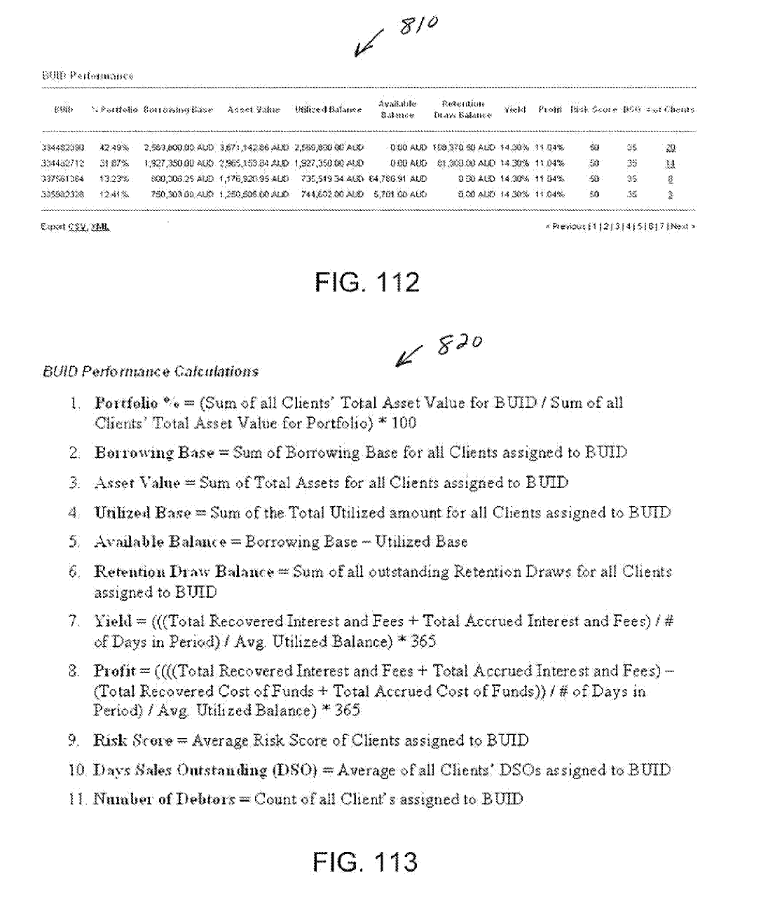

FIG. 112 is an screen image illustrating an exemplary BUID performance query 810. The BUID performance query 810 displays the concentration percentage, total assets, borrowing base, utilized balance, available balance, retention draw balance, yield, profit, risk score, DSO and number of clients.

FIG. 113 is an exemplary depiction of the BUID performance query performance calculations 820. The fields displayed in the BUID performance query 810 and their associated formulas are shown. The user selects the BUID sort. By default, the results are sorted by the highest portfolio concentration percent to the least. The user can select on the number of clients to view the list of client names associated with that BUID.

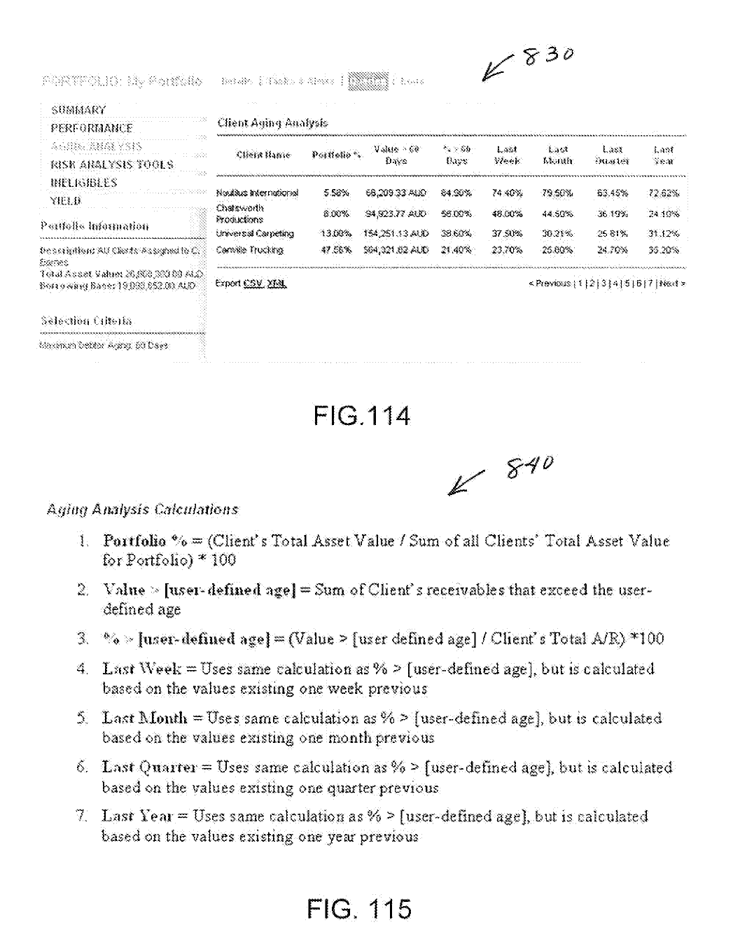

FIG. 114 is an screen image illustrating an exemplary aging analysis query 830. The aging analysis query is accessed from the client portfolio query page 760. The client aging analysis 830 provides the user with a query displaying all clients 102 with total debtor aging greater than the user-defined age. The query displays the value and percentage of invoices greater than the user-defined age, as well as related trend information. The default sort of the query is by the greatest percent of assets exceeding the user-defined age. Where the ledger recourse type option is set to “Month Received”, portfolio aging calculations are triggered based on the last day of the month of the invoice date.

FIG. 115 is an exemplary depiction of the aging analysis query calculations 840. The fields displayed in the aging analysis query 830 and their associated formulas are shown. This example is based on a user-defined setting of 60 days. The user-defined value is reflected in the selection criteria, as well as applicable column headers for the query.

The risk analysis tools queries are accessed from the client portfolio query page 760. The risk analysis tools queries consist of (1) risk score trend query, (2) detailed client risk analysis, (3) client concentration, (4) days sales outstanding, (5) collection trend, (6) payment trend, (7) utilized facility trend, (8) sales trend, (9) dilution trend, (10) credit note trend, (11) recourse trend, and (12) borrowing base trend. Where possible, each risk analysis query displays an overall record for the portfolio, in addition to the individual client records. This allows the financial institution 108 to view how the portfolio is performing overall. The financial institution 108 is also able to compare clients 102 against each other and against the overall portfolio values. The overall portfolio record is based on sums or averages of the individual client records, as appropriate, and are detailed specifically for each query.

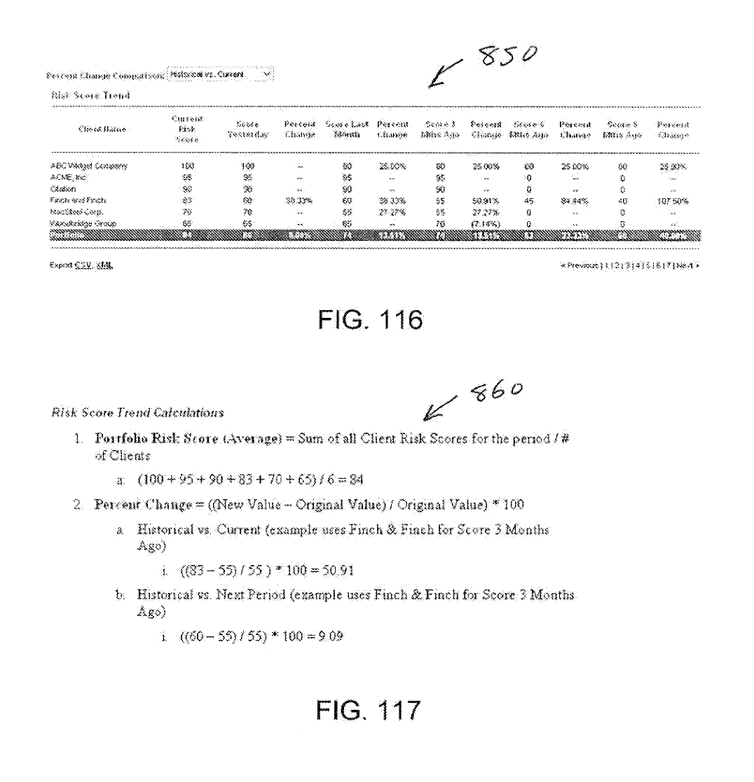

FIG. 116 is an screen image illustrating a risk score trend query 850. The risk score trend query 850 presents a historical view over, for example, 12 months of the clients' risk scores and compares the percentage change over that period of time.

FIG. 117 is an exemplary depiction of the risk score trend query calculations 860 The fields displayed in the risk score trend query 850, their associated formulas, and example results are shown. The user has options for viewing the percentage change by (1) calculating the percentage change between historical score and current risk score, and (2) calculating the percentage change between historical period risk score and next period risk score. This option is set as a default in the portfolio user-defined settings, but the user has the option of switching between views within the query results page.

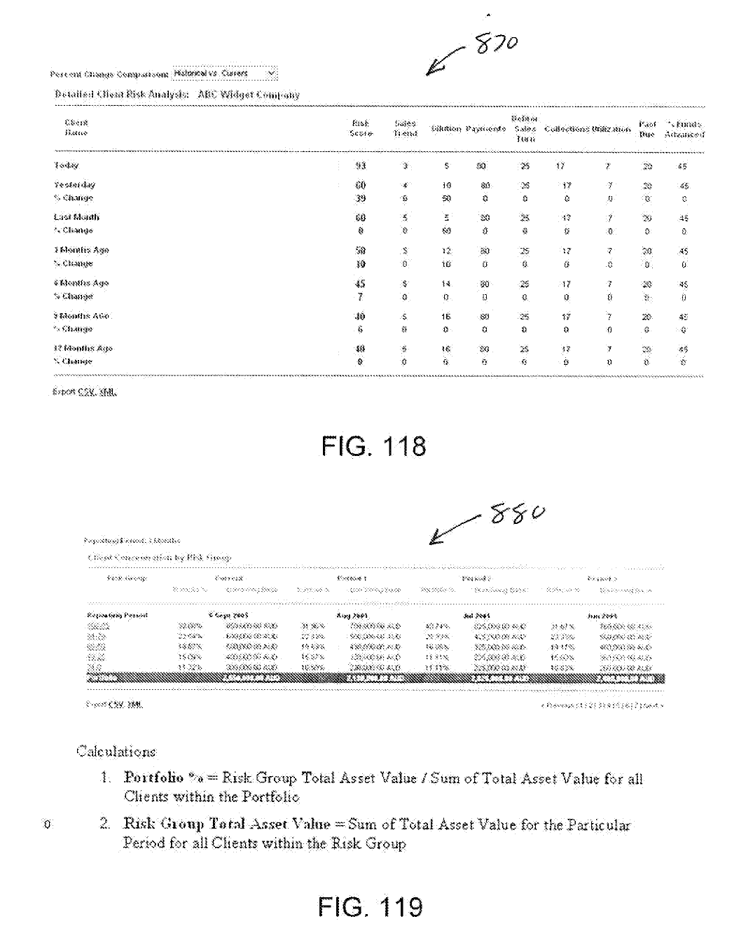

FIG. 118 is a screen image illustrating an exemplary detailed client risk analysis query 870. The detailed client risk analysis query 870 is accessed by selecting a client from the client risk score trend, as in the risk score rend query 850, for example. The information displayed is similar to that of the client risk score trend, but instead displays details of each risk category used to calculate the client's risk score.

The periods displayed are typically current, yesterday, last month, 3 months ago, 6 months ago, 9 months ago, and 12 months ago. The user has options for viewing the percentage change by (1) calculating the percentage change between historical score and current risk score and (2) calculating the percentage change between historical period risk score and next period risk score. This option is set as a default in the portfolio user-defined settings, using the same option set for the client risk score trend, but the user also has the option of switching between views within the query results page. The formulas are the same as those used for the detailed client risk analysis query 870.

FIG. 119 is an exemplary depiction of the client concentration by risk group query 880. The fields displayed in the concentration by risk group query 880 and their associated formulas are also shown. The client concentration by risk group query 880 displays the concentration of risk within each risk grouping, as defined in the portfolio settings, along with a comparison of the result to historical values. Information that is displayed per risk group includes risk group, portfolio percentage, and total asset value. The risk group is a hyperlink, and if selected, presents the user with the same data elements for each client that is included in the selected risk group. The user has capability to define a period for comparison with the current value against (weeks or months) and the number of periods.

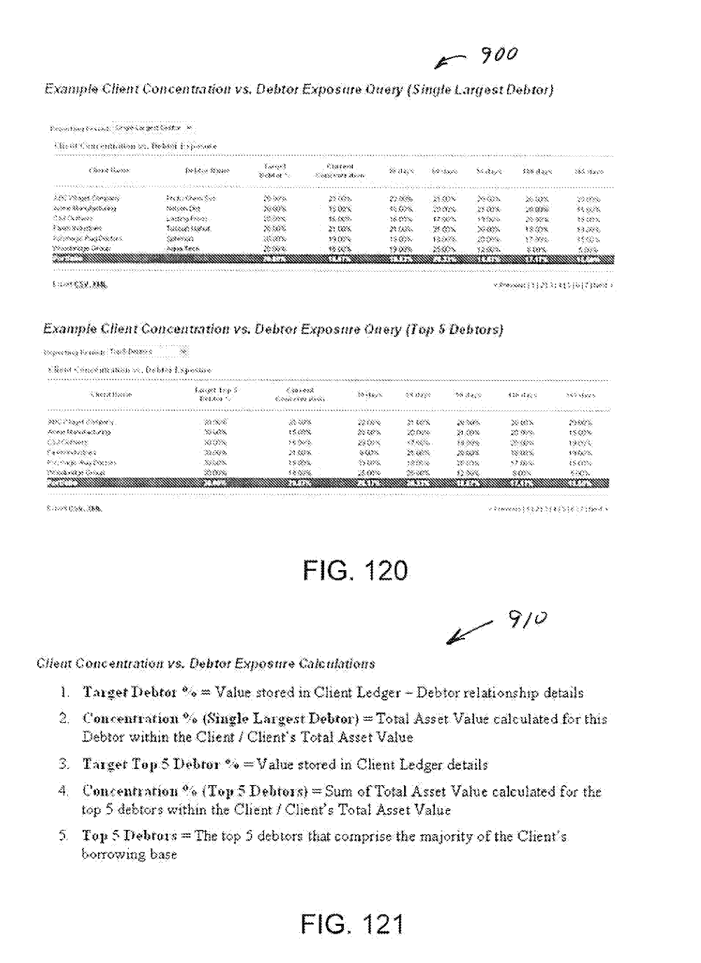

FIG. 120 is a screen image illustrating an exemplary client concentration vs. debtor exposure 900. The example shows results for the single largest debtor and top 5 debtors. The client concentration vs. debtor exposure query allows the user to view key debtor concentration for each client in the portfolio, as well as comparison to historical values. The query also displays portfolio averages based on the detailed information per client. The user has capability to select between the following views: (1) largest debtor per client compares the target debtor percentage for the debtor to the actual concentration in the debtor over 30, 60, 90, 180 and 365 days, and (2) top 5 debtors per client compares the target top 5 debtor percentage to the actual concentration in the top 5 debtors per client over 30, 60, 90, 180 and 365 days. The user sets the default view in the portfolio settings but also has the capability to switch between views while reviewing the query results. The calculation for both reports is identical.

FIG. 121 is an exemplary depiction of the client concentration vs. debtor exposure calculations 910. The fields displayed in the client concentrations vs. debtor exposure 900 and their associated formulas are shown.

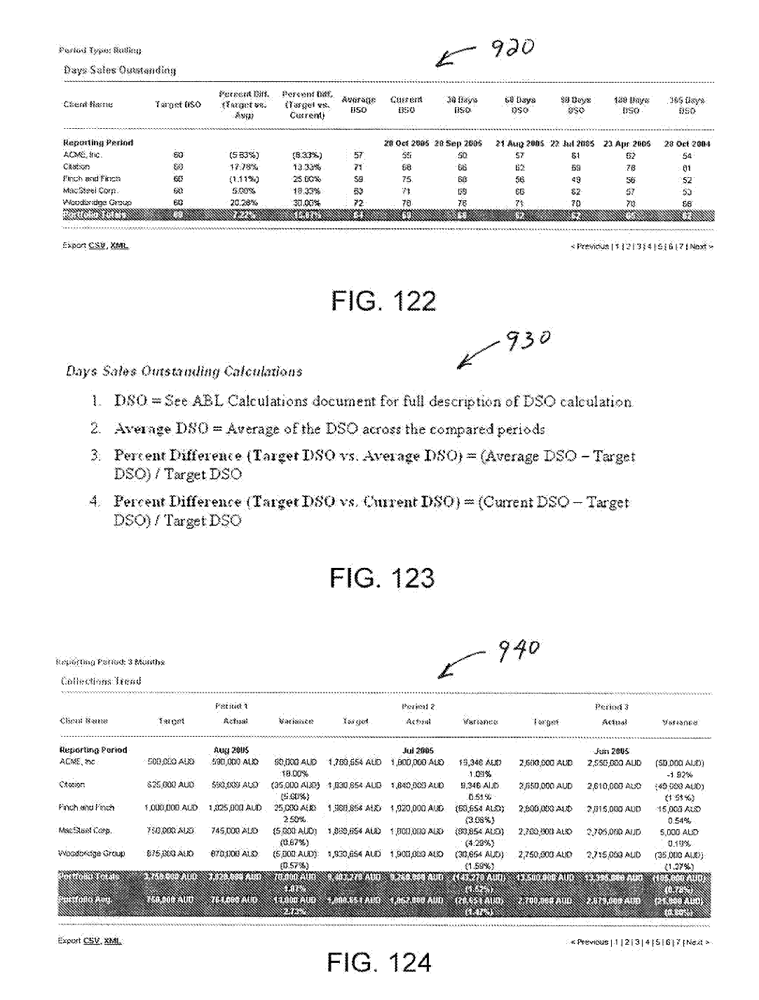

FIG. 122 is a screen image illustrating an exemplary days sales outstanding query 920. The days sales outstanding (DSO) query 920 displays the following information per client: (1) target DSO (ledger-level setting), (2) percent difference (target DSO vs. Avg. DSO), (3) percent difference (target DSO vs. current DSO), (4) average DSO (average based on reported periods). (5) current DSO, and (6) historical DSO values. The user has the option to select whether the DSO is calculated based on fixed or rolling DSO. (1) Fixed=DSO is calculated at the end of each month and displays the current DSO (DSO calculated at end of last month), 1 Month DSO, 2 months DSO, 3months DSO, 6 months DSO, 1 Year DSO. (2) Rolling=DSO is calculated for the last 30 days, etc., and displays the current DSO (based on last 30 days), 30 days DSO (DSO as of 30 days ago), 60 days DSO, 90 days DSO, 180 days DSO, and 365 days DSO.

FIG. 123 is an exemplary depiction of the days sales outstanding query calculations 930. The fields displayed in the days sales outstanding query 920 and their associated formulas are shown.

FIG. 124 is a screen image illustrating an exemplary collection trend query 940. The collection trend query 940 identifies actual collection performance across the ledger based on a comparison to the target collections amount. The collection trend query 940 displays the target collections amount, actual collections, and the variance between the estimated and actual, as well as historical trends over time. This information is displayed for each client 102 within the portfolio 722 with a variance greater than the user-defined amount. The user also has the capability to configure the number of months to display.

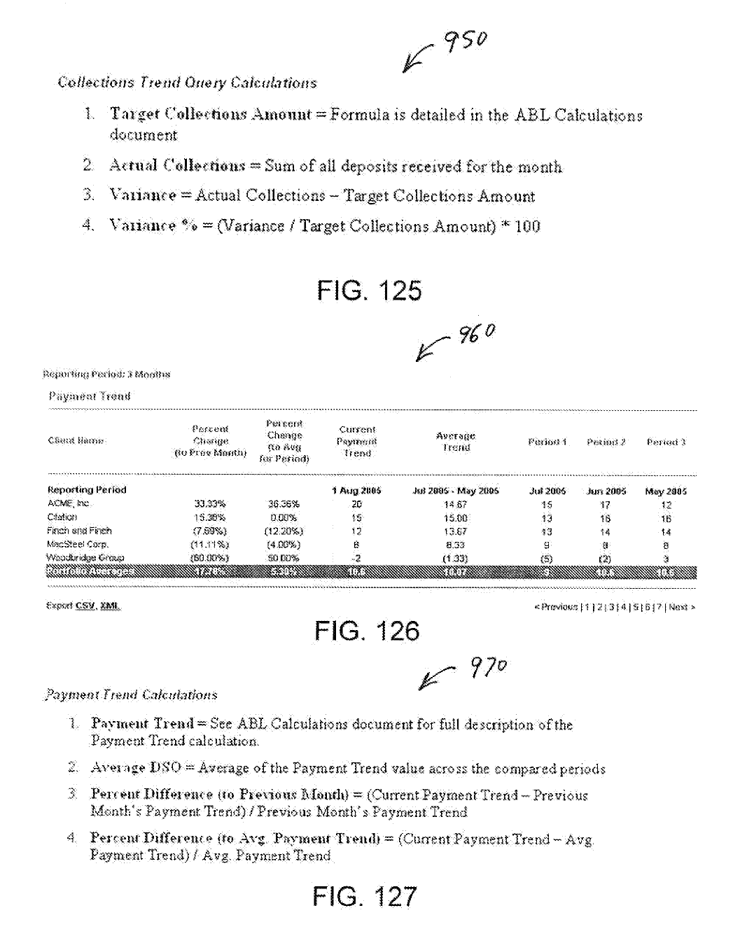

FIG. 125 is an exemplary depiction of the collection trend query calculations 950. The fields displayed on the collection trend query 940 and their associated formulas are shown.

FIG. 126 is a screen image illustrating an exemplary payment trend query 960. The payment trend query 960 displays the current payment trend, as well as the payment trend for the number of periods selected by the user. It also displays the percentage change based on (1) the current payment trend compared to the previous month's payment trend, and (2) the current payment trend compared to the average payment trend for the number of periods under comparison. The payment trend value shows the average time the client's invoices are paid relative to terms. For example, a payment trend of 15 indicates that the client's invoices are regularly paid 15 days past terms. A payment trend of −2 indicates that the client's invoices are regularly paid 2 days prior to terms. The user has the capability to configure the type and number of periods to display. Default sort is by greatest percentage change to least.

FIG. 127 is an exemplary depiction of the payment trend query calculations 970. The fields displayed in the payment trend query 960 and their associated formulas are shown.

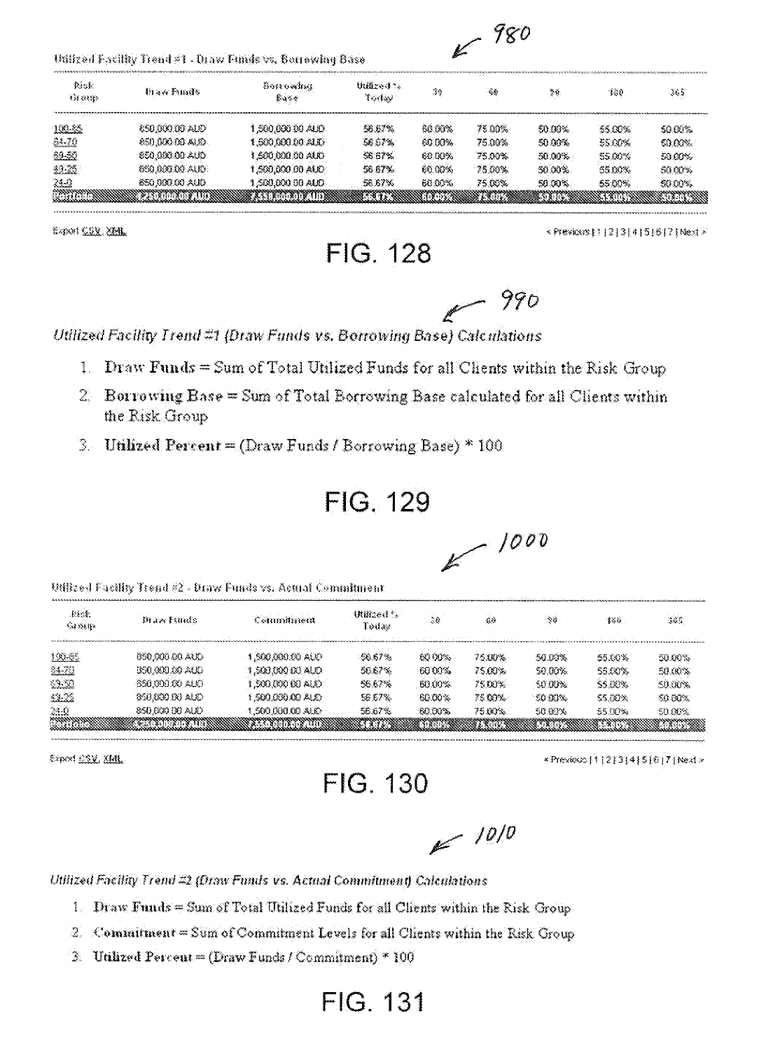

FIG. 128 is a screen image illustrating an exemplary utilized facility trend #1 (draw funds vs. borrowing base) query 980. The utilized facility trend #1 (draw funds vs. borrowing base) query 980 displays the amount and percentage of funds utilized in comparison with the total borrowing base. The data is summarized per risk group (as defined in the portfolio settings). The user may select on any risk group to display the clients that make up that risk group, along with the related detail per client. Default sort is by greatest current utilization percent to least.

FIG. 129 is an exemplary depiction of the utilized facility trend #1 (draw funds vs. borrowing base) query calculations 990. The fields displayed in the utilized facility trend #1 (draw funds vs. borrowing base) query 980 and their associated formulas are shown.

FIG. 130 is a screen image illustrating an exemplary utilized facility trend #2 (draw funds vs. actual commitment) query 1000. The utilized facility trend #2 (draw funds vs. actual commitment) query 1000 displays the amount and percentage of funds utilized in comparison with the actual commitment level. The commitment level is stored in the client ledger details. The data is summarized per risk group (as defined in the portfolio settings). The user may select on any risk group to display the clients that make up that risk group, along with the related detail per client. Default sort is by greatest current utilization percent to least.

FIG. 131 is an exemplary depiction of the utilized facility trend #2 (draw funds vs. actual commitment) query calculations 1010. The fields displayed in the utilized facility trend #2 (draw funds vs. actual commitment) query 1000 and their associated formulas are shown.

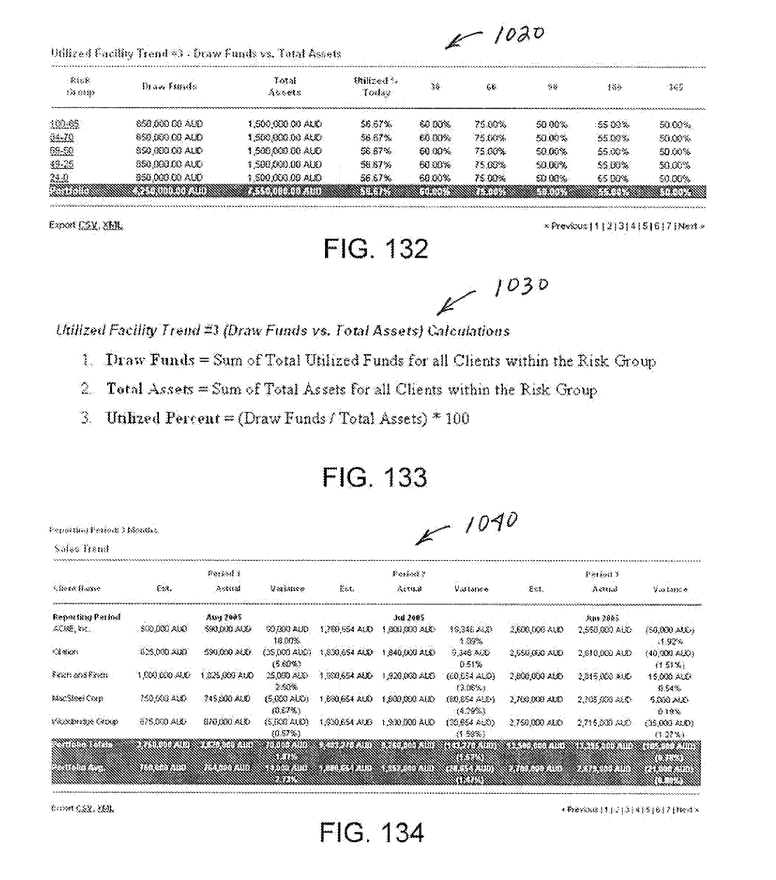

FIG. 132 is a screen image illustrating an exemplary utilized facility trend #3 (draw funds vs. total assets) query 1020. The utilized facility trend #3 (draw funds vs. total assets) query 1020 displays the amount and percentage of funds utilized in comparison with the total assets. The data is summarized per risk group (as defined in the portfolio settings). The user may select on any risk group to display the clients that make up that risk group, along with the related detail per client.

FIG. 133 is an exemplary depiction of the utilized facility trend #3 (draw funds vs. total assets) query calculations 1030. The fields displayed in the utilized facility trend #3 (draw funds vs. total assets) query 1020 and their associated formulas are shown.

FIG. 134 is a screen image illustrating an exemplary sales trend (estimated vs. actual sales) query 1040. The sales trend (estimated vs. actual sales) query 1040 displays the estimated sales, actual sales, and the variance between the estimated and actual, as well as historical trends over time. This information is displayed for each client within the portfolio with a variance greater than the user-defined amount. When comparing the variance to the user-defined value to determine whether to include the client in the query, the absolute value of the variance is used. In other words, a variance of −1,500 is equal to a variance of 1,500. The user also has the capability to configure the number of months to display. Default sort is from greatest variance to least.

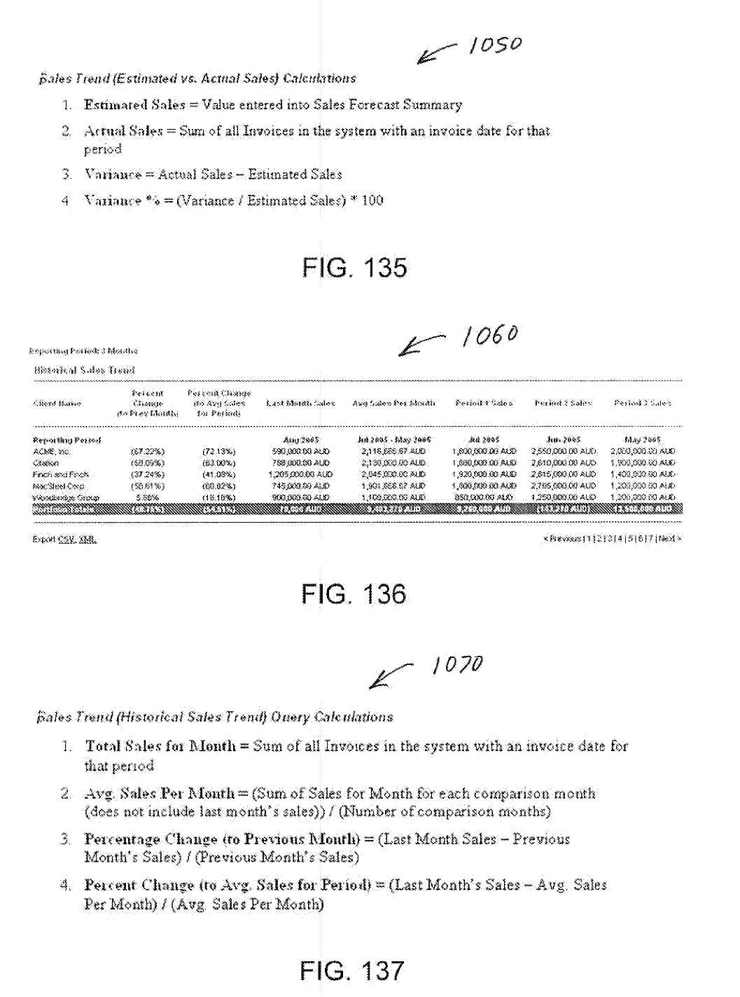

FIG. 135 is an exemplary depiction of the sales trend (estimated vs. actual sales) query calculations 1050. The fields displayed in the sales trend (estimated vs. actual sales) query 1040 and their associated formulas are shown. Estimated sales figures are entered using the sales forecast direct entry screen. This query is typically available only for clients that are providing this data.

FIG. 136 is a screen image illustrating an exemplary sales trend (historical sales trend) query 1060. The sales trend (historical sales trend) query 1060 displays the total sales for the last month, as well as the total sales per month for the number of months selected by the user. It also displays the percentage change based on (1) the last month sales compared to the previous month's sales, and (2) the last month sales compared to the average sales per month for the selected months to compare. The user has the capability to configure the number of months to display. Default sort is from greatest percentage change to least.

FIG. 137 is an exemplary depiction of the sales trend (historical sales trend) query calculations 1070. The fields displayed in the sales trend (historical sales trend) query 1060 and their associated formulas are shown.

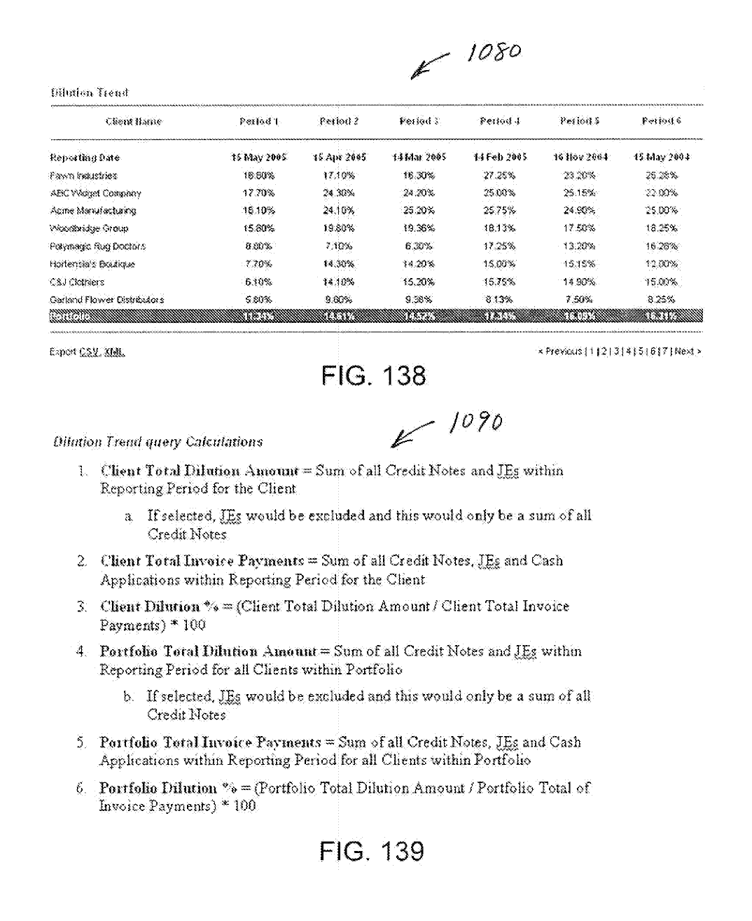

FIG. 138 is a screen image illustrating an exemplary dilution trend query 1080. The dilution trend query 1080 uses credit notes and journal entries to measure the amount of dilution for a client's receivables over a period of time. The query displays the percentage of dilutions for each client within the portfolio, broken out by periods. The user has the capability to select 5 reporting periods; the default reporting periods are typically the last 30 days, 60 days, 90 days, 180 days and 365 days. The financial institution 108 also has the capability to exclude journal entries from the dilution calculation.

FIG. 139 is an exemplary depiction of the dilution trend query calculations 1090. The fields displayed in the dilution trend query 1080 and their associated formulas are shown.

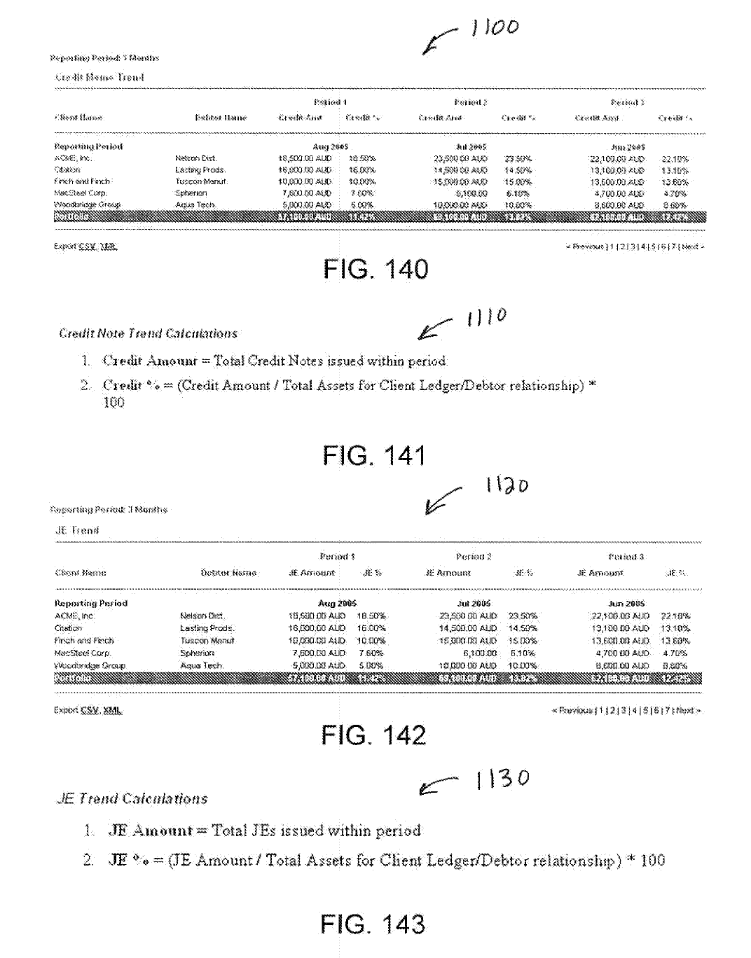

FIG. 140 is a screen image illustrating an exemplary credit note trend query 1100. The credit note trend query 1100 displays the value and percentage of credit notes being applied. This information is displayed as a list of clients 102 and their debtors 120 with the highest percentage and value of credit notes. The user defines the number of debtors 120 to display as well as the number of weeks or months to display. Default sort is from highest percentage and value to lowest percentage and value. The user also has capability to select a client/debtor summary record to view detailed information on the credit notes involved, including the age in days between when the invoice was created and the credit note was issued. This query can typically be performed only against ABL—detail ledgers. ABL—summary ledgers do not typically have enough data regarding credit notes.

FIG. 141 is an exemplary depiction of the credit note trend query calculations 1110. The fields displayed in the credit note trend query 1100 and their associated formulas are shown.

FIG. 142 is a screen image illustrating an exemplary journal entry trend query 1120. The journal entry trend query 1120 displays the value and percentage of journal entries being applied. This information is displayed as a list of clients 102 and their debtors 120 with the highest percentage and value of journal entries. The user defines the number of debtors to display as well as the number of weeks or months to display. Default sort is from highest percentage and value to lowest percentage and value. The user also can to select on a client/debtor summary record to view detailed information on the journal entries involved, including the age in days between when the invoice was created and the journal entry was issued. This query can typically be performed only against ABL—detail ledgers. ABL—summary ledgers typically do not have enough data regarding journal entries.

FIG. 143 is an exemplary depiction of the journal entry trend query calculations 1130. The fields displayed in the journal entry trend query 1120 and their associated formulas are shown.

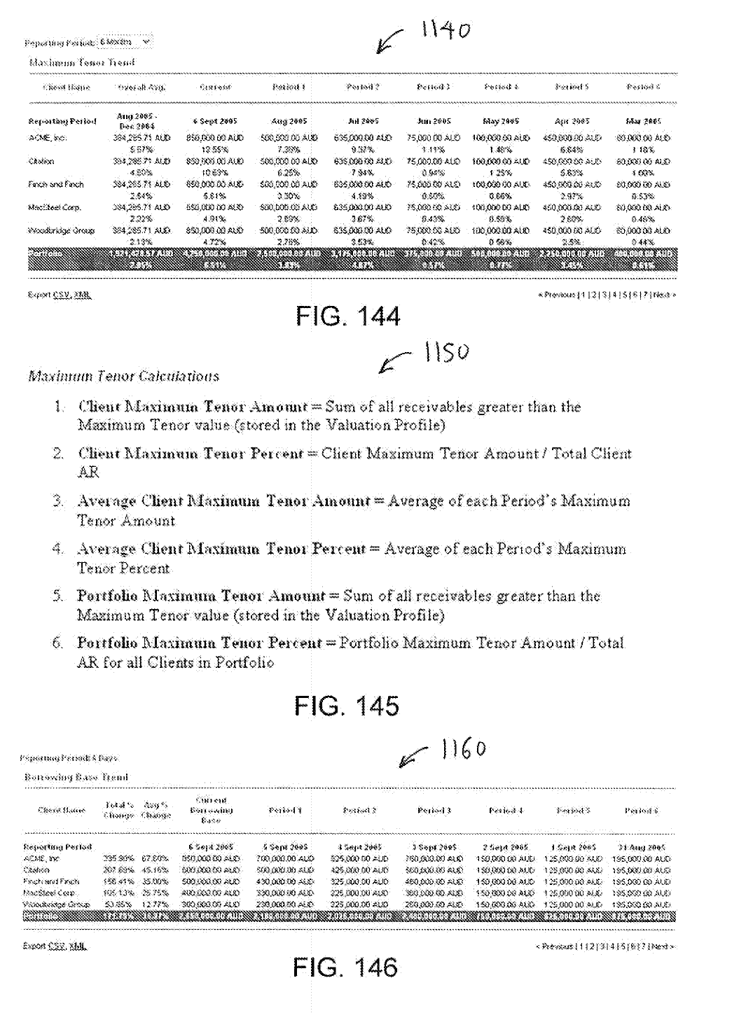

FIG. 144 is a screen image illustrating an exemplary maximum tenor trend query 1140. The maximum tenor trend query 1140 displays the currency amount and percentage of accounts receivable that exceeds the maximum tenor. This is displayed per client by month for a specified period. For example, if a client's maximum tenor is 90 days, and they have total accounts receivable of 100,000K with 10,000K that exceeds 90 days, then the amount over is 10,000K and the percent over is 10%. The financial institution 108 is able to select from the following period options: 3 months, 6 months, 9 months, and 12 months.

FIG. 145 is an exemplary depiction of the maximum tenor trend query calculations 1150. The fields displayed in the maximum tenor trend query 1140 and their associated formulas are shown.

FIG. 146 is a screen image illustrating an exemplary borrowing base trend query 1160. The borrowing base trend query 1160 is used to identify unusual increases in borrowing base calculations. The client's current borrowing base is compared to historical values to determine the average percentage increase over time. The user defines the period to compare against (days or weeks) and the number of periods. The user can also compare the individual client values to the total portfolio values. The default sort will be on clients 102 with the highest percentage increase over the period to clients 102 with the lowest percentage increase.

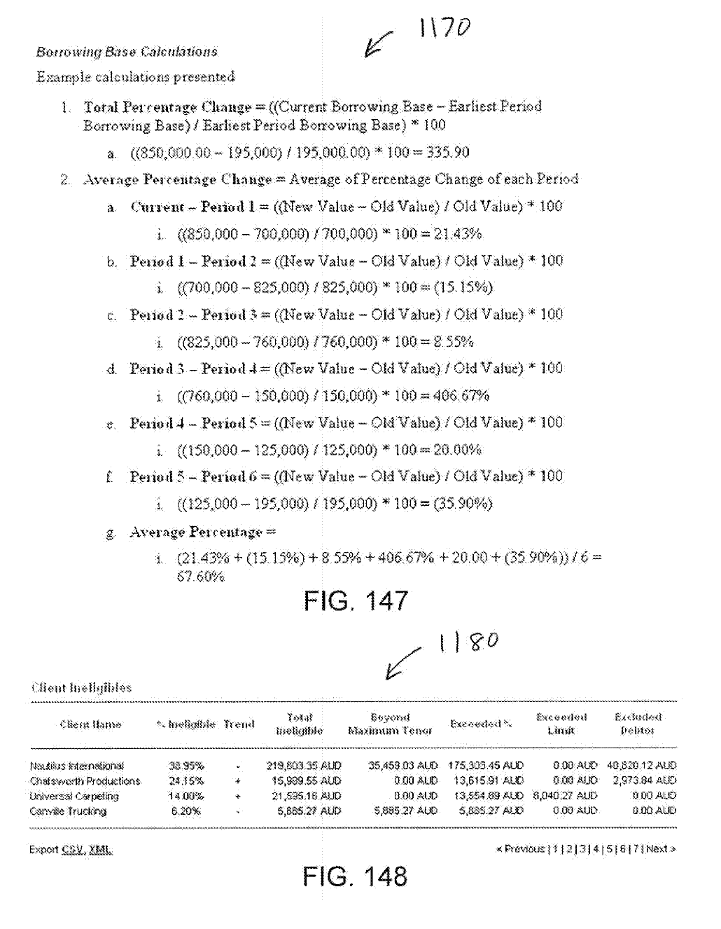

FIG. 147 is an exemplary depiction of the borrowing base trend query calculations 1170. The fields displayed in the borrowing base trend query 1160 and their associated formulas are shown.

FIG. 148 is a screen image illustrating an exemplary ineligibles query 1180. The ineligibles queries 1180 are accessed from the client portfolio query page 760. The ineligibles query 1180 displays the amount of the clients' outstanding receivables that are not eligible for funding due to (1) not being part of the borrowing base altogether, (2) beyond maximum recourse, (3) excluded by percentage or limit, and (4) inactive (excluded) debtor. The ineligibles query 1180 displays the percentage ineligible, the trend, total value of ineligible receivables, and the value of ineligibles broken out by category. Individual client ineligibles by debtor 120 is displayed in the client detail portion of the platform. The accounts receivable may be ineligible for multiple reasons; therefore, the ineligible category breakouts do not necessarily add up to the total ineligible value.

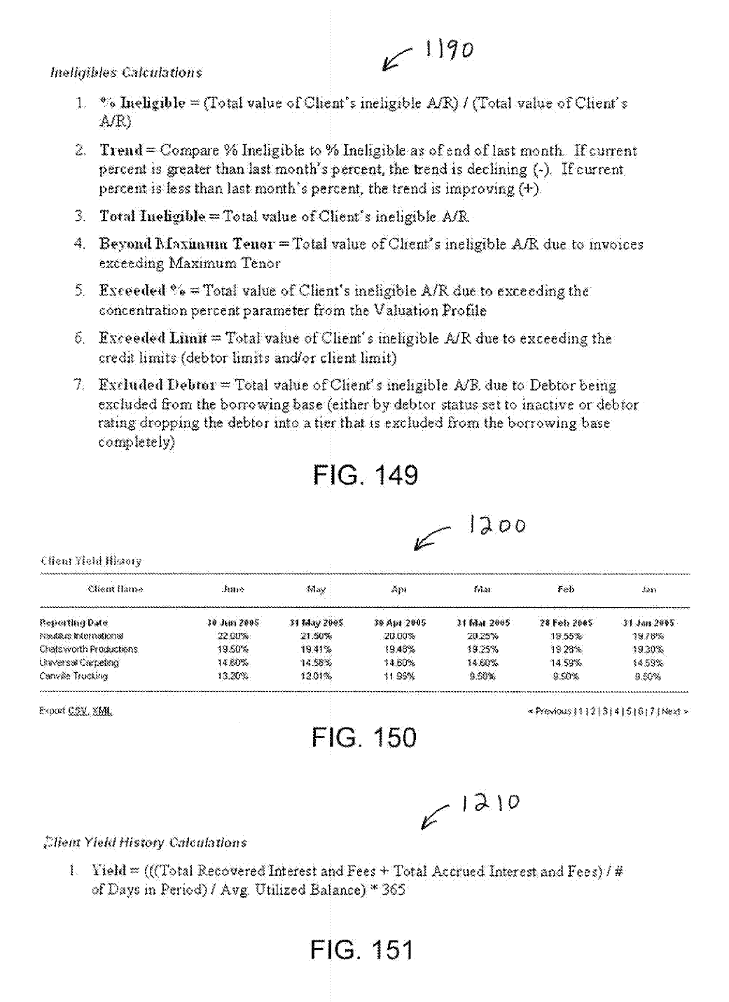

FIG. 149 is an exemplary depiction of the ineligibles query calculation 1190. The fields displayed in the ineligibles query 1180 and their associated formulas are shown.

The yield queries are accessed from the client portfolio query page 760. The following queries are available within the yield query tab (1) client yield history (2) client yield detail (3) client revenue detail.

FIG. 150 is a screen image illustrating an exemplary client yield history query 1200. The client yield history query 1200 displays historical yield figures for each client 102 within the portfolio 722. The historical yield is broken out by month for the past 6 months. Default sort is from the greatest current yield to the least.

FIG. 151 is an exemplary depiction of the client yield history query calculations 1210. The fields displayed in the ineligibles query 1200 and their associated formulas are shown.

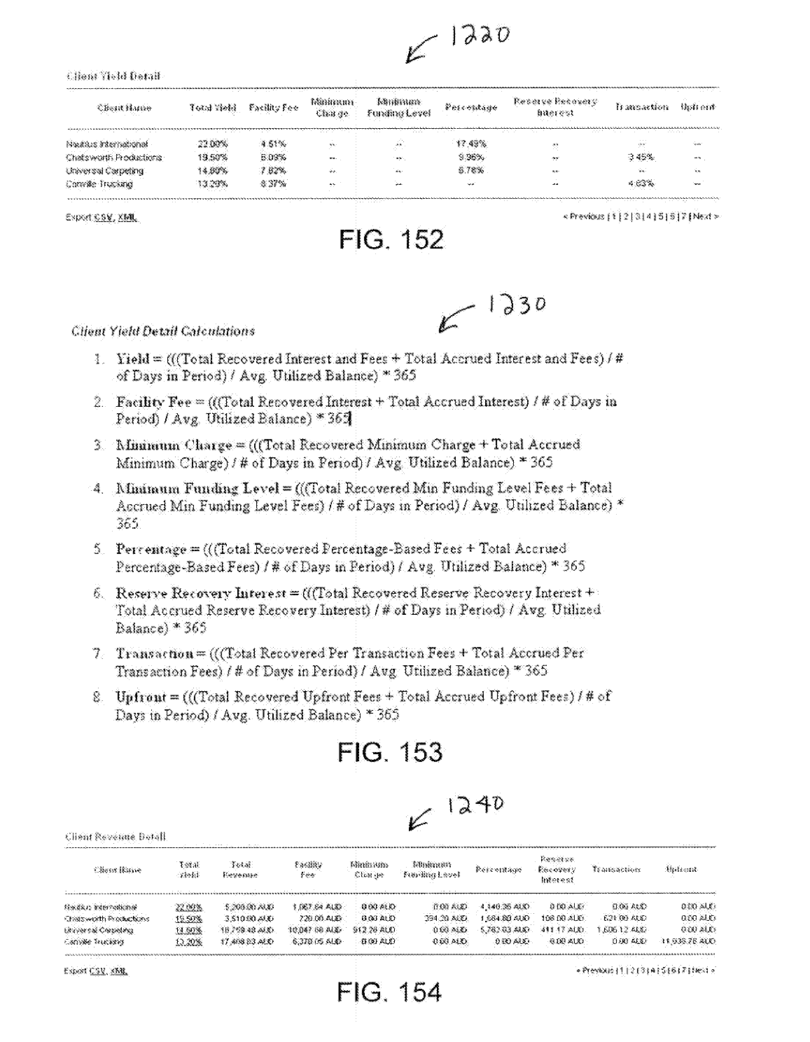

FIG. 152 is a screen image illustrating an exemplary client yield detail query 1220. The client yield detail query 1220 provides the user with a perspective of how the portfolio makes money and identifies yield alternatives for other clients 102 in the portfolio 722. Detailed yield information is displayed for each client 102 within the portfolio 722, including total yield and yield based on individual fee components. (1) Each fee type is broken out into its own category. (2) The sum of the yield figures in the individual categories is equal the total yield value. The date range for the query is set in the portfolio settings. Default sort on the results are from highest overall yield. The total yield value is a hyperlink that, when selected, allows the user to view the pricing profiles used to determine the interest and fees.

FIG. 153 is an exemplary depiction of the client yield detail query calculations 1230. The fields displayed in the client yield detail query 1220 and their associated formulas are shown.

FIG. 154 is a screen image illustrating an exemplary client revenue detail query 1240. The client revenue detail query 1240 displays the total revenue earned based on different fee types to provide a perspective of portfolio earnings. This is done by displaying the following detailed information for each client 102 within the portfolio 722: total yield, total revenue, total revenue earned based on individual fee components. (1) Each fee type is broken out into its own category. (2) The sum of the revenue figures in the individual categories equals the total revenue value. The date range for the query is set in the portfolio settings. Default sort on the results is from highest overall revenue. The total yield value is a hyperlink that, when selected, allows the user to view the pricing profiles used to determine the interest and fees.

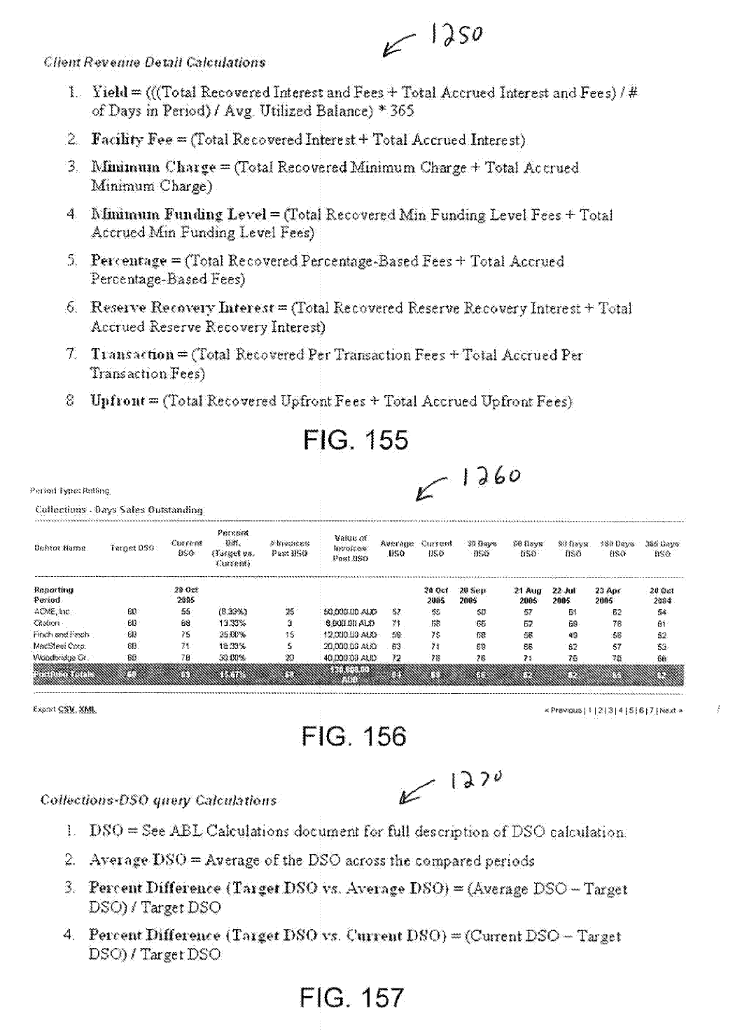

FIG. 155 is an exemplary depiction of the client revenue detail query calculations 1250. The fields displayed in the client revenue detail query 1240 and their associated formulas are shown.

FIG. 156 is a screen image illustrating an exemplary collections-DSO query 1260.

Users access the debtor portfolio details page 750 by selecting a debtor portfolio 142 from the list of portfolios available on the portfolio list page 714. The portfolio details page 750 shows the attributes and configuration of the selected portfolio 722. From the debtor portfolio details page 750, users can perform the following: (1) view and modify portfolio information, 2) view a list of debtors for that portfolio, (3) view a list of users for that portfolio, (4) view and modify portfolio settings, and (5) view, modify and run queries. The queries tab on the debtor portfolio details page 750 provides the user with access to the collections-DSO, concentration, dilution, and aging analysis queries.

The “Collections-DSO” page is displayed as the default screen when accessing queries tab. The debtor collections-DSO query 1260 displays the following information per debtor: target DSO, current DSO, percent difference (target DSO vs. current DSO), percent difference (target DSO vs. avg, DSO), number of invoices past the DSO, amount of invoices past the DSO, average DSO (average based on reported periods), historical DSO values. The user has the option to select whether the DSO is calculated based on a fixed or rolling DSO. (1) For fixed DSO, the DSO is calculated at the end of each month and typically displays current DSO (DSO calculated at end of last month), 1 Month DSO, 2 months DSO, 3 months DSO, 6 months DSO, 1 year DSO. (2) For rolling DSO, the DSO is calculated for the last 30 days, etc., and typically displays current DSO (based on last 30 days), 30 days DSO (DSO as of 30 days ago), 60 days DSO, 90 days DSO, 180 days DSO, and 365 days DSO.

FIG. 157 is an exemplary depiction of the collections-DSO query calculations 1270. The fields displayed in the collections-DSO query 1260 and their associated formulas are shown.

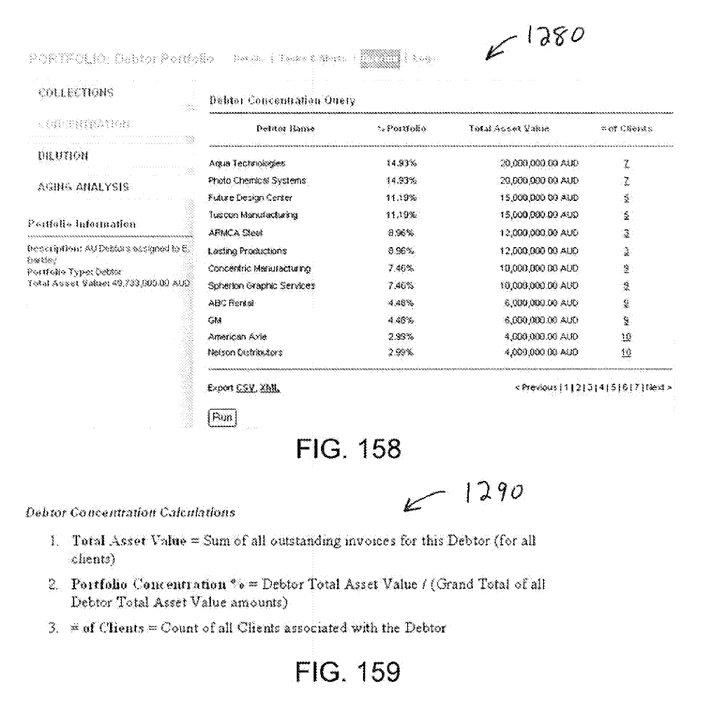

FIG. 158 is a screen image illustrating an exemplary debtor concentration query 1280. The debtor concentration query 1280 displays the percentage of total asset value relative to the total asset value of the portfolio 722 to establish a concentration percentage. The number of clients submitting the invoices is also displayed. The user can select the number of clients to view the list of clients associated with that debtor 120. Default sort is from highest portfolio concentration percentage to least.

FIG. 159 is an exemplary depiction of the debtor concentration query calculations 1290. The fields displayed in the debtor concentration query 1280 and their associated formulas are shown.

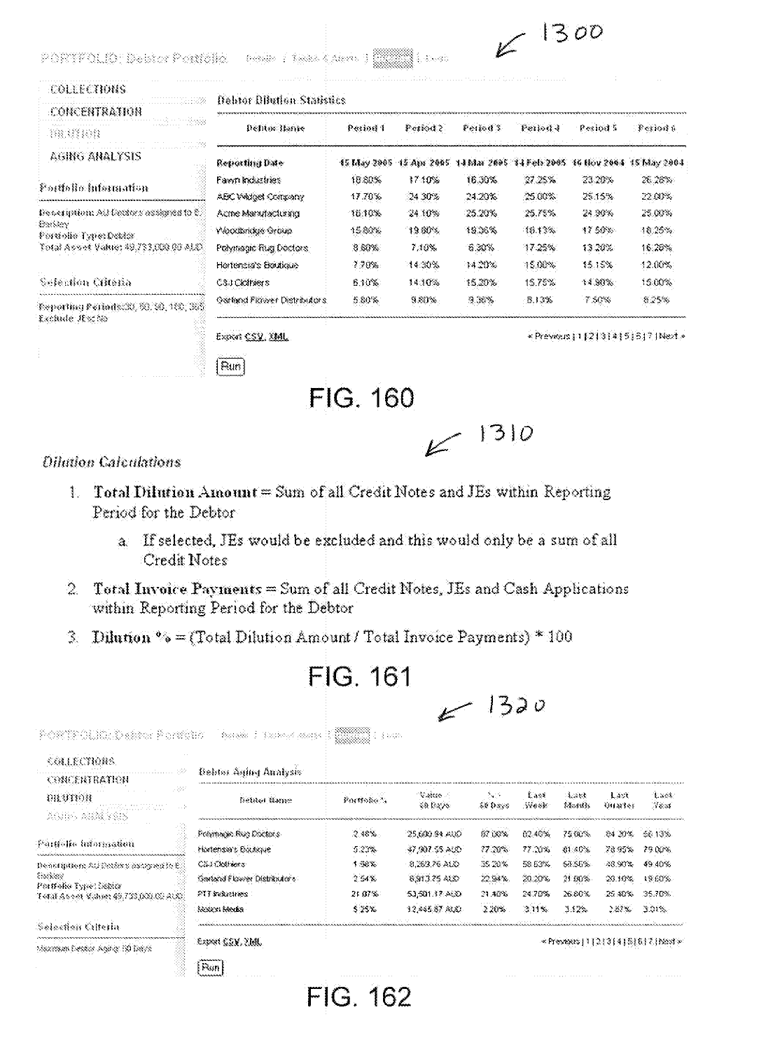

FIG. 160 is a screen image illustrating an exemplary dilution query 1300. The dilution query 1300 uses credit notes and journal entries to measure the amount of dilutions for a debtor's payables over a period of time. The dilution query 1300 displays the percentage of dilutions for each debtor 120 within the portfolio 722, broken out by periods. The user has the capability to select 5 reporting periods; the default reporting periods are typically the last 30 days, 60 days, 90 days, 180 days and 365 days. The financial institution 108 also has the option to exclude journal entries from the dilution calculation.

FIG. 161 is an exemplary depiction of the dilution query calculations 1310. The fields displayed in the dilution query 1300 and their associated formulas are shown.

FIG. 162 is a screen image illustrating an exemplary debtor aging analysis query 1320. The example is based on a user-defined setting of 60 days. The aging analysis query 1320 provides the user with a query displaying an aging analysis of each debtor 120 with total debtor aging greater than the user-defined age. The aging analysis query 1320 displays the value and percentage of invoices greater than the user-defined age, as well as related trend information. The query default sort is from the greatest percent of assets exceeding the user-defined age to the least percent. The user-defined value is reflected in the selection criteria, as well as applicable column headers for the aging analysis query 1320 results.

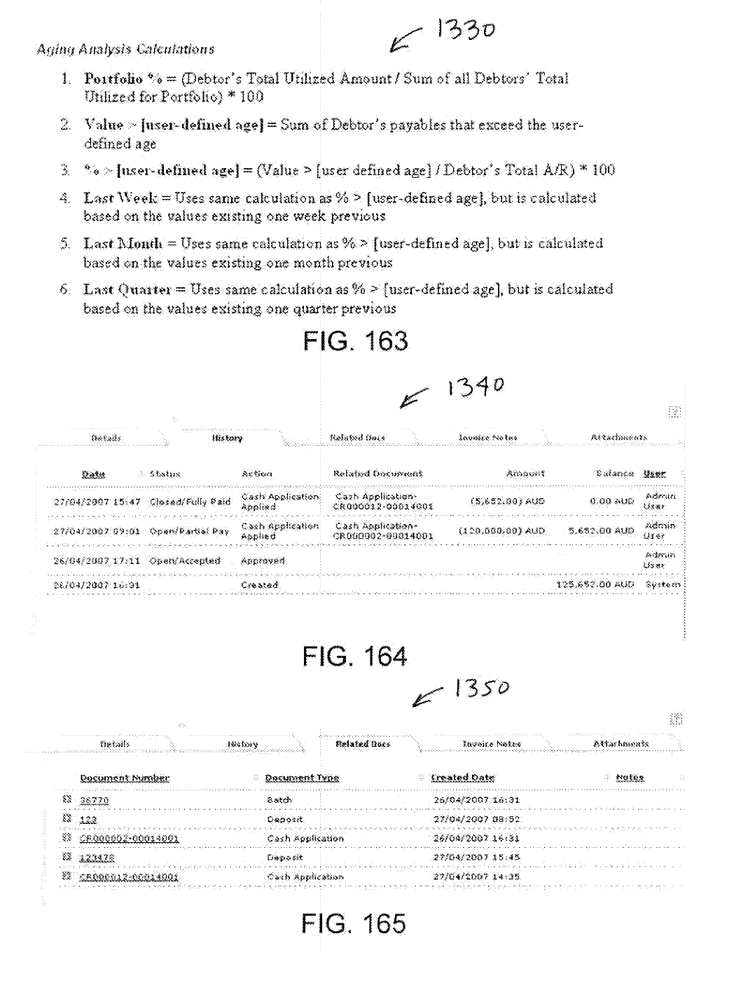

FIG. 163 is an exemplary depiction of the debtor aging analysis query calculations 1330. The fields displayed in the debtor aging analysis query 1320 and their associated formulas are shown.

Electronic Document Descriptions

Electronic documents (eDocuments) are important building blocks of the ABL application. They provide the capability for system users to view document details, document history, and link to related documents. The system has two primary users (clients 102 and financial institutions 108) and the view that each user sees may differ depending upon the applicable data for that user type. The ABL eDocuments are working documents similar to the paper documents used by the client 102 and the financial institution 108. In addition they provide extended features beyond those capable with paper documents. These enhanced features include (1) user friendly look and feel, (2) history of important of events that have occurred in relation to the document, (3) hyperlink capability to related documents, (4) attachments, (5) notes, and (6) event triggers. The features of the eDocument enable the user to drill into the application and work directly with the documents themselves. For example, a user might want to know which check an invoice was paid on, or why the invoice amount was reduced, or even change the status of the invoice. Because eDocuments have a consistent look and feel, system users can intuitively work with any eDocument type.

FIG. 164 is a screen image illustrating an exemplary invoice history tab 1340. The history tab is typically available on all eDocuments. Viewing the history tab shows a list of events that have occurred for that document. Typical history fields are: date of the event, status, action, related document, amount, balance and user. The number of fields can vary depending upon the document type. The date field contains the date and time of the event. The status is the status of the invoice. In the example shown in FIG. 164, the invoice has gone through three status changes (open accepted, open partial pay, and closed fully paid). The action column shows the events that changed the invoice status (approved, cash application applied). The related document shows the number of the document related to the action. In this instance, there were two cash applications 236. The amount column shows the amount of each cash application 236. The balance column shows the remaining balance after the cash application 236 was applied. Finally, the user column shows the user performing this action, where user name is “System” the action was performed by the system.

FIG. 165 is a screen image illustrating an exemplary related documents tab 1350. The related documents tab 1350 is typically available on all eDocuments. For those instances where a history tab event has occurred, there may have been a related document. An example of a related document occurs for a cash application 236 against a deposit 258. The related documents tab has the following fields: document number, document type, created date, and notes. The document number column provides a hyperlink to the related document. The hyperlink is provide for viewing the related eDocuments tabs as well as linking to another eDocument from that document. The document type column signifies the type of document associated with the document number. The created date column provides the date the related document was created. Notes may be available when events occur for which a note is generated.

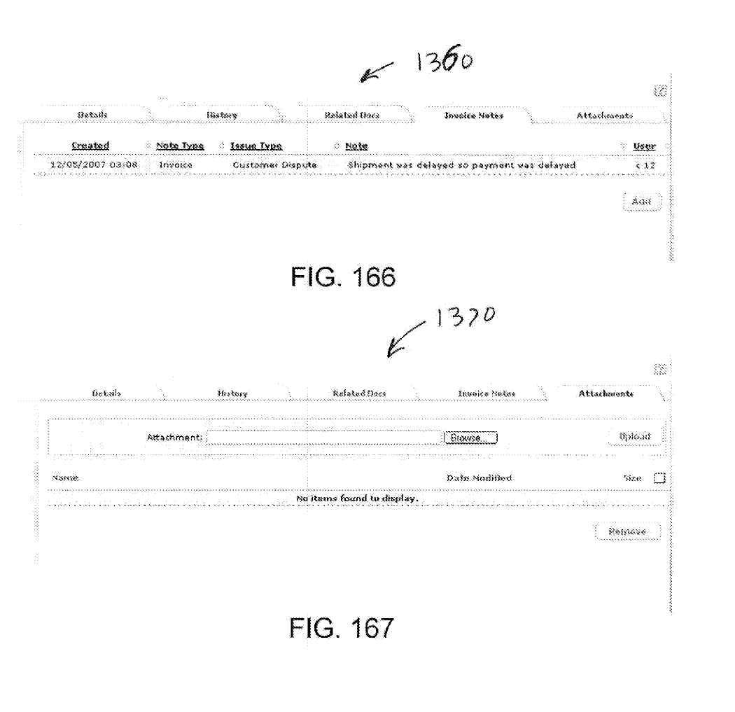

FIG. 166 is a screen image illustrating an exemplary invoice notes tab 1360. The invoice notes tab 1360 is typically available only on the invoice. The invoice notes tab 1360 enables the user to enter a note about the invoice. The note is typically available to any user having access to view the invoice. For example, a user might want to add a note stating why the invoice was canceled. The notes tab has the following fields: created, note type, issue type, note, and user. The created field contains the date and time the note was created. The note type is a selection available on a pull down menu when creating the note. The issue type is selection available on a pull down menu when creating the note. The note is the actual description of the event as logged by the user entering the note. The user is the system user ID of the person entering the note.

FIG. 167 is a screen image illustrating an exemplary attachments tab 1370. The attachment tab is typically available on most eDocuments. The attachments tab enables the user to enter one or more attachments with the eDocument. In the case of the invoice, users might need to attach supporting documents such as a copy of the invoice. Most standard document types and image types can be attached. The attachments tab 1370 has the following fields: name, date modified, size, check box, browse button, upload button, and remove button. The name column shows the file name of the attachment. The date modified column shows the last date the attachment was uploaded. The size column shows the file size of the attachment. The check box is used in conjunction with the remove button. The browse button enables the user to search their workstation or network to locate the desired attachment. The upload button works in conjunction to initiate the upload once the attachment has been located using the browse button.

Event triggers are events that can typically be performed through the eDocument user interface. Events are typically performed by selecting a button that initiates an event. For example, selecting the “Cancel” button on an invoice to change the status of the invoice to “Canceled” triggers an event. However, some eDocuments such as the aging summary and certificate of debtors allow the user to enter data that is used in other process such as the reconciliation. While some documents such as the deposit eDocument provide an interface whereby the user can search and select cash applications 236 to apply against the deposit 258.

Accordingly, it will be understood that various embodiments of the present invention described herein are preferably implemented as a special purpose or general-purpose computer including various computer hardware as discussed in greater detail below. Embodiments within the scope of the present invention also include computer-readable media for carrying or having computer-executable instructions or data structures stored thereon. Such computer-readable media can be any available media which can be accessed by a general purpose or special purpose computer, or downloadable to through wireless communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the invention may be implemented. Although not required, some of the invention are described in the general context of computer-executable instructions, such as program modules, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the invention may be practiced in network computing environments with many types of computer system configurations, including personal computers, hand-held devices, multi-processor systems, microprocessor-based or programmable consumer electronics, networked PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage device.

An exemplary system for implementing the inventions, which is not illustrated, includes a general purpose computing device in the form of a conventional computer, including a processing unit, a system memory, and a system bus that couples various system components including the system memory to the processing unit. The computer will typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, or other input devices (not shown), such as a microphone, game pad, satellite dish, scanner, or the like. These and other input devices are often connected to the processing unit through known electrical, optical, or wireless connections.

The main computer that affects many aspects of the inventions will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the invention is connected to the local network through a network interface or adapter. When used in a WAN or WLAN networking environment, the computer may include a modem, a wireless link, or other means for establishing communications over the wide area network, such as the Internet. In a networked environment, program modules depicted relative to the computer, or portions thereof, may be stored in a remote memory storage device. It will be appreciated that the network connections described or shown are exemplary and other means of establishing communications over wide area networks or the Internet may be used.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

What is claimed is:

1. In an electronic asset based lending system having a client and at least one financial institution, each of which accesses the system through a computer network interface, a method of enabling the client and the financial institution to automate reconciliation of deposit data against a borrowing base, comprising the steps of:
receiving cash application data from the client, the cash application data representing payments as received and recorded by the client;
receiving deposit data from the client and matching the deposit data to a client ledger corresponding to the client, the deposit data including a deposit amount, identifying the client and identifying a client bank account, and wherein the client ledger includes draws, cash applications and invoices;
denoting the deposit amount as unapplied cash;
determining a minimum immediate refund amount, the refund amount corresponding to non-funded cash, the non-funded cash being excluded from the borrowing base;
matching the deposit amount to cash applications and creating cash applications against the invoices, the cash application corresponding to the deposit amount; and
applying a balance remaining from the deposit amount to at least one draw and/or recovery account, wherein the balance is applied to the oldest draw and/or recovery account available.

2. The method of claim 1, wherein the matching includes criteria further comprising a day variance, a percentage variance, and an amount variance.

3. The method of claim 1, the deposit data further including details regarding specific invoices to be paid.

4. The method of claim 3, further comprising automatically matching deposit amounts to client invoices, wherein a user of the financial institution reviews and accepts automatically reconciled deposit data.

5. The method of claim 1, further comprising the financial institution receiving data regarding cash applied to invoices through integration with an accounting system of the client.

6. The method of claim 5, further comprising automatically matching deposit amounts to invoices, wherein the client reconciles any unmatched deposit amounts with unmatched invoices.

7. The method of claim 6, wherein the financial institution reviews and modifies before accepting reconciled items.

8. The method of claim 1, further comprising the financial institution configuring automatic-accept rules for reconciliation of deposit amounts and invoices.

9. The method of claim 1, wherein the client assigns deposit amounts to specific invoices and to aging categories, the invoices being with aging categories corresponding to a range of ages.

10. The method of claim 9, further comprising creating cash applied amounts from the deposit amounts, for invoices in the applicable aging category for a specific debtor.

11. The method of claim 10, further comprising, upon the cash applied amount equal to the deposit amount, applying the deposit amount for each aging category to debtor invoices within that aging category.

12. The method of claim 1, further comprising the financial institution configuring a reconciliation period for the client, wherein restrictions apply to the client after an approved setting.

13. The method of claim 12, wherein the client reconciles deposit amounts against invoices and draws and submits a deposit reconciliation to the financial institution.

14. The method of claim 12, wherein the financial institution downgrades a borrowing base amount of the client if deposit amounts are unreconciled exceeding the reconciliation period.

15. The method of claim 12, wherein the financial institution restricts funds from the recovery account of the client if deposit amounts are unreconciled exceeding the reconciliation period.

16. The method of claim 12, further comprising the financial institution configuring automatic-accept rules for deposit reconciliations submitted by the client.

17. The method of claim 1, wherein users correct misapplied deposit amounts.
